(19) United States
(12) Patent Application Publication
(10) Pub. No.: US 2025/0350941 A1
(43) Pub. Date: Nov. 13, 2025

(54) K-Net Device and K-Net

(71) Applicant: GALACTIC TELECOM GROUP, LLC, Silver Spring, MD (US)

(72) Inventor: James Kirunda Kakaire, Silver Spring, MD (US)

(21) Appl. No.: 18/880,163

(22) PCT Filed: Jun. 29, 2023
(86) PCT No.: PCT/US2023/026580

§ 371 Date: Dec. 30, 2024

Related U.S. Application Data
(60) Provisional application No. 63/367,436, filed on Jun. 30, 2022.

(51) Int. Cl. H04W 12/06; H04W 84/12

(52) U.S. Cl. CPC H04W 12/06; H04W 84/12

(57) ABSTRACT

A System and method for producing K-Net devices and improving a K-Net communication network on which the devices run to provide electronic services. A divided Net Extender extends the wireless network. K-Net devices utilize a modem card as an internal or external modem over Wi-Fi, cellular, millimeter wave and microwave bands. A processor on a circuit board coupled to a G chip or traffic controller chip embedded with a network control protocol and coupled to a dedicated cache memory manages networking of mobile devices and autonomous vehicles from a Local Area Network (LAN) manager device. A geographical internet protocol (Geo IP) enhances security. The modem connects to a wireless router device that runs a card control protocol, wherein the router plugs into the LAN manager device, connecting to internal and external DNS servers, GIP allocation and authentication servers. Devices are self-powered by alternating current generated from a direct current.

### CROSS-REFERENCE TO RELATED APPLICATIONS

This patent application claims priority to U.S. Provisional Patent Application No. 63/367,436, filed Jun. 30, 2022, which is hereby incorporated by reference herein in its entirety.

### FIELD OF THE INVENTION

The present invention is in the field of producing electronic devices, network equipment and how the devices relate to broadband networking and wireless networking.

### BACKGROUND OF THE INVENTION

Mobile devices, which include mobile phones, tablets, laptops, and wearable today, connects to Wi-Fi nodes and process data but only when they are stationed in a given radius. When the mobile devices move away from a Wi-Fi node, they do not connect to another Wi-Fi node and maintain data continuity. Data is lost. Further, user devices are not protected at a network level. It is easy for hackers to get into user devices or systems based on IP address connections and user authentication. Additionally, networks require trained technicians to setup systems and provide internet addresses using subnet masks.

A Mobile Wireless Broadband Network Interface Card (MWBNIC) provides secure internet connections and networks devices on W-Fi, microwave, and other wireless broadband networks as a modem. However, it does not provide physical user devices that work with the MWBNIC device. Thus, there is a need for a system with user devices that utilizes the MWBNIC device as a modem card to process data on Wi-Fi, microwave bands, and other broadband networks while maintaining connectivity and data packet continuity when in motion.

Further, there is another need for a system and method that improves communication networks and produce devices that securely run on the networks to provide electronic services.

### Problems Solved

Embodiments of the present invention introduces a system and method for producing K-Net devices and improving a K-Net broadband communication network on which the devices run to securely provide electronic services over Wi-Fi, microwave and other broadband spectrums utilizing the mobile wireless broadband network interface card (MWBNIC) modem, also referred to as a modem card. The K-Net devices are in form of a mobile phone, tablets, a laptop computer, a television, and a K-Net recorder. These come with a geographical internet protocol (GIP) that identifies and secures user devices on the network while protecting data on servers. A user gets a device from anywhere, pays service costs from within the device and activates the device through the device's com interface, without a service provider's assistance.

The K-Net network equipment includes a local area network manager device that works in conjunction with a wireless router device and a divided Net Extender device to manage wireless connectivity and provide electronic services on mobile devices and autonomous vehicles over Wi-Fi, microwave and other broadband spectrums. The network devices are powered by alternating current generated from a DC compartment within a device, to reduce operating costs.

### Advantages of the Invention

The system provides an improved K-Net network and devices that run on the network. In combination with a changing connection code that authenticates devices and secures connections, the system provides a geographical internet protocol (GIP) address that results into top notch security for autonomous vehicles and all devices preventing hackers from redirecting vehicles into accidents.

Unlike an IP address, a GIP does not require subnet masks when setting up a subnet network and thus reduces the need for trained technicians on basic tasks in a facility. A GIP identifies all necessary tokens in an address and replacing addressing classification with regional addressing that establishes a secure connection directly,

Computers, television sets and other devices running a broadband modem, wirelessly connects to the K-Net network like mobile devices. Additionally, a net extender with HDMI, USB, Ethernet etc., connects both mobile and home devices.

The system reduces networking costs by eliminating a need for sub-net masks when setting up machines on a small network.

The system prevents unauthorized access to electronic resources via networks by utilizing a double verification process of a user device requesting access to resources and verification of a user. The process involves a static GIP, a dynamic GIP and time at which said user device initially connects to an internet service provider (ISP) network. When a user logs into a resource provider's system, the resource provider further verifies from the ISP that a connecting device is the designated device and verifies the ISP providing service to the device seeking access to the electronic resources.

The secure K-Net broadband network is made up of a local area network (LAN) manager device built on a multiport circuit board with a traffic controller chip (TCC) for managing autonomous vehicle connectivity and a G chip for managing other device connectivity; and providing electronic services. The LAN manager device controls switching of mobile devices from one wireless router to another while maintaining connectivity.

The K-Net network further comprises of a plurality of wireless router device and divided Net Extenders also running a TCC and a G chip with embedded protocols. The wireless routers and divided Net Extenders interface with user devices to provide the electronic services including autonomous vehicle connectivity, radio, phone, television, video conference and more. Electronic services are accessed via a com interface and tabbed interfaces at specified frequency ranges and application ports.

The method for producing K-Net devices and improving a K-Net broadband communication network on which the devices run to securely provide electronic services, provides the electronics services utilizing a com interface and a plurality of tabbed interfaces making the devices more interactive and user friendly. A user gets a new or used device from anywhere, pays service costs and activates the device through the device's com interface, without service provider assistance.

### SUMMARY OF THE INVENTION

The present invention introduces a system and method for producing K-Net devices and improving a K-Net communication network on which the devices run to securely provide electronic services as displayed on the com interface and more. A K-Net device with a broadband wireless modem for networking data packets from at least one wireless node of an improved K-Net communication network, maintains packet order and continuity for the K-Net device in motion. A traffic controller chip and a G chip embedded with protocols are utilized to manage connectivity of autonomous vehicles and mobile devices while providing electronic services. A phone chip manages phones plugged into a Net Extender directly or through a splitter that allows multiple phones.

### BRIEF DESCRIPTION OF THE DRAWINGS

FIG. 1 illustrates an embodiment of the present invention comprising K-Net devices FIG. 1A, FIG. 1B, FIG. 1C and FIG. 1D that runs on the improved K-Net communication network with a com interface also referred to as home or main interface. FIG. 1D is operated from FIGS. 1A, 1B and 1C.

FIG. 2A is a geographical internet protocol (GIP) address with geographical or geo internet protocol address tokens that identifies specific functions of each segment or turple of the GIP.

FIG. 2B represents regions and sub-regions on earth that are utilized when determining a geographical region or sub-region for coordinates that results into a GIP.

FIG. 3 is a circuit board for a K-Net device with a modem on a K-Net network.

FIG. 4 describes version 1 of the packet control protocol (PCP) algorithm.

FIG. 5 is a second version of the packet control protocol (PCP) algorithm. It provides three options for switching a device that is getting out of range of a node.

FIG. 6 is a routing table represented as a data structure in a tabular form used in conjunction with the algorithm of FIG. 5. The data structure could be a harsh table, list or other that stores easily accessible data. FIG. 6B is a K-Net device filter.

FIG. 7 is a broadband network that operates over Wi-Fi, microwave, other bands.

FIG. 8 represents a K-Net device in motion switching from one broadband node to another.

FIG. 9 represents algorithm of a Card Control Protocol which runs on the wireless router to process data traffic between devices and the LAN manager.

FIG. 10 is the algorithm of the Network Control Protocol. It runs on the Local Area Network Manager to verify and authenticate devices.

FIG. 11 is an algorithm that runs a personal safety feature of the K-Net device.

FIG. 12 is a circuit board for the Local Area Network manager device.

FIG. 13 is a circuit board for the wireless router device.

FIG. 14 is a direct current (DC) compartment for generating alternating current from direct current sourced from FIG. 14A, FIG. 14B and FIG. 14C then converted to AC current from FIG. 14D.

FIG. 15 represents a system function algorithm.

FIG. 16 is a tabbed interface for providing television service.

FIG. 17 is a log of television channels read from a background to display in FIG. 16.

FIG. 18 represents log of favorites channels shows saved and retrieved by users.

FIG. 19 is a connection log on an internal domain name server (iDNS).

FIG. 20 represents a system and method for producing K-Net devices and improving a K-Net communication network on which the devices run to securely provide services over tabbed interfaces.

### DETAILED DESCRIPTION OF THE DRAWINGS

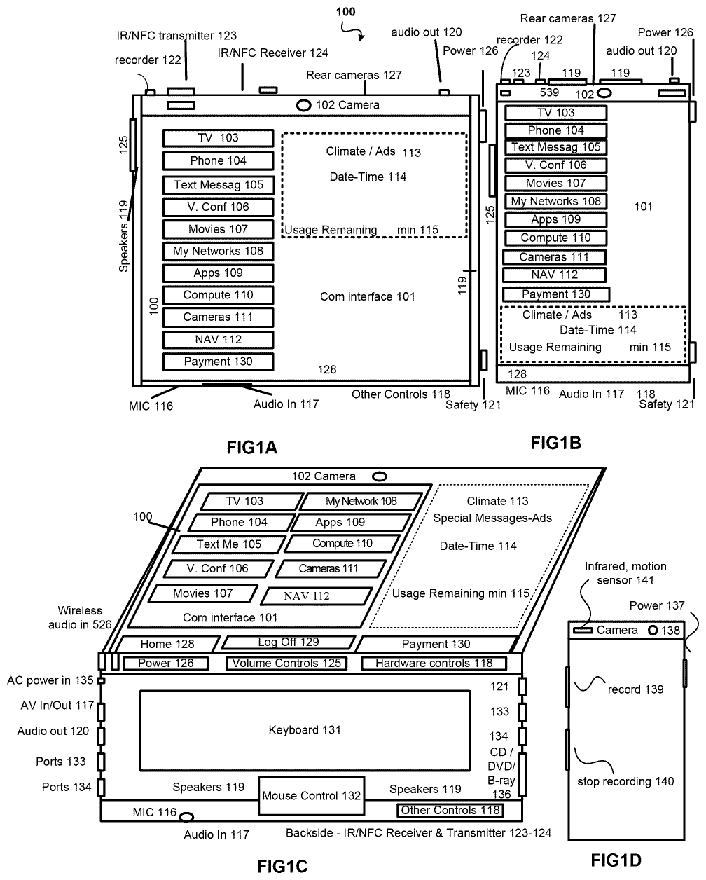

FIG. 1 represents K-Net devices in different versions. A K-Net recorder utilized to record and transmit events involving video and audio to a service server, is controlled from the other devices.

The system, wherein the K-Net device, the LAN manager device, wireless router device and a Net Extender device having at least one processor and a memory coupled to said at least one processor executing commands, an operating system on at least one storage media coupled to said processor, manages applications in said devices. The K-Net device utilize wired and wireless earphones over Bluetooth but provides direct audio input and speakers.

A modem card in a wireless broadband modem for networking data packets from at least one wireless node while maintaining packet order, and continuity for K-Net devices and autonomous vehicles in motion transmitting data on a network operating at Wi-Fi, microwave or other broadband spectrum bands.

The system provides an improved K-Net network configuring and connecting servers to a plurality of local area network (LAN) manager devices that implements antennas and filters coupled to a G chip (gChip) for controlling connectivity of devices. The LAN manager devices plugging into and connecting to a plurality of wireless router devices with antennas and filters that interface with autonomous vehicles, mobile devices and Net Extender devices wirelessly to provide electronic services wirelessly including television services, phone services, video conference services, radio and others as displayed on the com interface of FIG. 1. The wireless router device and the LAN manager device which interacts with servers to manage the wireless router devices, net extender devices and mobile devices when authenticating and accessing electronic services, on the K-Net network, are each coupled to a DC compartment that converts direct current to alternating current to power the system.

A phone chip in a divided Net Extender device for managing at least one phone device connected to the divided Net Extender device;

A traffic controller chip (TCC) coupled to the processor in the LAN manager device for managing connectivity of autonomous vehicles on the K-Net network instructing the vehicles and mobile devices in motion what wireless node to connect to next while providing a connection code for securing the connection.

The improved card control protocol (iCCP) embedded in a chip of the wireless router on the K-Net network, manages mobile devices, Net Extender devices and vehicle devices connecting via the broadband modem for electronic services. A K-Net device running an improved packet control protocol (iPCP) embedded in a network packet controller chip of the modem card for networking and transmitting data, simultaneously connects to more than one wireless node(s) on a network operating on Wi-Fi bands, microwave bands or other broadband spectrum bands to network with the wireless nodes.

The K-Net devices and the LAN manager devices working symbiotically with the servers to provide electronic services to the K-Net devices, wherein a range of frequencies and a port is designated for each type of electronic service provided on the K-Net device based on the card control protocol, the network control protocol and the system function algorithm. The K-Net device 100 with a front camera 102, is powered to execute the system function algorithm (SFA) which manages and controls how the K-Net device operates to provide electronic services. The SFA verifies a device and displays a communication (com) interface 101 also known as main interface 100 showing a television service button link 103, a phone service button link 104, a text message button link 105, a video conference service button link 106, a movies service button link 107, a my networks service button link 108 to which a user adds content they like. That is, when a user utilizes a website or install an app, the user is provided an option to add a URL or the installed app to My Networks if they like. The main (com) interface also displays an apps service button link 109 which shows all the apps installed on the device and the icons displays for execution. A compute button link 110 is for returning to a plain OS interface from where to launch a browser, a remote camera access service button link 111 for configuring the K-Net recorder device and retrieving recordings from a server or from the device itself, a navigation service button link 112 displays icons based on navigation applications installed on device. A radio button link is not shown on the com interface, and a payment service button link 130, wherein the payment service button link is activated on boot connecting and checking for a client device status and a payment status from a payment server and, wherein the SFA connects a new client device utilizing a default GIP or a default IP prior to purchasing services and without a service provider's action, The K-Net device displays a multipurpose interface that receives data packets to show at least one of climatic or weather conditions, time and ads. It also displays as a screen saver to show ads when a K-net device is booting, booted or showing a screen saver.

When opened, the payment service button link provides a new interface that takes a customer account number auto filled from device memory, service provider payment code auto filled from device and a payment method selected by user from a list of choices displayed on the interface. A button link is provided to save the payment method and to select one time or recurring. The payment methods include but not limited to a credit card payment, a debit card payment, an electronic check with bank account number and routing number, a pre-paid scratch card pin number and a digital payment such as crypto currency that is changed based on a digital currency type desired. The button links in the interfaces transmit instructions to the device processor then through the network connected to, wherein the network forwards the instructions to designated service servers and service is provided with payment. A payment module reads the account status in the payment system once a day. Upon powering a device, the device displays amount due X days before the due date and provide a payment button and a close button to ignore. A reminder interface is displayed until payment is made or service is terminated. When terminated, the payment button link gets connectivity to pay via a clickable link that saves payments to the payment server.

The interface also provides a climate window 113 that displays weather conditions, date and time 114, service usage 115 and any information that a service provider may want, including ads in form of videos, images text, audio or a combination thereof. The processor invokes a plurality of interfaces and button links to execute functions related to the selected interfaces and button links in the system.

The button links on the com interface (CI) 101 are displayed only when the applications are installed. By default, the CI is built to display television 103, phone 104, apps 109 and payment 130 but when an application is installed, its button displays on the interface. Button links can also be added or removed from the com interface via settings.

The K-Net device provides a microphone 116, audio input 117 and other controls 118, speakers 119, audio out 120, a safety alert button 121, an audio/video recorder camera on top of the device 122 that works in conjunction with navigation software to pinpoint a device location and submit recordings to a server upon activation. The cameras scan QR codes, barcodes and other codes. The K-Net device is a television set running a modem card, wherein the television set connects to a wireless node over Wi-Fi, cellular, microwave and millimeter waves, The television set provide electronic services, and wherein the television set is authenticated over at least one of a Geo IP or an IP address or a phone number or other identifier to a user account.

The device further provides lenses for a near field communication transmitter 123, a near field communication receiver 124, volume adjusters 125, a power button 126, rear cameras 127, home display 128 that shows at power on or at logon, logoff 129 and a payment service, 130 that displays various payment options. A laptop version provides a hardware keyboard 131, a mouse controller 132, ports 133 and 134, AC power in 135 and a CD/DVD/Blue-ray drive with a burner 136.

FIG. 1D is a K-Net Recorder with a power button 137, a camera 138, a record button 139 and a stop recording button 140, infrared and motion sensors 141 detects varied temperatures and senses motion to activate. The K-Net Recorder is operated via the com interface button 111. Mounting it on a vehicle dashboard detects humans and animals such as deer on a road and beeps showing a 180 degree view on a screen a recorder is configured to work with to alert a driver. The K-Net recorder device equipped with a motion sensor and infrared sensor, is configured to record when motion is detected. Recordings are configured to be saved to the device or the server or the device and the server. A television set or a display running a broadband modem is mounted to an automobile or a truck, wirelessly connects to the network over Wi-Fi, cellular, millimeter wave or microwave and provide at least one of television services and ads in form of video, images, audio and text. Ads are transmitted at specific ranges configured for time slots.

The button links on the interface are displayed on boot or at login and when opened, the button links submit instructions to the processor causing the processor to invoke a main interface for the type of service choice requested by the button link through a specific port linked to a frequency range corresponding to the service type; and displaying new button links and the new button links displayed on the main interface for the choice service causes instructions to activate the choice service and extract data from servers that provide said service on the network.

The K-Net device provides a safety button 121 coupled to the processor, a safety chip, transmitter 323 and at least one camera on top of the K-Net device 122, and when the safety button is pressed and held by a user to record an event at a site, the safety button transmits instructions to the processor 302, wherein the processor triggers a device vibration to indicate to the user that recording is initiated. Alternatively, rear or front cameras are configured to be the default recording device for the safety button. The safety button is alternatively accessed from an interface via touch screen.

The recording includes video, sound, a GPS location of the event site and a trace route path indicating nearest places and landmarks to the event site 1105, and the processor, safety chip and transmitter, automatically transmits 1104 the recordings to a service provider's server for real time retrieval 1108. A user configures the device to transmit recordings to other destination devices by providing device identifiers such as phone numbers or internal GIP/IP and the service provider's server submit links to the designated devices and calls the designated devices to inform of the recordings 1108 and turning on vibration mode of a designated recipient's device.

The recording is configured to default to the top camera, but a user selects any camera to record an event in real time or configure the camera by changing the default setting. It can be a rear or front camera instead of the top camera. When configured to transmit recordings to law enforcement stations 1110, the servers provide law enforcement stations in the vicinity of the event site and any designations as configured in the system with recordings via a K-Net network over Wi-Fi or microwave bands, a cellular network, a satellite or other network.

A K-Net recorder which is a version of a K-Net device, is equipped with the broadband modem card and an infrared sensor for detecting objects with a different temperature, a motion sensor for detecting moving objects and a smoke detector for detecting smoke. It is configured with a static GIP or a static IP address to connect to the K-Net network to record and transmit video and audio events to at least one designated server and internal memory of the device utilizing a specific frequency range whether in motion or stationed. The K-Net recorder device is turned on and off remotely via a com interface from a dedicated K-Net device connected to the internet by authentication and recordings are accessed in real time from the server by authentication on designated devices to maximize security. It triggers an alarm and sends warning messages to the server when excessive heat or smoke is detected. The warning messages are configured to be transferred to fire departments and law enforcement. The K-Net recorder is planted in any location indoors or outdoors and recordings are accessed remotely via a K-Net device with a graphical com interface or any other device with access to the server recording service via a web browser or application. It comes with a sticky backside or clippers that holds onto a surface for steady recordings. If configured, recordings can be accessed via any internet connected device without designation but authentication using email or phone number, password and a connection code are required. A K-Net device plays back recordings from several K-Net recorders utilizing buffering. Application software installed for configuration in any device. The K-Net recorder device is configured to record when in motion recording via a wireless router “node” or when mounted indoors or outdoors, and recordings are accessed in real time from the server by authentication on designated devices to maximize security. The K-Net recorder is mounted on any surface to record events inheriting recording characteristics of the safety button on the other K-Node devices. The device is mounted to surfaces utilizing a suction cup, hooks, nails or a combination thereof.

The K-Net device connects to the wireless router device wirelessly or through wires (Net Extender) to the K-Net network and transmits recordings to servers utilizing a specific frequency range on the MWBNIC. This version is also turned on and off remotely from another K-Net device under the cameras button link by selecting a name as configured to a static GIP or IP and an on, or off button. The K-Net recorder is small enough to be inserted into a different object to appear like any other object and a user may configure the K-Net device to record to a server of choice. It is powered by rechargeable batteries but comes with a USB port that plugs directly into AC power for continuous recording. The K-Net device is configured by default to record from a top camera, a rear camera or a front camera and can be reduced in size and changed shape. Recordings are transmitted via the network.

Represents a geographical addressing mechanism known as a Geographical Internet Protocol (GIP or Geo IP) address comprising Geo Tokens (203-211) utilized in the system as an internet address for identifying and protecting K-Net devices from network related attacks and for communicating with servers on a K-Net communication network. The tokens identify specific functions of the GIP. The GIP providing a transient or dynamic GIP address and a static GIP address for securing devices on the improved K-Net communication network maintains security. The GIP allows a GIP reader software on a resource providing server to verify the user, verify the device in use, verify the internet service provider providing service to the device seeking access to the electronic resources plus.

A plurality of GIP allocation servers for allocating GIPs, domain name servers (DNS′) for translating and controlling devices on the network and authentication servers executing a GIP reader for verifying and authenticating the devices on the network utilizing the GIP protocol, wherein the GIP is sub divided into tokens for identifying parts that the GIP is made of. A GIP is automatically assigned to devices by GIP allocation servers providing a dynamic and a static GIP address for securing devices on the improved K-Net communication network. The authentication servers with a GIP reader installed provides network access.

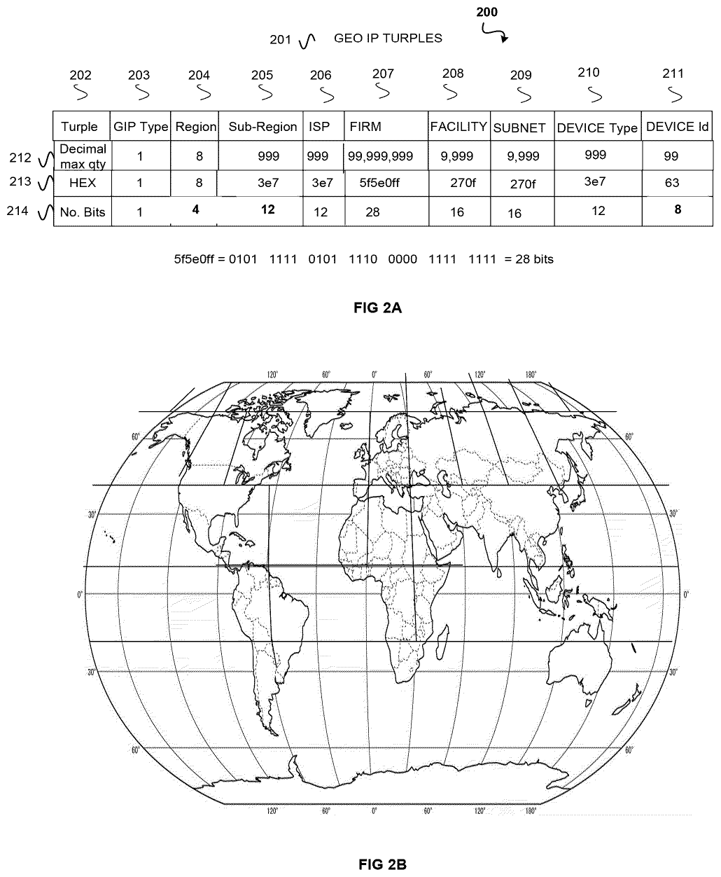

A token is represented in decimal numerals format to show the maximum number of occurrences of the token item. For example, the token Region (204) represents the maximum number of regions there can be on earth. Utilizing continents as regions, there are 8 continents, namely, North America, South America, Africa, Europe, Asia, Australia, Arctic, and Antarctica. Four (4) Quadrants or smaller divisions of FIG. 2B (earth), are alternatives.

The token is then converted to hexadecimal (HEX) and binary (No Bits) to get the number of bits per token as provided in the third row (FIG. 2A). The total number of bits in the GIP is 128 but some tokens are adjusted as needed. For example, the region token, the sub-region token and the device id token are adjusted based on need.

As an address in a K-Net device, a GIP is represented in hexadecimal (HEX) format as seen in the second row of FIG. 2A.

A GIP reader installed on an authentication server, takes in the first bit in the form of charAt(0). If the first bit charAt(0) is 1, it is interpreted as an internal static GIP and if it is 0, it is interpreted as an external dynamic GIP. A 0 or 1 bit can be assigned to either.

In another implementation, a dynamic GIP if needed, is saved to the K-Net device.

The GIP, characterized by hexadecimal tokens for identifying specific functions of the GIP, is made up of two types of geo internet protocol addresses one static and referred to as internal, and resident in the K-Net device for identifying the device on a service provider's network and a counterpart dynamic GIP referred to as external for identifying the device on external networks and saved to a server connection log instead of saving on the device, wherein the GIP comprises:

A Turple (202) identifying the formats used for each token. That is, Decimal, Hexadecimal (HEX) and No. Bits which is the equivalent number of binary bits.

A GIP Type token (203) made up of two bits one is a zero (0) for identifying the static type of geo internet protocol address assigned to a device when signing up for services and another bit is a one (1) for identifying the transient type of geo internet protocol address assigned to a device dynamically at connection time. A static GIP is resident in the device and a counterpart GIP token is dynamically assigned to the device at connection time and saved to a server for reference during connection time and it is identified as a dynamic or temporary GIP. The bit of 1 may be assigned to an external GIP and a bit of 0 to an internal GIP and vice versa.

A region token (204) for identifying a large geographical region in which the device resides on a Wide Area Network (WAN). On a global scale, this WAN can cover one quarter of the earth or one continent or a similar surface size. The region token is assigned a maximum of 8 regions. To prevent targeting a specific region, the region token is periodically/randomly renamed for every region when assigning dynamic GIPs.

A sub-region token (205) is for identifying a geographical smaller region within the region where the device resides on a Local Area Network (LAN). A sub-region can be any size land area such as 100 square kilometers or 10000 square kilometers. A region may have at most 999 sub-regions but are adjustable as needed.

ISP token (206) is for identifying an internet service provider (ISP) within a sub-region up to 999 ISPs for each sub-region.

A firm token (207) for identifying a client company or organization in a sub-region, e.g., a hospital, a military base, a university etc. with a maximum of 99,999,999 firms of all kinds. For a home or individual, the firm token (field) is represented by zeros or ones only. The firm and facility GIP tokens are adjustable to allow ping and trace route functions for devices on a company network. The number 99,999,999 represents quantity of firms. The equivalent HEX value is 515e0ff, FIG. 2A giving 28 binary bits in total.

A facility token 208 identifies different facilities that belongs to the same company in a sub-region. A company can have up to 9,999 facilities in a sub-region. This field eliminates a need for sub-net masks when setting up machines on a small network.

A subnet token 209, for identifying a specific portion of a network in a client's facility, A company may have several facilities. There is no need for setting subnet masks; and this allows a non tech person to setup several small networks.

A device type token 210, for identifying a type of device requesting connectivity. It is utilized to prioritize requests in case of emergency. The token represents to the GIP reader the type of device requesting for service or being sought after. This could be a mobile phone, tablet, laptop, server, autonomous vehicle (highest priority), television, navigation, sensor, and others up to 999 types. The device type token in a service server's GIP, identifies an authentication server that directs requests to the service server.

A device id 211, utilized to identify an actual device seeking connectivity or a server. The GIP is divided into an internal GIP and an external GIP, wherein the internal GIP is set to a GIP type token of a 1 bit, and an external GIP set to a GIP type token of a 0 bit or vice versa. The external GIP interacting with other service providers and other devices on external networks, preventing attacks on the internal GIP and the device through the network by making the internal GIP un-accessible A GIP reader reads charAt(0)=0 and tells the GIP is static, and charAt(0)=1 tells the GIP is dynamic. When a specified server is unavailable, a request is redirected to a different server. The default static Geo IP connects to an ISP without service. A user only selects an Internet Service Provider (ISP) from a list. If an ISP is not on a list, a user adds the ISP. When a device is assigned a static Geo IP or IP address by an ISP, the default Geo IP stays. A reset button erases the ISP assigned Geo IP reverting to the default. An assigned Geo IP is encrypted and cannot be changed manually from the device. A device provides a default static Geo IP which connects without service. A user selects an ISP from a list or adds an ISP manually to subscribe. After making a payment and subscribing to an ISP, the ISP assigns a static Geo IP to the device and saves the static Geo IP in the user device. It also assigns a transient Geo IP for 24 to 72 hours and saves that on an internal domain name server (iDNS). Each time a new transient Geo IP is assigned, a tiny code is also assigned and saved to the device. The iDNS logs account number, device id, assigned static Geo IP, assigned dynamic Geo IP, a tiny code assigned to the device and stored on the device and on the iDNS each time a new dynamic Geo IP is assigned.

A device requests connectivity by providing its internal GIP or IP. The authentication server stores the internal GIP/IP in a connection log and assigns an external GIP which the server stores in the same record with the internal GIP as a reference. The external GIP/IP interacting with other service providers and other devices, prevents attacks on the internal GIP/IP and subsequently the device through the network.

The LAN manager or wireless router reads a GIP of a connecting device and utilize the device type token to prioritize a connection and connects one with a higher precedence based on a type of device seeking for a connection. Other methods can be utilized to identify a type of device for prioritizing a connection.

The maximum number of bits in the address is 128 bits and the GIP is automatically assigned to devices by GIP allocation servers. IP addresses can be utilized as GIPs. The system of geo addressing eliminates a need for a subnet mask when allocating GIPs to devices and eliminates a need for addressing classification. Regional addressing establishes a connection directly. The internal GIP is assigned to a device as a static address by a server to permanently identify the device and the external GIP is dynamically allocated to last for a short period of time, wherein the external GIP is saved to authentication servers in a connection log (table or database) and it is the external GIP that is provided to external networks.

A GIP reader in domain name servers (DNS) identifies the external GIP and thus, other devices can neither utilize an internal GIP even if known nor utilize an external GIP to get to a device. A static or a dynamic GIP individually, does not complete a connection, wherein the authentication servers takes a connection request from a device with an internal GIP as a parameter along with other hardware identifiers and logs the internal GIP, and dynamically assigns an external GIP and logs the external GIP in a device's connection record or log on a server setting a short expiration period for the external GIP such as 24, 48 or 72 hours. The authentication server submits a device's external GIP to an external domain name server (EDNS) for external access.

The GIP allocation servers allocates two static GIP addresses to a resource providing server instead of a static and a dynamic GIP or IP as allocated to a user device. One of the static GIP addresses or IP address is internal, residing on the resource providing server to which the GIP is allocated, and a second GIP is external and residing on an external domain name server (EDNS) logged or tabulated against the resource server's fully qualified domain name (FQDN). A record of the internal GIP or IP, external GIP or IP, and FQDN is kept in a connection log, on an internal domain name server (IDNS) for resolution and the internal GIP is neither reachable from outside a network nor can an external device perform a ping or run a trace route on the server.

An external device seeking a connection to a resource providing server, utilizes the server's fully qualified domain name (FQDN) on the external domain name server, wherein the FQDN translates to the service server's external GIP at the EDNS. The GIP reader on an authentication server or other server reading a connection log of an IDNS populated with internal GIPs, external GIPs, and FQDNs for each resource server, maps the resource server's FQDN provided by the device seeking a connection to the resource server's internal GIP on the (IDNS) utilizing the external GIP.

The GIP reader redirects the connection request to the service server without providing the internal GIP of the service server and the GIP reader logs identifiers of the external device seeking a connection to the resource server for resources in the connection log as a record. The identifiers include a transient or dynamic GIP, an external internet service provider (ISP) token 1904, a connection date-time token 1905, a disconnection date-time token 1906, and GIP of a server connected to.

An external device connecting to a service server, utilizes the server's fully qualified domain name (FQDN), wherein the FQDN translates to the server's external GIP at a domain name server; and, wherein the device type token in that server's external GIP identifies an authentication server instead of the service server, and, wherein the external device seeking connection to a service server is directed to the authentication server on that network. The authentication server logs the external device's identifiers including ISP and redirects the device to the intended service server for service.

To authenticate a device on an ISP network, a K-Net device requesting a connection, provides its static GIP and other hardware identifiers to an authentication server in a connection request and the authentication server identifies the K-Net device on the K-Net network by comparing the GIP to device records, and obtains a dynamic GIP for the K-Net device from a GIP allocation server. The authentication server saves both the static and dynamic GIPs as a connection record for that connecting K-Net device. The connection record includes time at which the device connects to the network and is kept on the server for as long the ISP decides.

If the ISP happens to keep the connection record or log for 48-72 hours, each time the device connects to resources, both the static and dynamic GIPs in the connection log are utilized when connecting the device until the dynamic GIP expires in the 72 hours.

Electronic resource providers download and install on their servers, authentication application or a GIP reader that takes a dynamic GIP, connection time of a K-Net device on a K-Net network of the ISP, and other device identifiers to the ISP as parameters for verification. The parameters are saved in memory during when a device is connected to the K-Net network and discarded upon disconnection. Alternatively, the parameters are provided to the device and the GIP reader obtains the parameters from the device.

A K-Net device is registered with an internet service provider (ISP) and identified by authentication servers from the static GIP or a static IP when requesting for network connectivity and electronic resources. The K-Net device is assigned a transient or dynamic GIP during authentication, wherein the ISP records a successful connection to a connection log 1900 on a server logging the static GIP or static IP 1901, the transient GIP or the transient IP 1902, a fully qualified domain name 1903, an ISP ID 1904, a connection date-time 1905, and a disconnection date-time 1906 in the connection log; and the dynamic GIP is also saved to memory of external domain name servers. This prevents access to the internal static GIP while protecting the device in addition to the connection code and a user authentication utilized. A GIP reader on a server prioritizes a connection request based on a type of device seeking for a connecting. Example, a car has higher priority than a phone.

A GIP reader is configured to identify a device that accesses electronic resources based on a static GIP and a user authentication. A K-Net device connected to a network and seeking access to resources, submits a transient GIP or transient IP 1902 assigned to the device, a connection time (CT) at which the device connected to the ISP network 1904, and an ISP token 1903 as parameters to a resource provider server to access the resources.

The device ISP GIP reader on the authentication server or other server, receives a device verification request from a resource provider server based on the ISP token in the transient GIP, wherein the request include a transient GIP or transient IP address, a connection time of the device to the network and the ISP token. The ISP GIP reader reading identifiers of the device from the connection log on an authentication server or other server compares the transient GIP or transient IP and CT provided by the resource provider in the verification request to the transient GIP or transient IP in the connection log and time at which the device connected (CT) to the ISP network and when the parameters match, the ISP returns a verification confirmation to the resource provider with a static GIP or static IP from the connection log along with the dynamic GIP and CT. The resource provider identifies the device as a dedicated device allowing the device to access electronic resources specifically configured to be accessed by the device's static GIP and user authentication.

The electronic resource provider verifies resources to which the device and device owner, the authenticated user has access to and permits access to the resources.

User authentication involves logging in with a username such as (email or phone number) and a password with an option to save the username and another option to change the username. Upon submitting a username and password, a one-time connection code is provided to the user via a mobile device or email or phone call to a designated number and utilized to identify the user. A GIP reader then identifies the device and the ISP providing access to the device. The K-Net device implements a Geo Internet Protocol (IP) address and receives at least one tiny code from an ISP when a transient Geo IP or IP address is changed. At least one of the tiny code, the Geo IP, the tiny code and the Geo IP or the tiny code and the IP address, is a device signature that is passed to an ISP as a parameter for verification and authentication. The Geo IP and the tiny code are encrypted and saved to at least one of a connection application and a chip such as the G chip in a K-Net device for security. The tiny code and Geo IP are not transferable to other devices. The tiny code is used only during life of the dynamic Geo IP 24 to 72 hours, and it is also stored in the device's log on the server for verification. That code tells what the device is and whatever an ISP want to include such as MAC Address, last connection node and time. The tiny code cannot be transferred from one device to another

In this method for improving a communication network and providing devices that run on the communication network, the GIP reader is configured to identify a device that accesses electronic resources based on a static GIP and user authentication. The application takes in a dynamic GIP provided to a device and time at which the device connects to the ISP network as parameters, and formulates a verification request to the ISP. The ISP reads a connection log and compares the dynamic GIP and time at which the device connected to the ISP. When the parameters match, the ISP returns a verification confirmation providing a static GIP to the resource provider. the resource provider identifies the device as a dedicated device by comparing the static GIP on record to the static GIP from the ISP, allowing the device to access electronic resources specifically configured to be accessed by the device in addition to user authentication.

A K-Net network further comprises of application monitors on servers, repeaters, authentication servers, Internal DNS servers (IDNS), External DNS servers (EDNS), GIP/IP allocation servers, firewalls, Gateway to the internet all connected by wires such as fiber optics, copper etc. that delivers high speed data transmission.

The modem card is built with at least one external port that connects to wires including USB, HDMI where data is transmitted as electronic pulse when plugged into a port of another device.

The modem card of the current invention is built into and installable in multiple auxiliary devices including mobile phones, tablets, laptop computers, televisions, navigation devices, K-Net recorders and vehicles as a connecting modem that networks on broadband wireless bands including Wi-Fi, microwave and millimeter waves, cellular networks. A plug and play version of the modem is built for external ports such as USB.

FIG. 2B represents regions and sub-regions on earth. The smallest number of regions we can get from the earth is four (4). That is, dividing the earth into four quarters. However, a region can be made up of 2, 4, 6, 8 rectangles or more shown in FIG. 2B. Each small rectangle is a sub-region. The sub-region can also be made smaller if needed but we do not exceed a total of 128 bits in the GIP. In a sub-region, we utilize GPS positioning to determine exact locations including address, area identifiers includes country, zip code, postal code, phone area code, names of cities, names of states or provinces and other names.

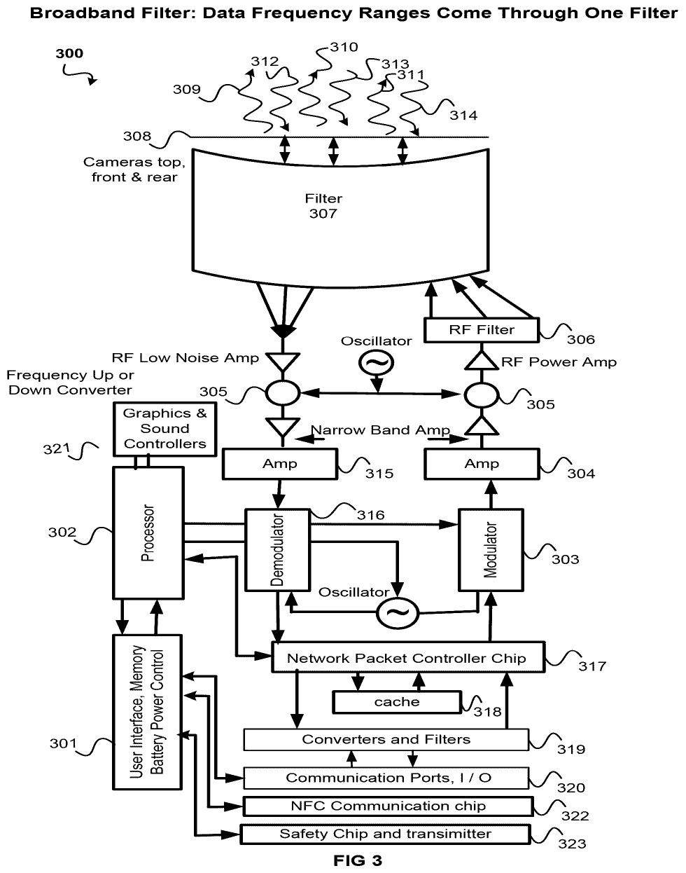

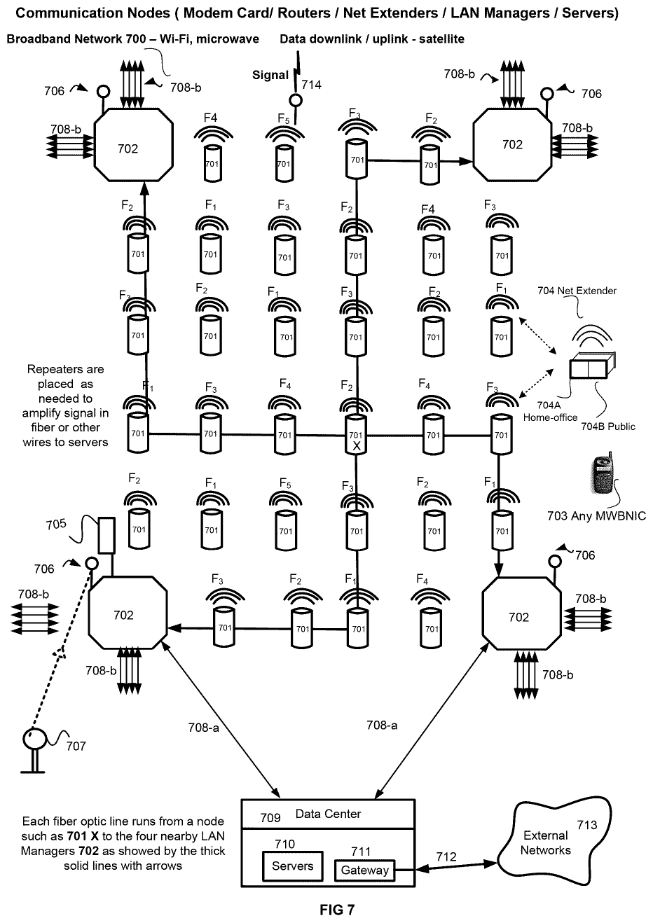

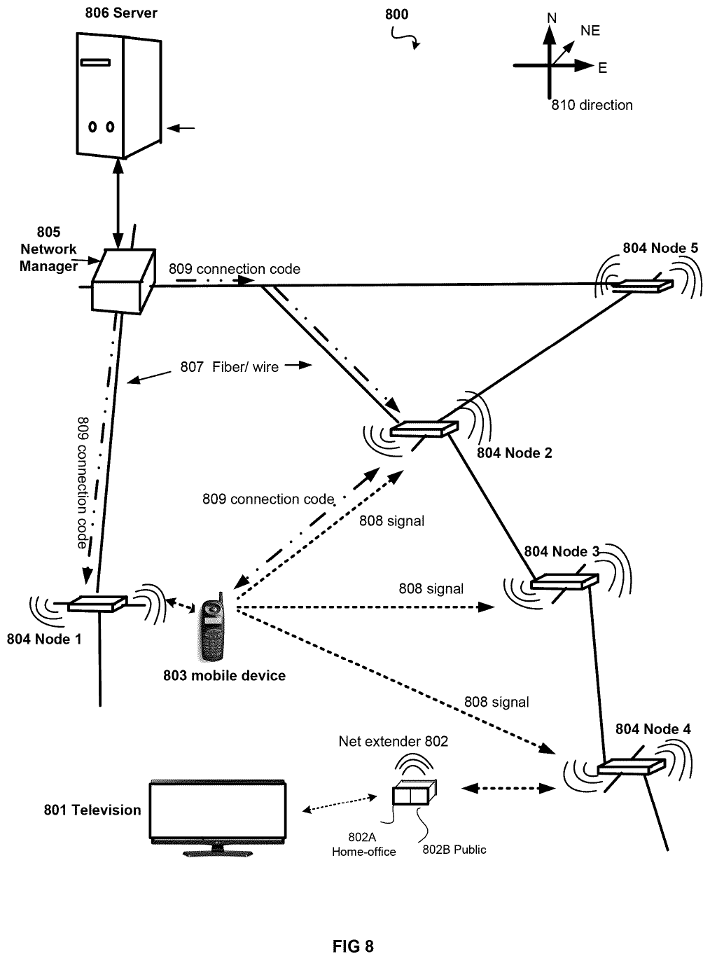

FIG. 3 Is a critical embodiment of the present invention. It represents a circuit board for a K-Net device that utilizes a modem card device as a connecting modem for networking electronic devices and broadband nodes to deliver data over Wi-Fi, microwave and cellular bands, FIGS. 7 and 8 and millimeter waves or a combination there of. It comprises of a circuit board 300 and wireless antennas for wirelessly interfacing with the wireless broadband router device “wireless node” connected to the LAN managers and servers by fiber optics/copper wires to provide electronic services while stationary or in motion. A K-Net device in motion utilizes the broadband modem based on the at least one chip and the memory to switch from one wireless router to another and network the device and the wireless router while maintaining data packet order and continuity. The K-Net device wirelessly connects to the wireless router device or the LAN manager device (node) to provide electronic services and utilizes at least one chip to network with the node when in motion switching from one node to another.

The User interface, memory and power Interface 301, is the input of the initial commands such as power on that sends signals to the processor 302 to execute and initiate connectivity and data flow. The memory is coupled to said processor for executing and storing instructions in a K-Net device. The converter 319, converts the digital commands from the processor 302 and related information into analog signal and the modulator 303 superimposes the signal onto a carrier signal for transmission wirelessly to a wireless router.

The frequency up or down converter 305, ensures the frequency in use at the node is the same as the transmission frequency within the card. The modulated data signal is then merged with the transmission wave. The filters 306, 307 ensures transmission takes place without extraneous signal.

The duplex broadband filter 307 coupled to the wireless radio antennas 312, is a two way filter that ensures outgoing data is what it is meant to be, and the incoming data is at the right frequency or frequency range. The outgoing data signals 308, are wirelessly transmitted to a wireless router. The duplex broadband filter 307 is dual mode meaning it filters narrow band below 2.4 GHz and broad band 2.4 GHz-5.x GHz, Microwaves, millimeter wave (mmWave) and Infrared utilized one at a time. Amplifiers 304, 315 enhances incoming signal 311, 309 and outgoing signal 310, 308.

The packet control protocol (PCP) embedded in a Network Packet Controller chip 317 of the modem in the K-Net device circuit 300, pushes, pops, compares and deletes packets from cache 318 when a device is in motion. The PCP is connected to a mechanism for determining bandwidth on nodes, another mechanism for switching frequency to that of the next K-node and a pre-determined connectivity data set that directly connects devices in motion. Components may be utilized instead of the mechanisms for bandwidth and frequency. These are means for networking. The LAN manager pre-determined connectivity data set is downloaded onto mobile devices.

The filters, filters narrow bands 310 out and narrow bands 311 in. Narrow band includes cellular signals. Either the broadband part is active or the narrow band but not at the same time in the filter 307. The incoming broadband signal 309 from a wireless router and other signals pass through antennas 312 coupled to duplex filters 307.

A demodulator 316, is utilized to recover signal from carrier wave and a converter, converts incoming signal 309 from a wireless router into digital for processing. The data packets transmitted to the modem card are received via at least one input port and converted to digital format for use by the device in which it is installed. The Network Packet Controller (NPC) chip 317, coupled to the processor 302 and a dedicated cache memory 318, temporarily stores networking and service data when a device is in use. The NPC chip, embedded with a Packet Control Protocol, manages connectivity and data transmission within the modem card. It identifies data packets by packet ID, wherein, the next packet selected for processing has an id of a higher magnitude than the packet from the previous wireless router.

Networking data is stored in data structures such as stacks in the cache 318. Service data is stored in queues and other data structures that provide first-in first-out order. The last few N data packets on the last stack of one wireless router are utilized for comparison to ensure packet order and data continuity when networking data from two different wireless routers (nodes). Networked data delivered to electronic devices in motion or stationed via the MWBNIC 300 includes narrow and broadband spectrums operating on Wi-Fi, microwave, millimeter wave and any other.

The networking data packets transmitted to the wireless modem card are received via at least one input port 320 and converted to digital format for use by the device in which it is installed. An input port is also referred to as a communication port or data port.

The modem converts outgoing digital data into a form that is transmittable over the airwaves and this form includes radio waves, microwaves, mm Wave and infrared.

The converters and filters 319, ensures outgoing and incoming signal from input/output 320 is filtered and converted to analog or digital as needed. A plurality of data ports 320 coupled to the user interface 301, processor 302 modulator 303 and demodulator 316 through the Network Packet Controller Chip 317 allows for interaction with the networked devices.

A Near-Field Communication (NFC) chip 322 coupled to user interfaces, memory 301, and processor 302, works in conjunction with the processor to establish a short range connection and read or transmit NFC data on the K-Net device via antennas. NFC processes payments and other data transfers through NFC transmitters and receivers. Graphics and sound controllers 321 are coupled to the user interface which includes keyboard, mouse, touch screen, voice input, memory, power control and processor to control graphics and sound in the K-Net device. The K-Net device embedded with a near-field communication chip coupled to interfaces, the memory and the processor, establishes a short range connection and read or transmit near field communication data.

A safety chip and transmitter with embedded software 323 coupled to the processor 302 and the network packet controller chip 317 controls and manages the safety button that records events and transmit recordings via the network to a server. Functions of the safety chip may alternatively be placed in the processor. A mobile wireless broadband modem running a Packet Control Protocol embedded in a Network Packet Controller Chip for managing network connectivity and data transmission on Wi-Fi and other broadband spectrums controls networking.

In the primary implementation method, the Local Area Network manager connected to the wireless routers by physical wires such as fiber optics, controls connectivity and K-Node switching. In the secondary method, the modem card controls its own connections and switching of nodes.

When implemented to control network connectivity and switching of nodes independently, the modem card is embedded with a mechanism for determining signal strength of nodes in range or a component in place of. This is coupled to the Network Packet Controller Chip 317 and processor 302 for switching nodes and maintaining data continuity.

In another implementation, every other wireless router operates at different frequencies from that of the neighboring wireless router. Networking data packets of the modem card are received from every other node at specific frequencies. The card easily finds the next wireless router to connect to based on frequency at which the K-Node communicates. The frequency up or down converter 305 coupled to the Network Packet Controller chip 317 accomplishes the task of switching to frequency of the next wireless router to be connected to and converting signal as necessary. The process is automated. The spectrum whose frequencies are utilized includes radio waves, microwaves, mm Wave and infrared. One or more filters 307 are utilized to establish more than one simultaneous connection.

The software that runs the card 300 contains a table or log with all wireless router and LAN manager locations in each sub Wide Area Network (SWAN) and their pre-determined values of coordinates or positions for each short distance such as one meter or less. The values provide the next K-Node to connect to based on a device's distance and coordinates. The table of nodes is automatically updated on devices.

The LAN manager which manages connected devices, instructs devices with the modem to connect to specific wireless routers as they move from one location to another. The wireless router to connect to next depends on signal strength relative to direction of motion of the device. The LAN manager utilizes communication frequency of a wireless router to select which wireless router to direct a device to for networking and utility.

The log or table in the card is kept on the LAN manager but at a much wider level covering a very large area of LANs referred to as wide area network (WAN).

To calculate position and coordinates of a device relative to K-Nodes, the algorithm in both the Packet Control Protocol and Network Control Protocol utilize time to leave (TTL) from the connecting device and arrival time (AT) to obtain the signal travel time by subtracting AT−TTL. It multiples this by the signal speed to obtain the device distance from each K-Node in the vicinity. The LAN manager or the modem utilize the pre-calculated and tabulated data in a log to specify a next wireless router to connect to.

In the implementation where the modem decides which next K-Node to connect to, the modem reads logs and choose the next wireless router. The protocol on the modem card is upgraded periodically as the device is moved from one area to another. Alternatively, a next wireless router is determined by calculations using distances between the device and node instead of logs.

A Network Control Protocol (NCP) can be installed on a server to run without LAN managers. Incoming signals are divided into networking signals and data signals.

In one implementation, wireless nodes (wireless routers/net extenders) transmit broadband networking signals at the same frequencies, and they all come through the same filter as seen in FIG. 3. Under this implementation, the modem card is instructed to read and filter in specific frequencies or ranges of frequencies while ignoring any other frequencies.

The modem card is instructed by the Packet Control Protocol embedded in it or by the Network Control Protocol on the nearest LAN manager what node to connect to next based on its position from the nearest nodes. In such a case, calculations are used to obtain relative positions. Alternatively, wireless router performance data is read directly from log tables and utilized in the determination of the next wireless router to connect to.

When three or four data structures such as stacks are utilized in recording incoming data, the writer module writes to stack one and moves onto stack two then stack three. While writing to stack three, the delete module starts deleting stack one. By the time the writer finish writing to stack three, stack one is available for write. The network packet controller chip of the broadband modem with an embedded packet control protocol, and coupled to a cache memory, compares a last packet from a wireless node to a first packet from a next wireless node to connect to, to determine packet order and maintain data packet continuity when switching from one wireless node to another. The LAN manager device transfers service data from a previous wireless node buffered on the LAN manager device to the next wireless node switched to for the broadband modem to access over Wi-Fi, microwave and other bands. Alternatively, multithreading is applied to write and delete to stacks concurrently. Other data structures may be utilized.

An incoming connection signal also referred to as networking signal, comes through the Frequency Up or Down Converter 305 which matches the frequency of the broadcasting node to connect to. Upon establishing a connection, carrier wave signal is filtered out and radio data signal converted to digital format for processing.

Upon demodulation and conversion, the digital data packets are sent to the Network Packet Controller Chip 317 coupled to the cache 318, modulator 303 and demodulator 316 to control data packets in and out of the modem card. The processor 302, Network Packet Controller chip 317 sends the demodulated data through filters and converters, and transmitted 319 to destinations such as the Communication Ports or display 320. Chip functions can be in the processor.

The modem simultaneously receives data packets from multiple nodes/net extenders via at least one input port and deletes the old ones while replacing them with the new packets. In order to maintain packet continuity, the Network Packet Controller chip 317 instantaneously saves the last N packets from each of the nodes that are connected to in memory and deletes the previous N data packets. These N packets are always the last ones and are saved in dedicated cache memory 318 or elsewhere for quick access. Old packets are continually deleted. The cache memory 318 may be a dedicated chip as shown or part of the random access memory 301 or part of the processor. Similarly, the Network Packet Controller chip 317 may be incorporated into the processor 302.

The packet control protocol embedded in the Network Packet Controller chip 317 pushes data packets onto a data structure such as a stack in cache and pops the data packets from the data structure when it is time for comparison of packets. Packets are identified and compared by packet id. The last data packet stored in memory from the last N packets is compared to the first packet in a newly connected to node to determine consecutive data packet order. The last packet from a node is set to X-1 and the first packet from the newly connected to node is set to ID=X (current packet).

When the last packet on the previous node is pushed onto a memory stack and compared to the first packet from the new node such that order is maintained, the new node packets are written to that new stack. If three stacks are used at a time, stack X and X-1 are considered current. The oldest stack X-2 is deleted to allow for new data.

At least one filter(s) 307 are utilized to filter frequency ranges. In an architecture where three filters are used, each of the three filters takes a specific frequency range that is different from the other two. The modem card reads a frequency or frequency range into each of the three filters. In one implementation, the modem activates data from the nearest node in its direction and this is based on signal strength. It listens further and connects to a second node whose frequency range matches that of the second filter. The two nodes are connected simultaneously but they each write data to its own allocated memory space. Data from each filter is directed to its space because it comes from a different node. A module is also assigned to write that data and another to compare data from two wireless nodes. Threads may be utilized to accomplish some of the tasks.

In each case, the modem card stores the last N packets in different temporary storages. Data packets are compared by packet ID. The packet control protocol pops the last packet to be pushed onto a stack or other storage type and compares the last packet from the oldest node to the packet Id of the first packet on the new node.

Data packets in the mobile wireless broadband network interface card are divided into two categories. One is the networking category that allows a mobile device to move from one node to another or connect to multiple nodes simultaneously and maintain the data packet order and continuity over Wi-Fi, microwave or other bands. The other category is the actual data intended for user device. Service data packets in each category are received at different frequencies that are assigned specific ports. The Packet Control Protocol embedded in the modem card maintains order and continuity of packets from different nodes. It compares the packet ID from a previous K-Node to the packet id of the newly connected to K-Node, wherein sets a packet with ID X-1 as previous and one with packet ID X as the current data packet.

The communication packets intended for networking devices and nodes are transmitted at their own frequencies different from the actual data transmitted over the network for the user device, but the networking packets can be flagged and transmitted at the same frequencies through all nodes.

Networking data packets of the wireless broadband network interface card modem are received from every other node at specific frequencies, wherein a connecting modem card easily finds a frequency under which to connect to the next K-Node on the broadband network showed in FIG. 7 and other broadband networks.

In a case where three filters 307 are used for outgoing and incoming signal, each filter in only one or a range of networking data packets. Since every other node broadcasts communication or networking data packets at a different frequency or range of frequency, the nodes in range in a given direction connects automatically; each through a different filter. The mobile wireless broadband network interface card does not need help of a LAN Manager to switch nodes under this implementation. Only frequency hopes accomplish the task of switching nodes though in another implementation, the LAN manager instructs the device what node to connect to.

Utilizing the auto connection based on frequency hops of the nodes or signal strength, the mobile wireless broadband network interface card reads established tabulated data with positions of all nodes for a given direction and determine which nodes to connect to and which to drop. However, the oldest nodes drop automatically as they get out of range of the networking frequency. Frequency filters establishes the nodes to connect to automatically which allows for simultaneous connections.

The actual service data category for a user device includes television data, videos, telephone, audio and text, navigation, video conference data, camera data and so on. Each type of service data received through the mobile wireless broadband network interface card (modem) is transmitted at specific ranges of frequencies so that all services flow through simultaneously without interfering with each other. A port is designated for each range of frequencies. Data packets are identified by packet identification (PID) which PID is sequentially incremented and flagged for the data frame. The PID is used in writing the last N data packets to a temporary storage memory from where they are popped for comparison with new packets from a newly connected to node. This temporary storage memory is a dedicated cache, but it can also be part of the random access memory or the processor. Packet ID numbers appended to device identification also prevents signal interference when multiple devices are sharing the same space and frequency channels.

As showed in FIG. 7, frequency hop refers to the alternation of frequencies on nodes that broadcast networking data packets. This enables automatic connection based on frequency in use. After establishing a connection, the actual service data packets flow through the modem card as desired by the auxiliary device connected.

While frequencies of connection packets are alternated for every other router, data packets for each type of data flow at the same dedicated frequencies throughout all the nodes on the Wi-Fi network of FIG. 7 or other broadband networks. That is, if TV signals flow at frequencies of A-C GHz on one node, it will flow through all nodes at those frequencies. If navigation data flows at frequencies of D-G at one K-Node, it will flow through all K-Nodes at that range of frequencies.

In a one filter architecture, the filter receives and transmits Wi-Fi, microwave signal or another signal through one filter. The frequency of the actual data remains the same through all nodes. Switching of nodes from one to another takes place when signal strength is diminished. Signal strength is determined by a mechanism coupled to the Network Packet Controller Chip 317 and processor 302 but can be determined by a component in another implementation. A device connects up to three or four nodes. Data from each of the node (wireless router), passes through one or more filters. The modem card listens to broadcasts from various wireless nodes in range and receives data packets from wireless nodes through at least one communication port. It reads and determines signal strength on the nodes after which connects to the one's with the strongest signal in its direction of travel. Service data flows through one wireless router or Net Extender (node) until the MWBNIC device switches to a new node on the Wi-Fi, microwave network of FIG. 7 or another broadband network including mmWave. Nodes or wireless nodes, refers to wireless routers and Net Extenders.

The modem card receives signal from the nodes with a time to live attribute in the TCP header. It obtains the time it takes the signal to arrive by subtracting time to leave from arrival time (T=AT−TTL). Multiplying T with signal speed provides device distance from the node. If connected to three nodes, three arbitrary circles are drawn with device distance as the radius. Intersection of those circles provide the coordinates of the device (X, Y). Alternatively, straight lines are drawn between pairs of nodes through the device position generating multiple triangles. The triangles are geometrically utilized to determine any distance required from the nodes. These methods of determining device coordinates and distances are utilized in other devices that we design. The modem card also receives its coordinates from the LAN manager. Three LAN managers that form a triangle in which a modem card is located are utilized to calculate coordinates of the device. After calculation, the LAN manager on which a device is connected forwards the coordinates to the device when needed. Alternatively, a mobile device calculates position.

Signal travel time is multiplied by signal speed to get device distance from the nodes connected to. The distance is utilized to obtain data such as device coordinates from known node positions.

The modem card is assigned a hardware MAC address by which it is identified on the network in addition to its Geographical Internet Protocol (GIP/IP) address and model number.

Another computation from change of position gives the second position of the device with new coordinates (X-x, Y-y) which tells the direction of motion by looking at which node's distance is increasing or decreasing. Direction of motion in turn is utilized to determine which nodes to connect to next. A node broadcasts its presence.

When sending a connection request, a modem card submits its identifying information and type of device requesting for connection to multiple wireless nodes in range. It connects to the nodes with the strongest signal strength until a new node with greater strength is encountered in its direction of travel. After authenticating to the new node, the previous node with the least strength is dropped. It receives data packets from wireless nodes through at least one communication port and determines the strongest signal strength to connection to. This is referred to as auto connect.

The original usage of the priority processing field in the TCP header is to prioritize devices with different retransmission times in case a transmission was unsuccessful. In this network, we utilize that field to prioritize devices with critical need to connect over others. Under this usage, a vehicle on a road may have higher priority over a phone device so the network lets the vehicle connect first. Though we use the original field in the TCP header for compatibility with current networks, we alternatively place it anywhere else in the TCP header but built into a GIP.

An improved packet control protocol (iPCP) for controlling networking data packets and actual data transferred within a mobile device is embedded in the Network Packet Controller chip that resides in the modem. The iPCP in the modem is connected to a mechanism for determining bandwidth or signal strength on nodes. It determines positions of the card relative to the nodes.

The modem card reads transmission frequency of a node. Utilizing either signal strength or communication frequency of a particular node, the modem card selects which node to connect to without help from the LAN manager. The card periodically downloads a routing table with nodes in the area where it is located.

The modem card is instructed by the LAN manager to connect to a next node based on its position from the nearest nodes, wherein pre-determined data is utilized to connect. Pre-determined data includes location of each node and LAN manager, and any positions between them and signal strength at each location. An improved Card Control Protocol (iCCP) is designed to control activities between the modem card and the wireless nodes. The CCP resides in the nodes. Not shown is a multiplexer for combining different outgoing data into single output for easy transmission and a demultiplexer for receiving incoming bundled data and splitting the data into individual sources destined for individual application ports.

The network system comes with four network protocols namely an improved Card Control Protocol (iCCP) that runs from the node (wireless routers/net extender) for identifying and authenticating K-Net devices, Net Extender devices and other devices, and providing electronic services, wherein the iCCP working symbiotically with an improved network control protocol (iNCP) that runs from the LAN Manager or server to manage connectivity on a local area network manager and servers. The system also comes with a Packet Control Protocol (PCP) that runs from the connecting device. The network control protocol, the card control protocol and the packet control protocol work symbiotically to establishing a connection and switch from one node to another node. A geographical internet protocol (GIP) secures devices and data. When a node (wireless router) receives frames from a modem card device, the signal is forwarded to the LAN manager or server for authentication upon verification.

A user configures a K-Net device to auto save user data including contacts to server and utilizes device location data saved to a LAN manager to configure location sharing including disabling share. Data saved to server, is synched on multiple devices owned by the user when configured.

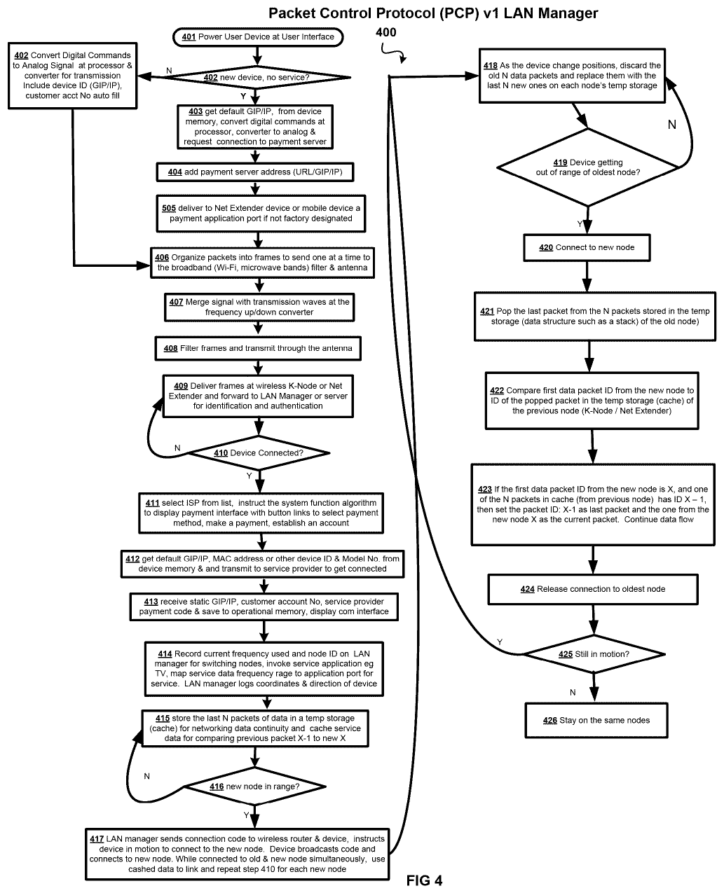

FIG. 4: The algorithm of FIG. 4 400 represents an improved Packet Control Protocol (iPCP) for controlling connectivity of moving devices; and data flow on one or more nodes (wireless routers and net extenders) without losing signal continuity. The iPCP enables a device to connect to internet service provider (ISP) networks without action from service providers.

In one implementation, frequency at which a node transmits connection packets switches from one wireless router or net extender to the next; and in another implementation, it is bandwidth; and in a third, it is pre-determined positions data on a Local Area Network (LAN) manager device.

While in motion, a mobile device or autonomous vehicle is instructed by the LAN manager what node to connect to and it connects to a new node. These nodes are pre-configured to broadcast connection signal at specific frequencies which are easily picked up by the Frequency Up or Down converter. For data continuity to take place, the modem has to be connected to at least two nodes simultaneously during a switch of node.

If a K-Net device has no service with an ISP, a device owner auto connects and pay from the device using one of the multiple payment methods including purchasing a pre-paid connection card with a connection pin from an ISP and use it to establish an account.

Auto connecting a device to a network without an ISP action: Powering on a device at a user interface 401, initiates a connection request to the nodes. The request which is in form of digital commands is converted to analog signal by a converter and encoded by the modulator 402 for wireless transmission. If at instruction 402, a device is new and have no service, the iPCP reads an operational memory 403 and gets a default GIP or default IP that is configured to connect to internet service provider (ISP) networks without purchasing service but for administrative purposes such as payment or receiving emergency weather alerts. The iPCP invokes a connection module that submits a connection request based on the default GIP or default IP built into the device memory connection module. The module prompts for a payment server address 404 in form of a universal resource locator (URL), GIP or IP address. The module through the processor and converter converts the digital commands to analog signal and encodes a connection request through the modulator. A payment port is pre-configured but if not configured, it is configured in the device 405.

The signal is amplified, and packets are organized into frames 406, to send one frame at a time. The signal is modulated and merged with transmission waves at the frequency up/down converter 407, and sent one frame at a time through filters 408 to the antennas for transmission to nodes over Wi-Fi, microwave, millimeter wave or other spectrum bands. Delivering the frames at a node (wireless router/Net Extender) 409 over Wi-Fi or microwave bands for identification and forwarding to a LAN manager and server, for authentication and connecting to a payment server. The connection request is submitted through antennas to a broadband node that forwards the request to a LAN manager device then to a payment server. Upon connecting the device 410, a list of ISPs is displayed on a screen of the mobile device, autonomous vehicle or a screen connected to a Net Extender such as a television screen or computer screen for a user to select from 411 and the payment module instructs the system function algorithm to display a payment interface which is displayed with button links to select a payment method, make an electronic payment and establish an account with the ISP. The ISP list is updated regularly to include all ISPs in a country or region.

The connection module extracts and submits the default GIP or default IP along with a MAC address or other device identifier and model number from the device's operational memory and transmits to the paid service provider (ISP) to get connected for service 412. This is submitted along with the customer account number established in the payment system, a payment confirmation code and ISP code. Thus, the ISP system takes as parameter (1) a default GIP or IP (2) a device ID such as a MAC address, (3) a model number, (4) a customer account number generated in the payment system, (5) a payment confirmation code which shows a client device payment status and (6) the ISP payment code read from the payment system. This is sent along with any other identifiers that may be needed. The account is automatically registered with the ISP in a log (file or database) under the customer account number. Account names may be recorded in the payment system when making a payment initially. However, a pre-paid scratch card may be used on a new or used temporally device without registering usernames.

After a device making a payment and registering with an ISP, the ISP in turn provides a static GIP or IP address and a transient GIP or IP address 413, wherein the static address is saved to an operational memory of the modem or device. The static GIP/IP replaces the default one that comes with the device and the transient GIP/IP is saved in a connection log on authentication servers for a short term use. Whenever the transient GIP/IP expires in 24 to 72 hours, the modem transmits the static GIP/IP seeking for a connection and the GIP/IP is verified providing a new transient GIP or IP.

The following items are saved to a device or device modem for auto connection on boot. A service provider payment code, a device account number and a client device payment status. After a device is registered to an account with the payment system and the ISP, the device submits these parameters along with the GIP/IP each time it is seeking a new connection to the ISP. Unless turned off, the device stays connected when powered. A user only launches an application to use.

The LAN manager logs (records) current frequency used on the node connected to and the node ID. It also logs coordinates and direction of the device in preparation for switching nodes. Based on direction and current location, the LAN manager determines a next node (wireless router/net extender) the device is going to connect to either by frequency of the node, bandwidth, calculation, or from a table of pre-determined nodes in memory, relative to position of the device. Node performance is pre-tested at given distances from LAN manager devices and saved in memory of the LAN managers with frequencies, bandwidths and coordinates of good performance for each node 414. When a user invokes a service application such as television, the system maps the service data frequency range to an application port for the selected service 414. An ISP system verifies a device seeking access to the electronic resources, and verifies the internet service provider to which the device is connected. The verification by the ISP system is returned to a resource provider for authentication.

The LAN manager device running an improved network control protocol (iNCP) counts N data packets for each type of service the user accesses when in motion and stores the packets in temp memory or cache 415. After the first N packets, the subsequent packets become the last N packets.

As for the last N packets of data stored at any given instance on a mobile device 415, a data structure such as a stack is used. Two or three stacks accomplish this task for each data type. If for example, the system utilizes N to represent 15 data packets, we can use 3 stacks and write 5 packets to each stack, storing the last N packets of data in the temp memory (cache) for networking and service. Once the first stack is full and at least one packet is written to the second stack, a delete method or function is called to clear the first stack with the 5 data packets. By the time the second stack is full, the first one is emptied and that is written to again. Three stacks are better than two. The process of writing and deleting the packets on stacks continue until there is no more data flowing in. Other data structures, files or databases could be used but a stack is much faster because it is a last on first out structure. Threads can also perform concurrent packet processing when writing and deleting.

The last packet to be written to a stack is always on top and it is the first one to be read off for comparison with a packet from a new node to determine continuity and packet order. Threads may be utilized to multitask. When a new node is in range to connect to 416, a LAN manager or server 417 sends a connection code to the node (wireless router/net extender) 809 and sends the same code to the mobile device or vehicle (mobile) instructing to connect to a new node 417. The mobile device or vehicle broadcasts the connection code 809. The node that received the same code (804 node 2) compares and connects when the code matches. While in motion and connected to both the old and new node simultaneously 417, the mobile device utilize cached packets in the network controller chip to complete the networking using the Network Control Protocol and repeats steps 416-417.

As the device change positions 418, the device discards the old N data packets and replace them with the last N new data packets on each node's temp storage. The modem device is programmed to simultaneously connect to two or more nodes.

Each data type is allocated its own memory to save the N packets. If the device is connected and different data types such as television, phone and navigation signals are inflowing, as well as network instructions for switching nodes (wireless router/net extender), there can be four different groups of memory allocations for this situation. If three stacks are used to store the last N data packets for each type of data, the instructions for switching nodes are allocated different memory areas. Television data is allocated three stacks, phone data is allocated three stacks and navigation data is allocated three stacks. Each data type has its own module that writes to its stacks so one data type does not interfere with writing on other stacks. Multiple threads run concurrently to have many tasks accomplished simultaneously. Additionally, multiple mobile devices switch nodes.

If the device with a built in or connected modem is getting out of range 419, it connects to a new node 420. When data packets start flowing from a new node (wireless router/net extender), the last packet from the previous node to be stored on the stack is popped from the temporary storage 421, and compared to the first data packet from the new node 422. If the current packet from the new node has ID of X and the packed on top of the last stack to be written has ID of X-1, 423, then packet with ID X-1 is set as the last packet and the new packed with ID X is set as the current packet. The data stream continues to flow as if all packets came from the same node.

After establishing data continuity from the old node and the new node, the old node 424, is dropped and its stacks emptied. If the device is still in motion 425, the algorithm loops back to step 418 and continue downwards else stay on the same nodes 426.

Every LAN manager keeps updated connection data of all nodes in a Sub Wide Area Network (SWAN) and currently connected user devices on the Local Area Network. However, it stores identities of local devices as well. When a user device from a different SWAN connects to a LAN manager that does not have its information because it is located in a different WAN, verification and authentication takes place from servers.

All functions of the Network Packet Controller Chip are alternatively placed in the microprocessor. Similarly, verification and authentication of the modem that takes place at the LAN manager could take place at the K-Node level or at the authentication servers.

When a used device is discontinued from an ISP and has no service, a payment module provides a reset button link for resetting the service provider's static GIP or static IP to a factory default GIP by erasing the ISP static GIP/IP from the operational location memory and copying the default GIP from a permanent factory location to the operational location easing the switching of ISP.

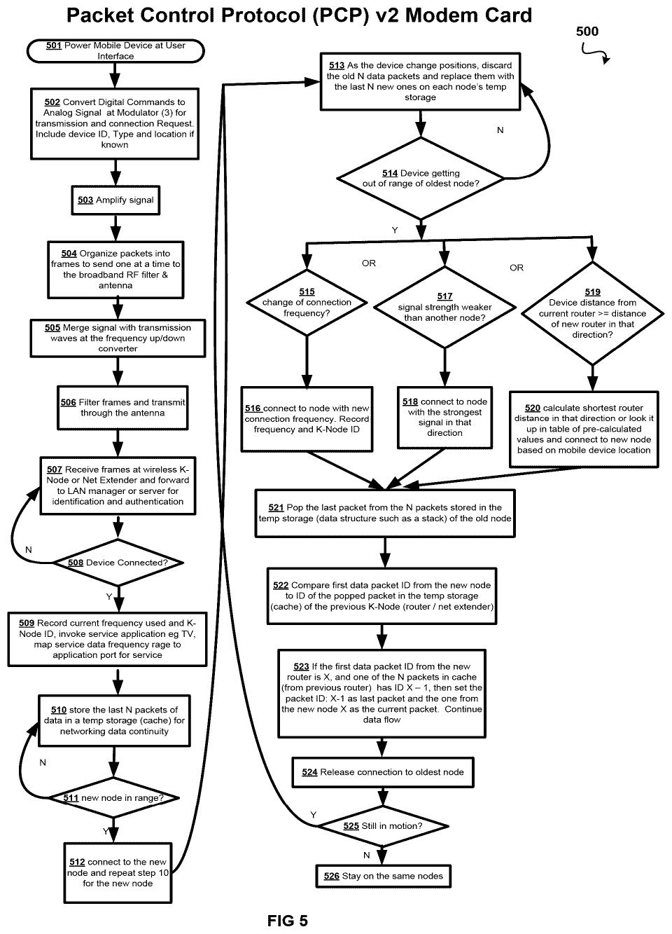

FIG. 5: The algorithm of FIG. 5, 500 depicts a different version of the packet control protocol (PCP) that lets the mobile modem card find its own node (wireless router/net extender) to connect to without being instructed by the LAN manager or server. The PCP is embedded in a Network Packet Controller chip in the modem card to facilitate connectivity and service data flow.

Powering a mobile device or autonomous vehicle 501, transmits commands to connect to the processor 502, converter and modulator, and are converted from digital to analog signal for transmission, filtered and superimposed onto a carrier signal for wireless transmission to a router or net extender. The signal is amplified 503 and packets organized into frames 504 sending one at a time to the filters and antennas for transmission. Signal is merged with transmission waves 505 at the frequency up-down converter. Frames are filtered and transmitted through the antennas 506. Device ID, type and location are utilized when connecting.

At a node (wireless router/net extender) 507, frames are received and forwarded to a LAN manager device or directly to server for identification and authentication. The LAN Manager keeps logs of all mobile devices connected to nodes on its LAN, fiber/high speed wires that connects the LAN manager to the wireless nodes along with embedded protocols and software. The protocols and chips in which they are embedded, facilitates authentication, node switching while in motion and data transmission on the network. Authentication times are recorded for different kinds of user devices along with data transfer capacities. When connected 508, the LAN manager records frequency used and node ID 509, and invokes a service application and port, mapping the service data frequency ranges to application port for service if not factory configured. In another implementation, a K-Net device is factory configured with frequency and port for every application that provide a service.

The user service data is subdivided into categories specifying the types of data being transmitted. Packets in each category are received at different frequencies which are assigned specific communication ports. This allows for all services to flow simultaneously without interference. The mobile wireless broadband network interface card reads pre-determined and tabulated positions data which provides it with the next node to connect to based on its calculated distance and coordinates. The application monitors, repeaters, authentication servers, Internal DNS servers (IDNS), GIP/IP allocation servers, firewalls, Gateway to the internet all connected by wires such as fiber optics that delivers high speed data transmission. A combination of all these with the protocols makes the network function and the design allows both broadband and narrow bandwidth to provide data and determine bandwidth on nodes.

A signal mechanism for determining signal strength at wireless nodes on the K-Net network comprising pre-determined values stored on the card or read from the LAN manager. The LAN manager store logs of all wireless nodes on their local area network. These logs include but not limited to geo-locations of all the wireless nodes and radius under which the nodes perform well. When a modem card requests for a connection, or move to a new location where it is going out of range of the connected to node, the LAN manager reads the logs and determines which wireless node is to sustain the modem card based on its current position and direction. Alternatively, a component is utilized to determine bandwidth and signal strength.

When switching from one node to another 510, the PCP in the network packet controller chip stores data packets from the currently connected to node in a temp storage or cache for networking and data continuity. While connected to the old node, the device simultaneously connects to a new node 511, store packets from the new node in memory (data structures) and preferably stacks 512. Packets are compared for continuity and networking takes place. As the device change positions 513, the protocol discards the old N packets replacing them with new N packets in the temp memory. When getting out of range 514, the mobile device or vehicle auto connects based on frequency of the node 515 and record node ID and frequency at which connected 516, or auto connect based on detected signal strength of a next node in that direction 517-518. The device can also calculate or read pre-determined tabulated values based on tested performance for each node radius 519-520. In either case, pop the last packet from the N packets stored in cache of the old node (data structure such as stack) is popped from the temporary storage 521, and compared to the first data packet from the new node to ID of the popped packet in cache of the old node 522. If the first data packet ID from the new node is X and one from the top of the last stack (data structure) or N packets in cache of the old node is X-1, set X-1 as the last packet on the old node and the new packet with ID=X as the current packet. Concatenate the packets for service data and continue with data flow 523. Release the connection to old node 524. If still in motion 525, repeat process, else stay on node 526. After the first N packets, the subsequent packets become the last N packets. After establishing data continuity from the old node and the new node, the old node 524, is dropped and its stacks emptied.

The data stream continues to flow as if all packets came from the same node. The data port set as current or active for device data utilize a data structure that is first-in first-out such as a queue. A stack which is a last-in last-out, stores networking data for comparison. Two, three or more stacks are utilized to store networking data.

Service data of each kind is assigned to a specific port which port is associated with specific frequency ranges; hence running. multiple applications without interference.

After networking, an application opened on a device submits a request stating the type of service needed. The Network Control Protocol in the LAN manager assigns an application port for both the device and LAN manager connection. If the device happens to be in motion, the port stays constant until the device is disconnected. When switching nodes, the port and other connection info is forwarded to the new node. Alternatively, a new port is issued at each new connection.

To check if a modem is still in motion, two variables are declared. Current distance and new distance and are both set to zero. Current distance is calculated and set to actual distance. After a change of position, the new distance is calculated and assigned to the new distance variable. The direction that decreases most distance between the device and node becomes current direction that is N, NNE, NE, EN, EEN, E.

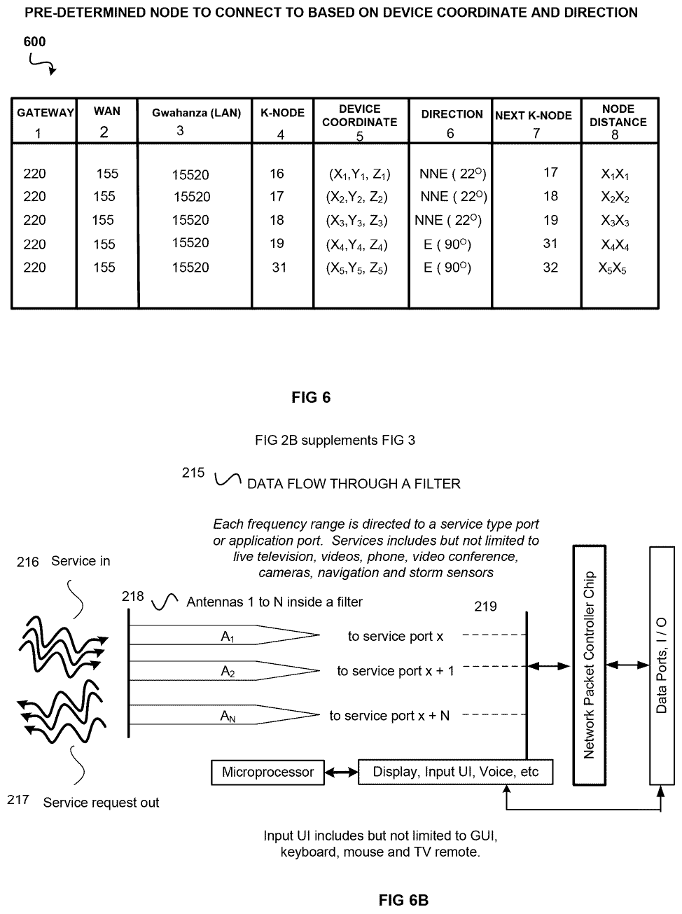

FIG. 6, 600 is a data structure in a tabular form representing a routing table. The data structure could be a harsh table, list or other that allows quick data access in the random memory. It is used in conjunction with the algorithm of FIG. 5. In one implementation, data resides on the user device (modem) and in another implementation; data is retrieved from the LAN manager or server on the network. The tabular form shows a gateway to the internet, 1 that a device is connected to. Utilizing routing tables, the gateway easily identifies the Wide Area Network (WAN) 2 where the user device is located. To further narrow the search, identification (ID) of the LAN manager 3 on which the Network Control Protocol resides is used. This narrows the search to only the nodes that are connected to that LAN manager. After locating the LAN manager on which the user is located, the algorithm reads the actual node 4 the user device is connected to since a log of nodes is kept on the LAN manager when a device is in motion. Distance of the node 8 is used with two other distances from two other nodes to determine coordinates of the device. Utilizing device coordinates and direction, the algorithm reads the next node to connect to from the tabular data. Not shown in the attributes is the speed of the modem or device from speed equals distance covered divided by elapsed time St=D/t and tabulated.

Alternatively, the packet control protocol algorithm calculates distances from three nodes and its direction of travel then draw arbitrary circles whose intersection provides the (x, y) coordinates of the device. At any device coordinate, the algorithm reads the next node, 7, to connect to in that direction from the table by comparing to the coordinate, 5 FIG. 6.

In one implementation, the LAN manager 805 receives signal from the modem via a node and utilize arrival time (AT) of the signal, time to live (TTL) and time spent on the way T=AT−TTL. Distance traveled by the signal (D)=T x c (speed of signal) which gives current position of the device and coordinates. Since positions of all nodes are known, a node at a shortest distance in a direction of travel is determined. Similarly, the mobile device or autonomous vehicle can take the same steps. However, it keeps a routing table or log of all the nodes on LAN and node distance so it can just read from the routing table.

In another implementation, tabulated values reside on the device such that they are just called upon to direct the device which node to connect to and which direction to take based on current device coordinates. These pre-calculated values include all positions of nodes, LAN managers, and coordinates of all the positions in between the nodes in increments of one meter or less. To obtain these lengths, the algorithm table 600 utilizes positions of nodes relative to longitude and latitudes in the vicinity of LAN managers. Degrees are converted into distances and tabulated. Distances and angles of nodes are utilized in conjunction with device and signal speed hence direction is calculated.

FIG. 7: A wireless router (node) 701 connects to a Local Area Network (LAN) manager 702, by fiber optics, copper or other wire 708-a that connects to servers 709, 710, 711. A plurality of lines 708-b with ports connecting to the nodes 701 at one end and LAN managers 702 on the other end.

Plugging fiber into a LAN manager 702 and powering the LAN manager on initiates a connection, to a server or another LAN manager to connect to, to establish a network. The LAN manager connects to zero or one server but connects up to four other LAN managers storing addresses and paths of the connected to LAN managers and server. If a LAN manager is away from a server room, it does not connect to any server directly FIG. 7. If a LAN manager has 8 ports on each side, connects and manages up to 32 wireless routers but more ports are added as needed.

Each wireless node 701, is independently connected to at most four nearby LAN managers 702 showed by the thick solid lines with arrows from 701 X. Plugging a wireless router into a port of a LAN manager and powering the wireless router 701 establishes a connection to the LAN manager plugged in and the node starts broadcasting its presence to wireless user devices. If four ports are connected, up to four LAN managers are connected to, and addresses of the LAN managers, and paths are stored in memory of the node. A mobile device 703 connects to the wireless node.

A divided Net Extender (DNE) device 704 that resides in buildings to provide network extension to the building, is embedded with the improved Card Control Protocol in a G chip and traffic controller chip for improving the K-Net communication network on which the devices run to securely provide electronic services, acts like an independent K-Node providing access to other devices such as televisions, computers, accessories and automobiles. The DNE with a circuit board, memory and at least one chip for managing connectivity of user devices and providing electronic services to the user devices, provides a private chamber 704A utilized only by specific user devices in a building and a public chamber 704B to which any mobile device connects to maintain network connectivity on the K-Net network, wherein a modulator superimposes signal onto a carrier wave to connect to wireless nodes on the K-Net network and a demodulator and filters recovers signal from the nodes; The DNE device provides data ports for plugging fiber optics, Ethernet, USB, HDMI or other wire ports for connecting user devices though wirelessly connects to at least one wireless router device for the electronic services over cellular receiver, microwaves, millimeter waves and the Wi-Fi bands. Connects to user devices to provide said services. A rechargeable battery 1324, is coupled to the power source for off grid use. The LAN manager device works in conjunction with the wireless router device to manage connectivity of the mobile devices, the vehicles and the Net Extender devices “user devices”, utilizing the modem card, wherein the LAN manager device networks the mobile devices and vehicles switching from one wireless router to another when in motion.

The improved Card Control Protocol on the nodes and divided Net Extenders, networks and transfers devices from one Net Extenders or wireless routers to another to maintain continuity of data packets while in motion.

The divided Net Extender (DNE) device that wirelessly connects to the K-Net broadband network via Wi-Fi, microwave and other broadband spectrums to establish a network extension, provide electronic services including television service, phone service, video conferencing service, computing service, and payment service. The com interface and related functions are installed on a storage media in the divided Net Extender device to provide the services via the com interface on a television display, a computer monitor, a wall projection or other screen at specific frequencies and packet identifiers.

The DNE device powered by direct current (DC) in addition to alternating current (AC), connects to wireless router devices with an improved card control protocol and connects to a LAN manager device with an improved Network Control Protocol (iNCP). The DNE is embedded with the improved card control protocol in a G chip and works in conjunction with the at least one LAN manager device and at least one server to provide the electronic services. The Net Extender device storing data on a storage media, provides the com interface, tabbed interfaces and other interfaces for launching the electronic services.

The divided Net Extender device connects mobile devices to a public chamber at specific networking frequency ranges different from the private chamber frequencies at which the devices in a home or office building connects at hence preventing signal interference.

The LAN manager device on the K-Net network stores account payment status info and initial connections of divided net extender devices that connects through said LAN manager in memory, keeping at least one log. The LAN manager device updates the account payment tatus info once every X hours where X is 24, 48, or 72 hours. The LAN manager transmitting data about a divided net extender to a server for the first time, memorizes a shortest path for sending data to the server and a second shortest path and a third shortest path and a fourth shortest path for every net extender connecting to the LAN manager, wherein the LAN manager keeping the paths as a log table, sets the paths saved in memory as primary, secondary1, secondary2 and secondary3 for quick connectivity, delivering connections in a shortest possible time without verifying with a server each time. Functions of the LAN manager 702 are alternatively transferred to a server.

F1, F2, F3, F4 and F5 shown in FIG. 701 above the various nodes lies in a category of frequencies utilized to connect a modem card to nodes. These frequencies are different from the frequencies at which service data flows. The network frequencies are interchanged at every node so that neighboring nodes do not broadcast at the same frequencies to attract the same device at the same time. This helps the device to automatically connect to the nearest frequency in range. Devices connect to more than one node simultaneously.

In the network of FIG. 7, 700 flat antennas, 705, are coupled to LAN managers 702 or wireless routers 701 to harvest free television channels in the air into the K-Net network. The signal is demodulated to digital for television consumption. These channels become accessible to all devices that have this modem card 703 built in or plugged in via a communication port such as USB, HDMI, or other, and are available to Net Extenders. The television signals are collected and distributed in real time and saved as well for later distribution. Like all other services, the television service has its category of frequencies that allows all types of data to flow simultaneously without interference to each other. The modem card is built with at least one external port that connects to wires including fiber. The divided Net Extender device provides the electronic services to the user devices. Every wireless router or node and LAN manager is placed at a known location with global positioning. When a device connects, the device automatically detects location coordinates for automatically configuring local television channels to the area channels. User devices and the network provides for at least one of automatic configuration of a default local television channels based on location of a wireless node connected to, and configuration of default channels by selecting or entering one or more area identifier. The area identifiers include at least one of an area code, a zip code, a postal code, a country code, a city name, a region name and other identifiers. Every wireless router or node and LAN manager is placed at a known location with global positioning.

Some of the LAN manager devices 702, of FIG. 7 are connected to line of site dish antennas 706, that receives data signals from other antennas 707 using microwave transmission or other signal types. The dish antennas connected to 702 or nodes 701 are placed on higher ground and utilized to bridge signal across rivers, mountains or places where it is difficult to run fiber optics and other wires. Fiber optics, copper or other wires 708a or 708b, connects LAN managers 702 to servers in a data center 709, 110, 111. Fiber optics or other wires 712 connects a data center to external networks 713. Satellite signal uplink and downlink antennas 714, connects to wireless routers (nodes) 701 or LAN managers 702 to exchange and distribute data with user devices and sensors.

Each wireless router directly plugs into the four nearest LAN Manager devices utilizing fiber optic lines with varying length depending on location distance. For instance in FIG. 7, each wireless node 701, is independently connected to four nearby LAN Managers 702 as showed by the thick solid lines with arrows and varying fiber optic lengths from the node labeled 701 X for transmitting data between the LAN manager over fiber optics or wires on one side and mobile devices and Net Extenders over Wi-Fi and microwave bands on the other end.

FIG. 8, 800 represents a K-Net Local Area Wireless Broadband Network (LAWBN) providing electronic services. The K-Net device is comprised of a user device or television 801 connecting wirelessly to a divided Net Extender device 802 on a private chamber 802A while the net extender connects wirelessly to a wireless router 804 node 4 through a wireless modem card. The wireless nodes 804, the Local Area Network manager 805 and server 806 connects to each other via fiber optics, copper or other types of wires 807. A mobile device or autonomous vehicle 803 connects to a nearest node 804 node1 by authentication. Though nodes can be configured to communicate with each other, the best implementation is when they communicate only with the LAN manager devices to which the nodes are directly plugged into on one side and the other side the nodes communicate with wireless devices over Wi-Fi, microwave, millimeter wave or other broadband spectrums.

The LAN manager devices 805 communicate with the nodes 804 on one side and communicate with servers on the other side as showed in FIG. 8.

The nodes on the K-Net network of FIG. 8 broadcasts their presence. They are built with identifiers that distinguish them when they transmit data. The Packet Control Protocol (PCP) embedded in the Network Packet Controller chip of the modem, establishes connectivity by comparing the identifiers of the nodes to connect to and saving the incoming signal from those nodes to buffer for processing and authentication.

To maintain connectivity, a device in motion simultaneously connects to more than one wireless router networking through a packet control protocol embedded in a Network Packet Controller chip. The protocol and chip in the user device work in tandem with a card control protocol embedded in a traffic controller chip or in a G chip that is coupled to a processor in the wireless router to accomplish connectivity and data transfer tasks. Thus, a device in motion maintains data packet order and continuity when switching from one wireless router to another.

The wireless router in turn, works symbiotically with an improved network control protocol embedded in a traffic controller chip or in a G chip that runs in the local area network (LAN) manager device, the one that controls overall connectivity and directs devices which node to connect to next. For every connection, data is buffered at the LAN manager to facilitate node switching.

Data flowing through the network is divided into two main categories namely networking and user device service data. The user service data is subdivided into categories specifying the types of data being transmitted. Packets in each category are received at different frequencies which are assigned specific communication ports. This allows for all service types to flow simultaneously without interference.

Connecting to a node. Prior to connecting, a device submits it's connection request which includes its identity. The device's identity is comprised of its MAC Address, Model, static GIP or static IP Address and other data such as its location (x, y, z), phone number. The node appends its id and forwards that information to the nearest Local Area Network (LAN) manager which verifies the device with a server and authenticates.

Switching nodes. In one implementation, the LAN manager keeps log of positions of the device. When the LAN manager detects that the device is getting out of range of the node it is connected to 804 node 1, the LAN manager 805 generates a connection code and appends the code along with the LAN manager ID to the connection request. This also include a device ID and a next node ID. The LAN manager reads a log of nodes from its memory (routing table). Based on pre-determined performance for every location, the LAN manager determines the next node to connect to and transmit a connection request with a connection code 809 to the next node to connect to 804 node 2 via fiber optics, copper or other wire 807. When a device is in motion, the LAN manager creates a session for that device and loads in cache all the possible nodes the device can connect to for quick access. Alternatively, the LAN manager may calculate the positions for each device.

This is a highly secure method of connecting and switching nodes. Data is strictly directed to the device with specifics that only that device can provide to authenticate. The connection code changes for every connection request.

A node saves each connection request to a different memory location or data structure such as a stack based on id of a mobile device seeking connection so that requests are not mixed up. A variable may be generated for each request instead of a data structure.

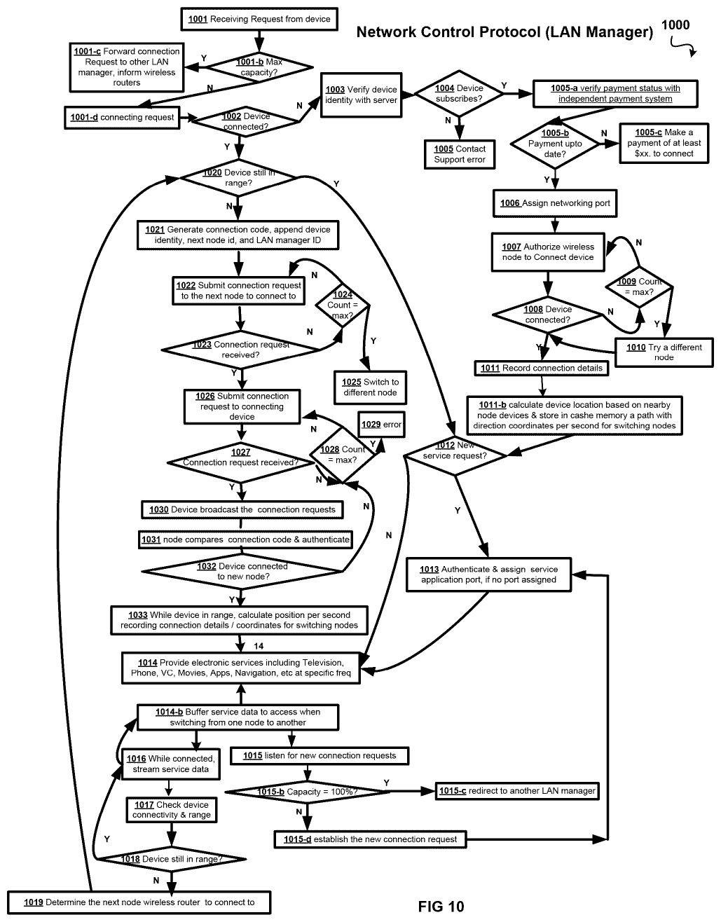

The LAN manager also transmits the connection request with the code 809 to the mobile device via the currently connected to node 804 node 1. The mobile device or autonomous vehicle 803, broadcasts the connection request with the code 809, 808 over Wi-Fi, microwave or other broad bands. The nodes in range (804 Node 3 and Node 4) peeks at the header which includes id of the next node 804 Node 2 and ignores the request because it doesn't belong to them. Only the next node (804 node2) whose id is the same as that one in the connection request extracts the request. The next node (wireless router) to connect to next retrieves the request it received from the LAN manager previously saved to temp memory and compares to the connection request submitted wirelessly by the device and authenticates the device to switch to the wireless router for service. This is also shown in the algorithm of the network control protocol FIG. 10.

The LAN manager 805 establishes a small local area network (LAN) comprised of itself the manager, several wireless nodes connected to it by high speed wires such as fiber optics or copper and logs of geo-locations and radius under which the nodes perform well and values of signal strength corresponding to each location it serves by coordinates.

The LAN manager keeps a log of a connected mobile device or AV. The log includes the device's current location (X, Y), direction of motion relative to the wireless routers (NE) within range, the current local area network WAN, the current node connected to 804 node 1, node distance, time, the current network connection port and any application ports assigned to the device. The LAN manager 805 establishes the next node 804 node 2 and adds it to the log for swift retrieval when needed. The next node changes when the device changes direction or gets away from the next node. Alternatively, the LAN manager may instruct a mobile device or AV what node to connect to next based on bandwidth of a node or frequency at which the node operates.

Alternatively, a modem automatically connects to a node during node switching instead of being instructed by a LAN manager. Here, the modem does not need a connection code, but security is not reliable and battery life may get diminished. A malfunction node may be difficult to detect in time without a LAN manager to track positions in a. wide Area network (WAN).

When the device is getting out of the LAN manager's local area network range, the LAN manager 805 reads the routing table and forwards the device 801 to the next LAN manager on a WAN.

Whenever a switch of node is initiated, an active connection request on a LAN manager is reorganized by deleting the previous node and creating a new request showing the current node as the origin and the request includes the device ID, ID of the current node, ID of the LAN manager and ID of the next node to connect to and more.

The broadband modem, which networks data from more than one source receives data packets from multiple nodes via at least one input port. It saves the data packets from each node instantaneously utilizing at least one data structure preferably a stack. A few packets are written to each data structure each time. The N data packets are simultaneously deleted from the oldest data structure. Alternatively, data is cached in the random access memory. Only the last N packets are preserved each time for comparison to data coming from a new wireless router. The previous N data packets are deleted as new ones come in to replace the old packets.

The modem card is built into many electronic devices as a modem. These auxiliary devices include mobile phones, tablets, laptop computers, automobiles, home televisions, car televisions, cameras, navigation devices and any other that requires wireless networking to access broadband spectrum over Wi-Fi bands, microwave bands, millimeter wave or other broad bands. This enables a user to watch live television or video conference while in motion. It is also built as a plug and play modem inserted into external device ports such as USB to deliver service.

The modem card stores temporary connection data from the network in a mini database or a file placed in its memory. The connection data is retrieved to physical memory prior to completing authentications and networking. Data stored in this database or file is utilized to complete authentication and a network connection and switching from one K-Node to another. Similarly, the software accesses the data when the data is stored in a file instead of a database.

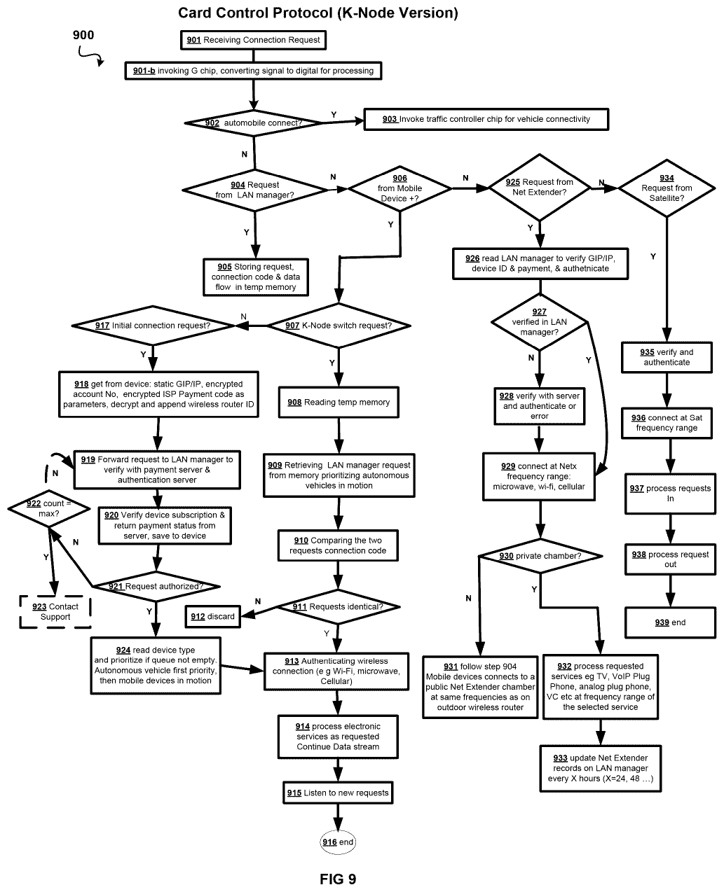

FIG. 9, 900 is the algorithm of the improved Card Control Protocol (iCCP) that runs on wireless routers and Net Extender devices (nodes). Instruction 901 receiving a connection request and a processor coordinating the converting of the signal to digital for processing within the node 901-b invoking the G chip to process and transmit the request. If the request is from autonomous vehicle 902, a traffic controller chip (TCC) 903 is invoked to process connectivity. Though the TCC can provide electronic services, the vehicle obtains other electronic services through the G chip dedicating the TCC to traffic signal. If the request is from a LAN manager for a device to switch node 904, the protocol stores the request and connection code in temp memory (cache) under ID of the device seeking a node switch 905.

If the request is from a mobile device (user device or autonomous vehicle) 906 seeking to switch to a new node (wireless router or Net Extender) 907 receiving the request, the algorithm reads cache 908 and retrieves a request from the LAN manager saved in memory under ID of the device seeking a connection 909. At 910, comparing the two requests and connection code, if the requests are identical 911, authenticate the device over Wi-Fi, microwave or other broadband spectrums 913. Process electronic services requested and continuing with data stream 914. Protocol listens to new requests 915.

If however the protocol found the request at instruction 907 to be a first time connection request 917, get connection parameters supplied by the device including: a static GIP or static IP used for an initial connection request, encrypted device account number, encrypted ISP payment code and a payment status as parameters, decrypt and append the wireless router ID 918 then forwarded the request to a LAN manager device to verify with payment server if the payment status is not current, else send to authentication server for a connection 919. The protocol verifies the device subscription returning a payment status from server to save to the connecting device for future connections 920 when payment status ok. If the request is not authorized 921, the protocol counts to a pre-determined number of trials and if attempts to connect gets to the maximum trials 922 such as three, the device is directed to contact customer service 923. If the device is authorized 924, the protocol reads device type from the GIP and prioritize based on type of device, autonomous vehicles taking highest precedence. A verification table or file on the verification server contains subscription info and payment status among other data.

If the request was from a Net Extender 925, the protocol verifies validity of the GIP or IP, device ID and payment status with LAN manager or server and authenticate 926. However, payment status for each Net Extender is stored on accessible LAN managers and on the Net Extender so verification takes place at the LAN manager. If not verified at LAN manager connected to 927, the LAN manager forwards the connection request to verify with a server and authenticate or error 928. The divided Net Extender connects to wireless router nodes wirelessly at a frequency range different from mobile devices and autonomous vehicles 929.

When the improved card control protocol (ICCP) is running on a Net Extender 930 and a request comes to a public chamber 931, the request is redirected to step 902 to check if it is an automobile and if not, it is directed to step 906 to check if it is a mobile device and gets authenticated at the same frequency range as that at the wireless router. If, however, the request is to a private chamber of the Net Extender, it is determined that the request is from a device owned by the owner of the Net Extender and connected to the private chamber 932 to access the electronic services including television, Voice over GIP/IP phone, video conference, radio and other services. The Net Extender records are updated on the LAN manager every X hours (X=24, 48 etc.) 933.

If the request is from a satellite 934, the request is verified with the server and authenticated 935 connecting at satellite frequency ranges 936 and processing in requests 937 or process requested satellite data out 938 or end processing 939.

FIG. 10, 1000 an algorithm for the improved Network Control Protocol (iNCP), runs from the Local Area Network (LAN) manager. The iNCP is embedded in a G chip, a traffic controller chip (TCC), in a processor or any other easily [000-c13: b P43] accessible memory. A K-Net device with a broadband modem running a packet control protocol embedded in a chip of the modem card, submits a connection request to a wireless router 501-507 and the wireless router forwards the request to the LAN manager 1001. Receiving a request from a device via a node (wireless router or net extender) 1001, the protocol tests to see if the host LAN manager is operating at maximum capacity 1001-b, and if true, the LAN manager protocol redirects new connection requests to other neighboring LAN manager devices when at maximum capacity, 1001-c and transmit a message to inform the plurality of wireless router devices connected to, not to send in new connection requests until notified 1001-b.

If not operating at full capacity, the protocol receives the connection request and authenticates 1001-d. If not authenticated 1002 the protocol verifies the device identity with a server 1003. If the device does not subscribe to the service 1004, contact support, else verify device account payment status with an independent payment system 1005-a. If payment status is not up to date, the device is recommended to make a minimum payment amount 1005-c, else if payment status is current to date 1005-b, the device is assigned a networking port 1006 and authorization is sent to the requesting wireless node to authenticate 1007. If the device still not connected 1008, the authorization is re-submitted 1009. A count is established up to N trial times. If the number of counts reaches the maximum N, the authorization is sent to a different node or a meaningful error is provided 1010. The node is automatically pinged and a trace-route is run, and reported to tech support as dysfunctional. If the device is connected 1011, connection details are logged in the connection log including a static GIP/IP, a transient GIP/IP, date-time of connection, servers connected to, date-time of connection and date-time of disconnection. It should be understood that though the payment system is independent, payment account status is periodically replicated into the authentication system for quick access.

While the K-Net device is in motion, the LAN manager device running the iNCP 1000, calculates position of the K-Net device in motion based on nearby nodes storing a path and direction in cache memory 1011-b recording coordinates at time intervals such as one second and buffering service data for easy access when switching from one wireless broadband node to another. A wireless broadband node refers to a wireless router device and a Net Extender device that is utilized to network mobile devices on the broadband network over Wi-Fi, microwave and other broadband spectrum bands.

If connected to any service applications, the applications and application service ports are recorded. In addition, system usage is updated for routing purposes. Each LAN manager handles a specific capacity. When the capacity is reached, requests are redirected to the most appropriate LAN manager out of the four each LAN Manager connects to.

If the connected device requests for service via an application 1012, the iNCP in the LAN manager assigns an application port for both the device and LAN manager connection 1013. That port is set to a designated range of frequencies to prevent interference from other apps running on the same device. Electronic service is provided 1014. Frequency ranges and corresponding ports however, are factory configured. This is only if not implemented in factory. While service is provided, service data is temporality buffered in the LAN Manager for quick access when switching from one wireless node to another 1014-b. Instruction 1015 listens to new connection requests. If at 100 percent capacity 1015-b, redirect to another LAN manager 1015-c else, establish a new connection request 1015-d. Concurrently, data is streamed when the device is still connected 1016. Service data is transferred 1016 while the other process is checking to ensure device connectivity is continuous and in proper range 1017. If the device is getting out of range 1018, the protocol determines the next node to connect to 1019. Concurrence is executed by multiple threads, several modules or other means.

If the device happens to be in motion, the port stays constant until the device is disconnected. When the device is getting to the minimum allowable packet transfer rate or pre-determined range zone 1020 and getting out of range, the LAN manager device directs the moving K-Net device to what wireless router to connect to next when switching from one node to another 1021-1031, 1014 on the broadband wireless network operating on Wi-Fi, microwave and other broadband spectrums. The LAN manager generating a new connection code and appending the code to the device ID, the next node ID and LAN manager ID, the LAN manager submits the connection request including a connection code to the next node to connect to 1022. When the code is not received by the next node to connect to 1023, the protocol tries again until count reaches maximum allowed 1024 and switch to a different next node 1025. If the request is received by the next node to connect to, the LAN manager transmits the same connection request and connection code to the connecting device through the node currently connected to wirelessly 1026. If the connecting device receives the connection request 1027, the connecting device broadcasts the connection request 1030. The next node to connect to picks the request because it has a copy of the request received directly from the LAN manager and saved to cache memory with its ID appended to the request. All the other nodes in range ignore the switch of node request because their IDs are not appended to the request. The next node compares the connection request and code to the previously received connection request from the LAN manager and connection code, and authenticates to switch after a match 1031. When the device is connected to the next node 1032, the protocol monitors the device positions per second recording coordinates and connection details 1033. The connecting port connects at a specific range of frequencies to avoid interference from applications running on the same device and other devices. Service is continually provided and service data buffered for continuity when another node switching occurs. Not shown are steps for packet encryption, compression, decryption and verification with server.

Switching wireless nodes (node) on the network summary not necessary in that order:
1. A wireless router (node) receives a connection request from a broadband modem and forwards the request over fiber or a wire to a Local Area Network (LAN) manager
2. The device running the modem is authenticated and connects to the broadband network Wi-Fi/microwave extra and sets in motion
3. The LAN manager on the network maintains coordinates of the device and direction.
4. The device get to a point where it is about to get out of range of the wireless node
5. The LAN manager device on the network detects that the mobile device or modem is about to get out of range and sends a connection code to a wireless router to connect to next via fiber, copper or any wire used and the next node stores the request in memory because ID of the next node is appended to the request.
6. The LAN manager sends the same connection code to the mobile device that want to connect to the new wireless node to switch for signal continuity.
7. The device/modem broadcasts the connection code copy to nearby wireless routers.
8. The wireless router with the connection code provided by the LAN manager, running an iCCP retrieves the code from memory, compares, and then authenticates the device when the codes match.
9. While connected simultaneously to an old wireless node and a new wireless node, the packet control protocol embedded in a chip in the mobile device's modem transfer cashed data linking the old node and the new node and the device signal flow continues. The old node is dropped and the process is repeated whenever a switch is needed from one node to another.

FIG. 11 Represents a personal safety algorithm 1100 in the system. The K-Net device provides a safety button coupled to a camera on top of the K-Net device, a camera in the rear and a camera in the front through software. A user configures which camera to use when recording. When the safety button is pressed, and held by a user to record an event at a site, the safety button transmits instructions to the processor, wherein the processor 302 and safety chip 323 triggers a device vibration to indicate to the user that recording is initiated 1101.

While the K-Net device or phone is on, press & hold alert safety button 121 to record an event at a site where a device is located, wherein instructions 1101 triggers a device vibration to indicate to the user that recording is initiated. When the device vibrates 1102, record and transmit data to service provider and recording on device if configured 1104. A user releases button 1105, but the recording which includes video, sound, a GPS location of the event site and a trace route path indicating nearest places and landmarks continues.

If not Configured to send to law enforcement and others 1106, a prompt is provided to configure the device to send to law enforcement and any desired designations by entering identifiers of the designation devices including phone numbers, GIP or simply selecting choices of law enforcement from device menus 1107 pre-entered. If configured 1108, recordings are automatically transmitted to the service provider's server for real time retrieval by designated devices and law enforcement. The service provider's servers submit links to the designated devices and call the devices to inform of the recordings and turning on vibration mode of a recipient's devices.

A user configures the device to transmit recordings to other destination devices by providing device identifiers such as phone numbers or internal GIP and the service provider's server submit links to the designated devices and calls the devices to inform of the recordings and turning on vibration mode of a recipient's device; and, wherein the system provides for selection of a camera to record an event instead of the default top camera. Multiple cameras are configured to record simultaneously.

When configured to transmit recordings, the servers submit audio out, GPS location, race route, pictures, video to at least one law enforcement station in vicinity and other designations as configured in the system with recordings via K-Net, a, a Satellite or Other Network as configured 1109 and the servers provide law enforcement stations in the vicinity and any designations as configured in the system with recordings.

On law enforcement and designated individual's screens, the system app lights the screen, turns on alarm & displays GPS path indicating nearest places to the event site 1110. A user device records incoming data to secondary memory 1111 when configured or set to default local recording on device.

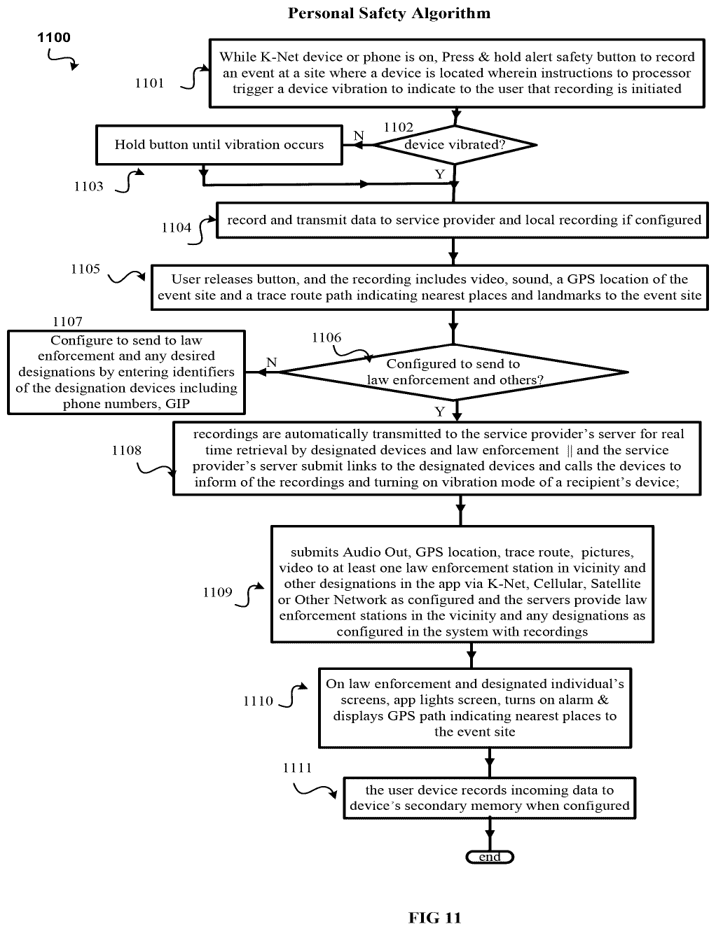

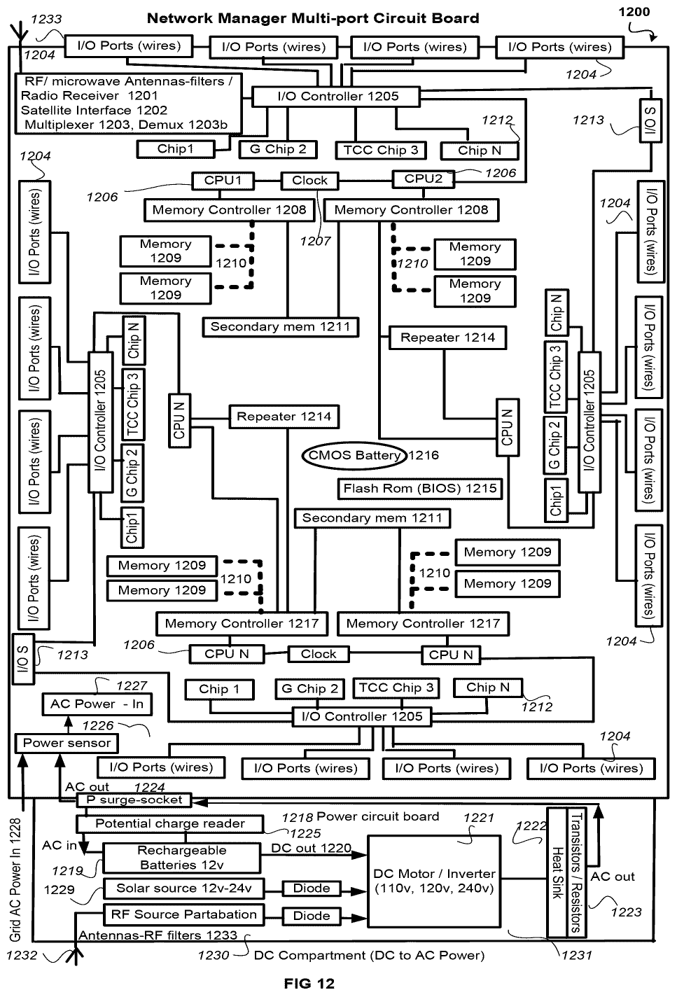

FIG. 12 is a multiport circuit board 1200 for a local area network (LAN) manager device with a television antenna interface and radio receiver 1201, satellite interface 1202, multiplexer 1203 and a Demultiplexer 1203b for distributing data to the wireless routers coupled to input output (I/O) controllers 1205 implemented with a plurality of input/output (I/O) ports 1204 to which fiber optics, copper or other types of wires from the wireless network routers plugs and connect to transmit data between the LAN manager and the plurality of wireless router devices on the network and other LAN manager devices and servers, wherein the I/O ports are connected to I/O controllers, a plurality of G chips and TCC chips and at least one processor 1206 with a clock 1207 for executing instructions to and from the wireless routers and servers connected to. The board shows four physical connection ports on each side with a total number of K-Node devices connecting (N) as 16. It should be understood that the number of connection ports on each side can be varied from 4 to 5, 6, 7, 8 etc. as needed. When a side has 8 physical ports for connecting fiber optics cable or other wires to the K-Node routers, the total number of K-Node routers N becomes 32. However, all ports can be consolidated on one side or two sides of the LAN manager device to reduce production costs.

The I/O controller connected to a plurality of G chips and TCC chips 1212 for processing data from the wireless routers and coupled to I/O ports 1213 to and from servers, wherein the processor and the I/O controller determining which chip (G chip or traffic controller chip (TCC)) is available for a connection request and data transmission to provide the electronic services. The LAN manager storing transaction logs in memory of the Local Area Network (LAN) manager including logs of wireless nodes on local area networks, geo-locations and radii under which the nodes perform well for networking in secondary memory 1211 from where the logs are cached 1209 for easy access. A repeater 1214 coupled to the processor, amplifies and retransmits signal to distant LAN managers and Servers. The DC compartment 1230 converting direct current to alternating current electrically powers the LAN manager device in which the multiport circuit board is built. The LAN manager device working in conjunction with at least one wireless router connecting to servers by wires, is built with at least one input-output port to which a fiber optic, copper or other type of wire connects to transmit data between the LAN manager and a plurality of wireless router devices. A plurality of wireless router devices on one side of the broadband K-Net wireless network operating on Wi-Fi and microwave bands, and LAN managers or servers on the other side of the network, identifies and authenticates connection and service requests from K-Net devices with a broadband modem card.

Memory controller 1208, 1217, memory 1209, secondary memory 1211 for storing permanent data including software and the transaction logs including logs of wireless nodes on local area networks, geo-locations and radii under which the nodes perform well for networking, makes up the core of the circuit board. Operational data such as protocols in secondary memory is loaded into cache during operations. Functions of the I/O controller can be inserted in a processor. The LAN manager identifies and authenticates connection requests from the wireless router devices. At least one of the processor or chip in the LAN manager instructs mobile devices in motion what wireless node to connect to next.

The multiport circuit board 1200 with at least one chip, and a memory running an embedded operating system for managing protocols and connectivity of the wireless routers, mobile devices, vehicles and Net Extender devices on the K-Net network is coupled to a DC circuit board from a direct current (DC) compartment 1231 by wires and sockets. The DC compartment comprising a case that carries 12 volts rechargeable batteries, 1219 that powers a DC motor connected to an inverter 1220 with components for converting direct current (DC) into alternating current (AC) from at least one of a rechargeable DC battery, photovoltaic cells or antennas that harness power signals from the atmosphere through electrical conductors, a perturbation component and a switch. The devices are coupled to an inverter for converting DC to AC current utilizing a transformer and an inductor as components of the inverter for increasing or decreasing output voltage in the wireless network router device, the LAN manager device, and servers connected to by the K-Net network devices. The LAN manager is coupled to at least one server by a fiber optic cable or other type of broadband cable to transmit data, wherein the wireless router provides connectivity and electronic services to the user devices over at least one of a cellular network, a wi-fi network, a millimeter wave network, a microwave network or a combination of more than one.

The motor rotates a rod attached to a cylinder surrounded by magnetic bars not shown. The cylinder and magnetic bars rotate over a transformer as part of an inverter 1221 generating a fluctuating magnetic field. The magnetic field results into an alternating electrical energy in the inverter and a current flows through wires in the inverter generating in the neighborhood of 260 volts depending on coils in the transformer. A heat sink 1222 is applied to reduce the amount of heat dissipated. To control the output voltage to 110v, 120v and 240v, different transformers are used and resistors and transistors 1223 are applied to reduce or increase the voltage. AC current flows out of the inverter into a power surge protector 1224. One outlet is plugged into the socket to pass current to the LAN manager device and another outlet passes current to a rechargeable battery charger.

A potential charge reader 1225 is connected to the batteries through the containing case 1219 to measure charge left on the batteries. When charge on the batteries drops below a set value such as 30 percent, the potential charge reader with a sensor signals for battery charging to resume and stops when it gets to 100 percent. Another socket on the power surge protector is plugged in to supply the main circuit board with AC power from the inverter. This socket plug connects to a power outage sensor 1226 and this powers the circuit board and components 1227. When the electrical energy from the DC compartment stops, a power sensor detects and automatically releases backup GRID AC power 1228 to power the circuit board and components.

Alternatively, photovoltaic cells or solar panel(s) 1229 or an RF source 1230 connected to antennas 1232, coupled to filters 1233, is made to undergo a perturbation that agitates atmospheric magnetism and generate a DC current, wherein the DC current is converted to AC current by the inverter. As a result, the wireless network router device, the network manager device and servers in a datacenter are powered by electrical energy from alternating current generated in the DC compartment within the devices or attached to the devices through electrical wires and connectors. The alternating current is generated from a direct current source of either a set of rechargeable batteries that are periodically charged based on charge level after drainage or charge reading, photovoltaic cells (solar panels), or frequency-magnetic perturbation converted to alternating current by an inverter.

The K-Net network implements a multiport circuit board for the Local Area Network (LAN) manager device and implements a four port circuit board for a wireless router device with at least one physical data port on one or more sides of the wireless router. A LAN manager device is plugged into a server via fiber optics. The wireless router is added to the K-Net network by plugging one end of a fiber optics line, a copper wire or other type of wire into a connected LAN manager's I/O port and plugging the other end of the fiber or wire to the I/O port of the wireless router. Powering on the wireless router causes the wireless router's physical I/O port to get lit invoking an initial communication module and submitting the wireless router's identifiers to the connected LAN manager. The LAN manager transmitting the identifiers of said wireless router to a server for verification and assignment of a 128 bit geographical internet address (GIP) or an internet protocol address (IP) for the wireless router to communicate with at least one LAN manager on the network. The wireless router device stores each of the LAN manager devices that the wireless router connects to via different I/O ports with their respective paths in memory for quick access when providing the electronic services to mobile devices, vehicles and Net Extender devices.

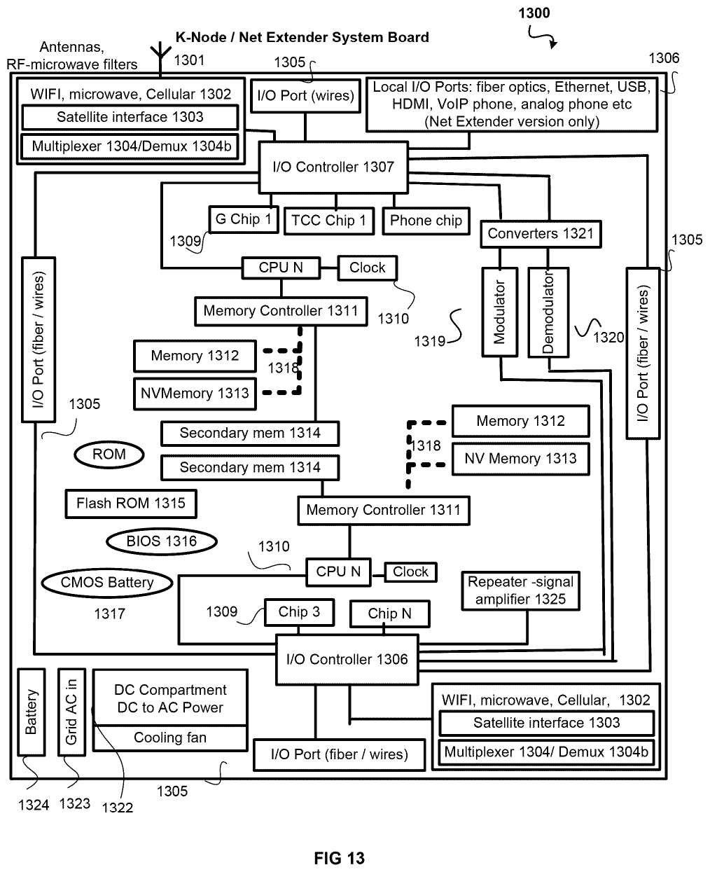

FIG. 13 is a four port circuit board 1300 for building a wireless router device, and a Net Extender device. The circuit has at least one input-output (I/O) ports to which fiber optics, copper or other type of wire from LAN manager devices plugs to connect for data transmission between the wireless router device, and Local Area Network (LAN) manager devices. Each wireless router connects up to four LAN managers 1305. Antennas 1301, Wi-Fi and microwave bands, and cellular receiver 1302, Satellite interface 1303, multiplexers 1304 and demultiplexer 1304b facilitates communication. The four port circuit board connects to at least one Local Area Network (LAN) manager via I/O ports 1305 linked by fiber optics, copper or other types of wires not shown. LAN manager devices or the wireless router devices are coupled to the satellite interface for input into the network and output to the satellite and K-Net devices. The I/O ports 1305 are coupled to an I/O controller 1307 also coupled to at least one processor 1310 for executing instructions to and from the wireless router operating on Wi-Fi and microwave bands, and at least one chip 1309 for controlling network traffic to and from the wireless router. The I/O controller is further coupled to a memory controller 1311, through the processor, memory 1312, 1313 and at least one of a G chip 1309 and a traffic controller chip 902_b simply referred to as chips or chip, for processing service requests from the K-Net device, the Net Extender device or a vehicle equipped with the broadband modem to access electronic services. This is interlinked with secondary memory 1314 for storing permanent data. The multiplexer takes different data types of electronic services destined for a single device such as television data and phone data and combine the data frames into a single output to the device. A demultiplexer at the receiving device splits the data to intended ports and applications. The K-Net device connects to the wireless router device and accesses the electronic services. The SFA displays at least one interface wherein the interface provides one or more services button links for accessing television service and radio service through antennas, and without internet access. The DNE, a television set and other K-Net devices, auto detects a node connected to and determines local television channels to display in a television guide based on area identifiers.

The wireless router device, the divided Net Extender device and the Local Area Network Manager device runs embedded operating systems that manages applications. Converters 1321 coupled to a modulator 1319 the I/O controller 1307 and processor 1310 converts the outgoing digital signal from the I/O controller 1307, processor 1310 into radio frequency signal for encoding with carrier wave and transmission to K-Net devices. A demodulator in the wireless router 1320 coupled to the I/O controller and processor, recovers the signal transmitted by wireless devices via antennas filtering out carrier waves, and the converter 1321, converting the signal to digital for processing within the wireless router. The digital signal is then converted to electrical pulses and transmitted to the LAN manager device and server via fiber, copper or other wire. A repeater 1325 amplifies the signal. The DC power compartment 1322 provides DC/AC power input generated from within the device for powering the device. An electrical GRID provides AC power into the device via an input 1323. The net extender device is powered by DC current from the battery 1324, when AC is unavailable. Television and radio is received through antenna without internet.

A divided Net Extender comprises of physical I/O ports such as Ethernet, USB, HDMI, analog phone port and more 1306 to which a user plugs devices. Voice over Internet Protocol (VoGIP/IP) plugs into a digital port, Ethernet or USB while an analog port provides for a phone plug on the Net Extender 1306. A repeater 1325 coupled to the I/O controller and processor, amplifies the signal. I/O ports are placed on each side of the board for easy access, but all ports may be consolidated on one or two sides to reduce cost. It should be understood that the wireless router device takes more ports when needed.

The wireless router device built on the four port circuit board and running an improved Card Control Protocol (iCCP) in memory, connects to at least one LAN manager running an improved Network Control Protocol (iNCP). The iNCP determines a next wireless node for a mobile device or autonomous vehicle in motion to connect to on the K-Net network over Wi-Fi, microwave, or other broadband spectrum bands. The wireless router device is coupled to at least one fiber optic cable or other broadband cable for transmitting signal to and from at least one LAN manager device or a server.

The local area network (LAN) manager device 805 interacting with at least one server 806, manages connectivity of mobile devices 803, Net Extender devices 802 and autonomous vehicles 803 through the plurality of wireless router devices 1300, 804 to which the LAN manager is connected by fiber optics, copper, Ethernet or other type of wires 807. The LAN manager device runs an improved network control protocol embedded in the traffic controller chip (TCC) and the G chip 1309 to control traffic and manage wireless router devices providing electronic services including radio, autonomous vehicle connectivity, television, phone and video conference, at specific frequency ranges for each service type. The TCC or G chip in the LAN manager device or in the wireless router device coupled to radio frequency (RF) and microwave filters and antennas, manages switching of autonomous vehicles and other mobile devices with a broadband modem from at least one wireless router device to another over a Wi-Fi and or microwave bands network. The broadband modem runs a packet control protocol embedded in a packet controller chip. To minimize costs, the plurality of data ports on LAN manager and wireless router devices, are consolidated on one or two sides of the device. A static IP address may be utilized instead of a static GIP.

A plurality of wireless router devices 804 with antennas coupled to filters 1301 and at least one of the traffic controller chip or G chip running an improved card control protocol to provide electronic services to a connecting device including mobile devices, Net Extender devices and autonomous vehicle (AV) s at specific frequency ranges for each type of electronic service. The default GIP is factory saved to a permanent location and to an operational location in a K-Net device memory. A connection module only reads the default GIP from the operational location memory from where it can be changed by reset.

A reset button link resetting a service provider's GIP or IP to a factory default GIP/IP, accomplishes it by erasing the ISP GIP/IP from the operational location memory and copying the default GIP from a permanent location to the operational location preparing the device for service with any ISP. When a device is discontinued from an ISP service, a reset button link is provided for a user to reset and connect to a new provider with instructions on boot. A list of internet service providers (ISPs)/telecom is auto populated when a device connects and the list is provided for a user to select from 901-f when switching from one ISP to another. A connecting device connecting for a first time or restoring a disconnected service account, utilize the default GIP or the default IP to connect submitting a device MAC address or other device ID and a model number from the device memory. The connecting device is assigned a payment application port and a payment interface to make a payment and subscribe to an ISP or restore a disconnected service account without the ISP's involvement. The reset button link erases a previous service provider from the operational memory of a device to switch to another ISP or telecom provider. To start with a new ISP, a user device submits a default static GIP or default static IP, a device ID such as a MAC address, and a model number to the payment system and a list of providers is displayed to choose from. The user selects an ISP from the list, makes a payment and get a customer account number, an ISP payment code and a payment confirmation code as parameters to subscribe the device. Those are saved to both the device memory and the ISP subscription server for verification and connecting to the ISP. The parameters are submitted each time the device reconnects.

The filters coupled to the antennas of the wireless router device 1301, are connected to at least one G chip 1307, 1309 or traffic controller chip, on the four port circuit board and the filters coupled to the antennas of the LAN manager device 1233, are connected to at least one chip on the multiport circuit board via the I/O controller 1205, wherein the at least one chip 1212, processes wireless signal from mobile devices, Net Extender devices, autonomous vehicles, satellite, over the air television signal, radio signal, and signal from fiber optics or wire plugged into I/O ports of the wireless router device 1305 to deliver the electronic services over Wi-Fi or microwave bands. The electronic services, including radio, autonomous vehicle connectivity, television, phone, and video conference are delivered wirelessly to mobile devices, Net Extender devices and autonomous vehicles through the wireless router device by authentication. Though the chips can be dedicated, they are not dedicated in the preferred implementation. A processor and an I/O controller assigns an available chip to incoming requests and the number of chips are varied for feasibility. The chips are utilized to control network traffic to and from the wireless router. A repeater coupled to the processor amplifies the signal.

A traffic controller chip (TCC) coupled to a plurality of filters and antennas 1201 for filtering broadband signal on the K-Net network, is embedded with the improved Network Control Protocol (iNCP) and resides in the Local Area Network (LAN) manager device or server to manage connectivity of autonomous vehicle. When embedded with the improved Card Control Protocol (ICCP), the TCC resides in the wireless router device to process signal over Wi-Fi bands, microwave bands and other broadband spectrums to manage connectivity of autonomous vehicles (AV) with a broadband modem in motion switching from one wireless node to another. The modem in the vehicles run a packet control protocol embedded in the network packet controller chip. AVs primarily utilize TCCs for connectivity and G chips for electronic services. The TCC is specifically utilized for managing connectivity of autonomous vehicles but it can be configured to provide electronic services to autonomous vehicles (AVs) as well. Similarly, G chips connect AVs.

The divided Net Extender device 802 with at least one converter 1321 converting digital signal from a processor 1310 (CPU-N) coupled to a phone chip 1309 in the Net Extender device into analog signal and another converter, converting analog signal from a phone device or from antennas 1301 into digital for processing in the divided Net Extender (DNE). The DNE provides phone service on a digital or an analog phone device (not shown) plugged into the divided Net Extender device port or plugged into a splitter that allows multiple phone devices to be connected. The phone chip with embedded code storing a plurality of phone numbers and related information in memory, facilitates phone service to multiple office or home phone devices in a building each through a dedicated channel, a dedicated frequency range and a dedicated port. Physical phone devices in a building connecting to the plurality of phone numbers for making calls through multiple voice over GIP or IP (VoGIP) or (VOIP) ports or through multiple analog and digital ports built into the Net Extender. A splitter creates more phone ports for plugging in physical phones.

Adding at least one phone number to forward to, forwards a call to the phone number and when not picked up at the forwarded number, a message is saved to the Net Extender memory, wherein pressing an asterisk key or other key on a phone device keypad and selecting a voice box number or name assigned to a Net Extender channel, retrieves messages from the voicemail of the phone number associated with the channel. To add phone numbers to channels, an admin user connects the Net Extender device to a computer or mobile phone via a USB or other port and gets authenticated. The device gives an option for adding or changing phone numbers. The K-Net device and the K-Net communication network implements a security mechanism that involves creating a user account and registering a user with at least one electronic communication method that includes email, and phone number and registering devices of the user that connects to the wireless router device to execute the security mechanism over one of Wi-Fi, cellular, microwave and millimeter wave spectrums. A Geo IP or an IP address is established for each of the user devices. The security mechanism provides at least one button link for viewing devices on the account and another button link for inventory of installed software applications. The email verifies the user account when a phone call is placed for restoration. A tiny code further identifies a device on a server.

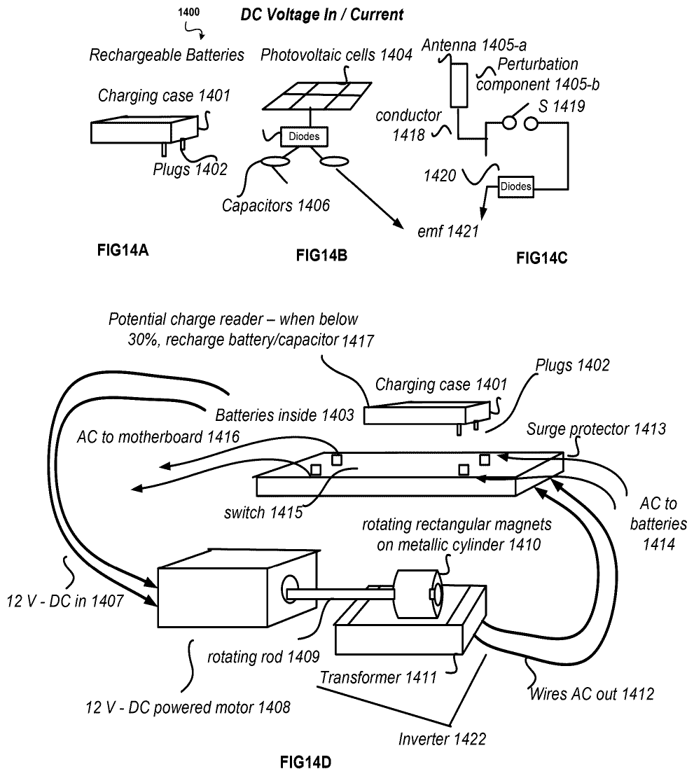

FIG. 14 represents a power mechanism for generating electrical energy for powering the wireless network router device, the Local Area Network manager device and servers. The wireless router device, the LAN manager device, and the server devices connected to on the K-Net network, are powered by alternating current (AC) electrical energy generated in a DC compartment inside each of the devices or attached to the devices through electrical wires and connectors. At least one rechargeable DC batteries 1403 in a charging case 1401 utilized as a source of direct current energy is coupled to a sensor (built into the charging case) for determining charge level on the battery while providing a direct current (DC). A second source of DC is a set of photovoltaic cells 1404 absorbing electromagnetic waves (EM) from the sun and providing a DC current. A third source of DC is a set of antennas 1405-a coupled to a frequency perturbation component 1405-b a conductor 1418, a switch 1419 and diodes 1420 harnessing a DC current from a perturbed atmosphere. Each of the three sources of direct current (DC) is coupled to an inverter that converts DC to AC current utilized independently. The inverter in the DC compartment 1422, converting the direct current into an alternating current for utilization in the device with the DC compartment, wherein the transistors (not shown) amplifying the electrical signals to a high output voltage while the resistors (not shown) limiting the voltage and controlling the max voltaic output for each device.

A transformer and an inductor as components of the inverter increase or decrease output voltage in the wireless router device, the LAN manager device, and servers connected to by the K-Net network to measurements such as 120 volts, 220 volts and 240 volts. It should be understood that a third party inverter can be utilized to convert DC current from any one of the three sources into alternating current.

The direct current from the batteries 1407 flows into a DC motor 1408 that rotates a rode 1409, wherein the rotating rod rotates a cylinder with attached magnets 1410 resulting into a changing magnetic field that generates an alternating electric current from a direct current source. The rotating rode 1409, rotating rectangular or cylindrical magnets on a metallic cylinder 1410, transformer 1411 and ac wires 1412 are some of the components of the inverter. The inverter passes AC current pulses to the transformer which induces a varying magnetic field in the primary coil. A secondary coil of the transformer takes the varying magnetic field and induces an ac current out 1412. The current flows through a transformer 1411 that generates a voltage up to 260 volts. Alternatively, Transistors not shown, amplify the electrical signals to a high output and Resistors not shown, controls the max voltaic output for each device according to R (resistance)=V (voltage)/I (current). Wires currying the ac current 1412, powers a surge protector 1413. The charging case with batteries is permanently plugged into the surge protector to recharge the batteries each time the batteries are discharged.

A on-off switch 1415 turns the electrical circuit on or off. A second socket 1416 carries ac current to the main circuit board. A built in charge reader, not shown 1417, determines the amount of charge left on the batteries and activates the charge until it is 100 percent or near full again.

Dictionary: Some of these words are used interchangeably. K-Node=K-Node wireless router=wireless router device=wireless router=node. Local Area Network manager=LAN manager. A MWBNIC is also known as modem card or simply modem. K-Net devices are a class of electronic devices that include mobile phone, tablet, laptop, a K-Net recorder and television. A GIP reader is software that reads a GIP to authenticate a device.

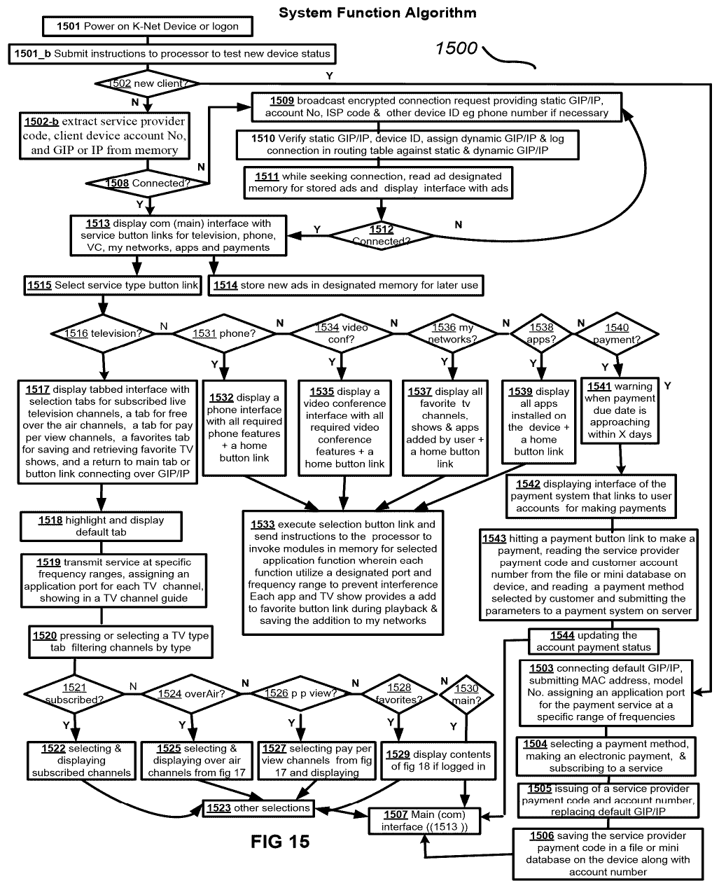

FIG. 15 Is a system function algorithm that creates device accounts without ISP action and manages connectivity of devices to the network. A plurality of GIP/IP allocation servers for allocating GIP or IP addresses, internal and external domain name servers (IDNS/EDNS) for translating GIPs and controlling devices on the network and authentication servers executing the GIP reader for verifying and authenticating the devices on the network. Upon powering on a K-Net device with the system function algorithm (SFA) in memory 1501, the device transmits instructions to the processor of the device to test for a new client device status 1501_b. To connect a new device to a service without a service provider's action, the SFA extracts from the device memory and submits a device MAC address or other device ID and a model number when the client device status is not in a payment system. A new client device 1502, invoking a module and retrieving the default GIP or default IP from memory of the device along with a MAC address or other device ID and a model number 1503, and submitting the trio to the authentication server to register the device, establishing an account. The system and method connecting the new client device utilize the default GIP or default IP. The SFA assigning the device a payment application port at a specific frequency range 1503 and providing an interface for subscribing to the electronic services displays a list of internet service providers (ISP) or telecom providers to choose from, wherein choosing an ISP displays a payment button link showing available services and prices. Opening the payment button link and selecting a payment method, and making an electronic payment via payment methods including a debit or credit card, a prepaid card, a bank electronic check and a digital or crypto currency, subscribes the device to a service 1504, wherein the SFA invokes a module for receiving a service provider payment code, a client device account number, and the ISP provide a static GIP or IP address based on a geographical location, ISP company and other identifiers replacing the default GIP in the operational memory with a static GIP or static IP specific to the selected ISP. This updates the client device payment status 1505 upon paying. The SFA saving the service provider payment code, client device account number and static GIP to a file or mini database in memory for future payments and connection requests 1506 and provided whenever making a payment. The SFA then authenticates the device to the com interface over a GIP or IP 1507, 1513 without a service provider's action. A device can pay for one to 12 months. The service provider code and account number are saved to memory of the K-Net device 1506 for retrieval when making future payments.

One client account number is linked to multiple devices on a payment server via the payment interface. Once a device submits a default GIP and makes a payment, the device identity on the payment server is attached to the user account and ISP payment code for future payments. The client can pay for each device individually or pay for all the devices they have for 1 or more months.

When executed, each button link 103-112, 130 transmits instructions to the processor invoking modules to provide a corresponding electronic service from a server. Connecting with an account.

A K-Net device assigned a static GIP or a static IP address after a payment is made and an account is established, executes the system function algorithm to connect, extracting (1) a service provider payment code, (2) a client device account number and (3) a static GIP or static IP from memory of the device 1502_b and tests for connectivity 1508, to establish a connection. The system function algorithm (SFA) transmits instructions to the device processor to submit an encrypted or unencrypted connection request submitting the service provider payment code, the client device account number and the static GIP or static IP to the authentication server as parameters to establish a connection 1510-1512. If not connected, broadcast a connection request 1509, While seeking connection, read ad or message designated memory for stored ads and display an interface with ads.

As the device tests for connectivity, 1509-1512, the authentication server and the internal domain name server (IDNS) are interacting with a payment server and identifying the service provider payment code, the client device account number and the static GIP or IP of the device after which redirects the connection to the GIP allocation server assigning a transient or dynamic GIP or IP to the device when none is assigned. When the parameters are identified, the device is authenticated and the algorithm displays the com or main interface showing service button links including the television service, the phone service, the video conference service, the my networks service, the apps service and the payment service 1513. The authentication server records or logs the connection to a connection log 1900. Opening any of the service button links on the com interface, selects a service type 1515, submitting instructions to the device processor and invoking the algorithm to display a corresponding interface for the selected service type 1516-1533. When no service, the device displays compute screen.

Selection of a television service type 1516 transmits instructions to the device processor causing the system function algorithm to display the television (TV) tabbed interface 1517 (1600) with selection tabs as button links for subscribed live television channels 1601, a tab for free over the air channels 1602, a tab for pay per view channels 1603, a favorites tab for saving and retrieving favorite TV shows and apps 1604, a filter by region or country tab 1606 and a return to main tab or button link 1605 connected over a GIP or IP. Upon displaying the TV tabbed interface, a configured default tab 1518 is highlighted utilizing cascade style sheets or other technologies. The system transmits service signals at specific frequency ranges, assigning frequency, application port for each TV channel and external channel identifiers to specific channels 1519, wherein the channels and channel identifiers are displayed in the television channel guide with corresponding scheduled playback time slots under respective tabs 1608. Alternatively, tabs are showed as button links laid horizontally or vertically. Pressing or selecting a TV type tab 1520 filters channels by type such as subscribed TV 1521 displaying subscribed channels 1522, over the air 1524 displaying over the air channels 1525, pay per view 1526 displaying pay per view channels 1527, favorites 1528 displaying favorite channels FIG. 18 and apps 1529 and main 1530 displaying the com interface.

If service type is a phone 1531, the system displaying a phone interface with all required phone features 1532 and a home button link to return to the com interface. If selection is a video conference 1534, the system displaying a video conference interface with all required video conference features 1535. If selection is for a my networks button link 1536, the system displaying all favorite social networks channels and shows 1537. If the selection is for a apps service 1538, the system displaying all apps installed on the device each represented by an icon that when opened, transmits instructions to the processor to launch the application 1539. A return to main button link is on all interfaces. The divided Net Extender device, the television set and other K-Net devices executes instructions to select a radius for covering local television channels harvested by the wireless router or LAN manager device into the network. Configuring the radius provides for entry of multiple area identifiers which provides more local channels from a larger area, and the channels are sorted by at least one area identifier.

The system function algorithm “SFA” executed on boot, transmits instructions to the K-Net device processor invoking the packet control protocol and modules to check for a client device status and connecting by manor of the default GIP, default IP, an assigned GIP or assigned IP 1502. The SFA on the K-Net device facilitates provision of the electronic services providing a plurality of interfaces and button links corresponding to the different services. The algorithm checks for an existing client device payment status from the payment server 1540. When the client device status is found in the system 1502-b, the algorithm reads payment records providing warnings to the device when an electronic payment is almost due, 1541 showing the number of days left and providing a payment service button link for making a payment and another button link for canceling to return to the main or com interface. The button link for making a payment 130, submits instructions to the device processor invoking a payment module that extracts the service provider payment code and the client account number saved in a file or mini database in memory 1542 of the K-Net device and transmitting them as input parameters in addition to a GIP or IP. The payment module displays an interface of the payment system that links to user accounts for making payments via a payment method of choice 1543. The interface of the payment system is a tabbed interface with a tab for a credit card payment, a tab for a bank electronic check payment, a tab for a prepaid card payment and a tab for a digital or crypto currency payment method. Alternatively, the interface of the payment system provides payment methods by dropdown menus, check boxes or radio buttons and links saving the payment directly to the server, updating the client device account status 1544, and returning to the main or com interface for services 1507. Attempts to launch a disconnected service displays a payment link to a server to make a payment via an interface with all the payment methods.

The system function algorithm 1500 in the K-Net device displays a com or main interface 100 on boot or at login showing button links for electronic services provided, wherein the electronic service button link that initiate the television service 1516 (103), further invokes the system function algorithm specific to television submitting instructions to the device processor, and causing the processor to display a tabbed interface 1600. The tabbed interface displays a subscribed television tab 1601, an over the air television tab 1602, a pay per view channels tab 1603, a favorites tab for saving and retrieving favorite television shows 1604, a main interface tab or button link 1605 for returning to the main interface, and a filter by region button link 1606.

The tabs and button links on the tabbed interface, transmits instructions to the processor, causing the processor to filter and load specific channels corresponding to television type or category selected by extracting the service channels from memory of at least one server, filtering by frequency range and channel type and assigning an application port for providing the selected service type and television channel. Over the air channels may be viewed directly from the network without server. A channel log is generated providing a channel number 1701, a channel name 1702, a channel type 1703, a frequency range under which the channel is provided 1704, region which includes a country 1705, a city where the service is broadcasted from 1706, and date and time when the channel is added 1707. Pressing the filter by region button link on the interface 1606 causes the processor to transmit instructions to further filter and displays the channels by region and city besides channel type. The system provides for setting of a default television tab and default region on the tabbed interface via a settings interface providing a television (TV) channel guide for each tab.

It should be understood that a GIP type token of 0 or 1 can be assigned to the dynamic GIP, and that a dynamic GIP can be saved to the K-Net devices as a secondary GIP when necessary. A static IP address may also be utilized instead of a static GIP in this system and method.

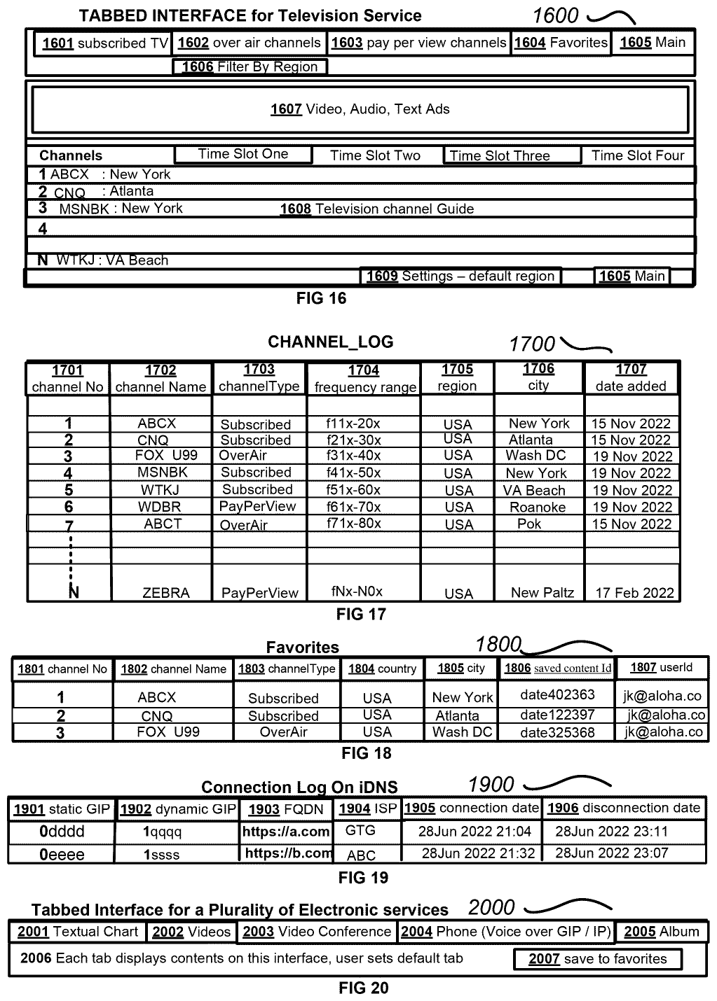

FIG. 16 represents a tabbed interface displayed when a television button link is selected from a main (com interface) in the method of providing electronic services. The button link for the television service 1516 submits instructions to the device processor causing the system function algorithm to display the television tabbed interface 1517 and tabs as button links. A tab for providing subscribed television channels 1601 paid for by subscription, an over the air tab 1602 for providing free channels harvested in the air and a tab for pay per view channels 1603 for providing rental channels that are viewed one day or for a period of time for each channel. A tab for favorite channels 1604 for saving and retrieving channels or television shows and apps that a user saves to favorites. Only a pointer is saved. Several users save the same channel as a pointer without taking memory space. A filter by region-country tab 1606 and a main tab 1605 for returning to the main or com interface of FIG. 1. Not shown, is a settings tab for setting how the interfaces appear, setting language, setting parental controls, setting a default television tab, setting a default language on a K-Net device and Net Extender device, and setting other controls. Users also set default channels instead of a TV guide for each tab individually and turns closed caption on or off. It should be understood that service tabs can be presented on an interface as button links. The algorithm highlights and displays a configured default tab 1518, transmits service signals at specific frequency ranges, assigning frequency, application ports and external channel identifiers to specific channels 1519. The channels and channel identifiers are displayed in the television channel guide with corresponding scheduled playback time slots under the respective tabs 1608.

Television channels are selected and filtered based on region, and or country where service is provided, and streamed at specific frequency ranges that are assigned an application port, a channel number, a channel name such as ABC14 and displayed in a channel guide for the selected region or country within a tab of the tabbed interface 1601-1604, 1606, 1608. Channels default to country where the device is located. However, a user selects a country from where service is to be obtained and selects a default country in the settings, regardless of where the user is located.

When configured in settings to display, a recording button link is provided on the screen during playback and a hide recording button is also provided to hide the recording button. Accessing recordings require a customer account number, and username and password. A user can access the recordings from any device anywhere. Pay per view provides a payment button link for making payments.

The television tabs are followed by a window designated for ads in form of video, audio or text 1607. Ads are placed by third parties and saved to server. The ads may be played by geographical region, by GIP/IP address, by device id or played based on a program viewed.

All television channels come through at specific ranges of frequencies with markers that identifies the channel and channel type. That is whether the channel is subscribed (SB), over the air (OA) or pay per view (PV). The channels are then sorted and displayed in the respective tabs based on channel type, that is, SB, OA or PV, Provider Company and country.

Each channel is assigned to a permanent identifying number that users can memorize and associated with the channel provider name such as ABX. Each channel is assigned a frequency range corresponding to an application port.

The system service applications including television, phone, video conference, and audio conference are installed on the K-Net devices and on the Net Extender. All secondary interfaces provide a return to main (com interface) button link.

FIG. 17 represents log of television channels read by software to display in FIG. 16. For example: A channel number 1701, channel name 1702, and city 1706 will map to channel no 1, ABCX New York city in the television channel guide of FIG. 16.

FIG. 18 represents log of favorites channels and shows saved and retrieved by users. For television, 1801 is channel number, 1802 is channel name, 1803 is channel type whether subscribed, over air, pay per view etc. Country of service is 1804, city is 1805, saved content Id which helps in identifying and retrieving the content is not shown. An updatable user id 1806, is a phone number or email and password. Concatenation of a saved content Id and user Id makes a save parameter. The Apps button link and the my network button link on the com interface includes, sharing textual content and links service, videos service, video conferencing service, phone service and photo album services from server.

FIG. 19 is intertwined with FIG. 2. A service or resource server is a server that provides resources such as web pages, files, databases, etc. Users utilize a fully qualified domain name (FQDN), 1903 or simply a universal resource locator (url) such as https://www.mydata.com to get to a server. The url is then translated to a static external GIP which gets mapped to an internal static GIP 1901 to access the resources. A static external GIP for a server on an External Domain Name Server is not shown. It is represented by a dynamic or transient GIP 1902. The ISP connected to 1904, connection date and time 1905 and disconnection date and time 1906 are recorded.

When a user signs up for a resource on a server, the user provides a dedicated device static GIP or static IP, email, phone number and password. The resource provider GIP reader expects a dedicated device to connect only from the ISP unless the user changes ISP and GIP to reflect a new temporally or permanent location. The GIP reader verifies: a transient GIP, static GIP, ISP, connection time, user ID and Password, and an authentication code is provided at login. Verification by the ISP system is returned to a resource provider for authentication.

FIG. 20 represents a system and method for producing K-Net devices and improving a K-Net communication network on which the devices run to securely provide different types of electronic services over tabbed interfaces. From FIG. 1 com interface, the at least one of my networks service button link 108 and the apps service button link 109 provide a plurality of electronic services from a tabbed interface 2000 or button links in a browser or from an application installed on the K-Net device and the Net Extender device collectively referred to as the device. A user sets a default tab to display when the tabbed interface is launched through an icon. The device connecting to a network over a GIP, IPv4, IPv6 or any other connectivity protocol and exchanging data with at least one server and, filter each type of the electronic services into an individual tab at specific frequency ranges and assigns at least one application port for each of the tabs for launching the electronic service, wherein the types of electronic services include sharing textual content, images and links service 2001, videos service 2002, video conferencing service 2003, phone service 2004 and photo album service 2005 executing individually on a server. A save to favorites button link 2006 invokes a save module generating a saved content Id for identifying a selected electronic service content to be saved, wherein the save module concatenating a current date and the saved content Id into a save parameter and submitting the save parameter along with a user account Id to a database or file links the saved content Id to the user account Id. Saving the selected electronic service content during playback or at any time to favorites on a server under the saved content Id and the user account Id, makes the favorites accessible by authenticating of the user account Id from any connected device. The user account is an email or phone number with a password for logging in. Users are authenticated from a data source different from the favorites, but retrieval is mapped on a user id in both locations. Device identification occurs and a connection code is utilized as additional verification of a user.

1. A system for producing K-Net devices and improving a K-Net communication network on which the devices run to securely provide electronic services, the system comprising at least one of:
at least one processor and a memory coupled to said processor for executing instructions in a K-Net device running a system function algorithm for managing and controlling how the K-Net device operates to provide electronic services,
a wireless router device running an improved card control protocol (iCCP) for identifying and authenticating K-Net devices,
a Local Area Network (LAN) manager device running an improved network control protocol (iNCP) and a plurality of servers, wherein the iCCP working symbiotically with the LAN manager devices and servers, manage connectivity on the K-Net network and generates a connection code utilized to identify a K-net device switching from one node to another;
a storage media storing an operating system for managing applications in the K-Net device, LAN manager device, wireless router device and Net Extender device, is coupled to said processor and memory;
at least one chip embedded with a tiny code for verifying a device seeking access to a node, the tiny code is saved to the device by the network on which the devices run;
a broadband modem based on at least one antenna and, a network packet controller chip coupled to a filter and a memory for networking data packets from at least one wireless node while maintaining packet order, and continuity for K-Net devices in motion and transmitting data on at least one of a Wi-Fi, a cellular, a millimeter wave, a microwave, a Bluetooth, and other narrowband and broadband spectrums that provide connectivity and networking, wherein the modem processes one of a geographical internet protocol (GIP or Geo IP) utilized as an internet address (IP) in K-Net devices and a static IP address, wherein the GIP provides a transient or dynamic GIP address or dynamic IP address, and a static GIP address or static IP address for securing devices on a K-Net communication network;
a radio frequency antenna coupled to a power source, at least one filter, memory and a component for determining the strongest signal on nodes in the modem, wherein the modem provide internet service to stationary devices and devices in motion over the broadband and the narrowband spectrums;
a storage medium in the modem embedded with a plurality of modules for managing connectivity and networking over the Wi-Fi, the cellular, the millimeter wave, the microwave, the Bluetooth and the other wireless spectrums that provide connectivity and networking;
a gChip embedded with algorithms, software and other technologies for controlling connectivity and data, memorizes devices that connects to the network;
an improved K-Net network connecting servers to a plurality of local area network (LAN) manager devices with antennas and filters coupled to the G chip (gChip) for controlling connectivity of devices and managing a safety feature on the K-Net device, wherein the LAN manager devices plugging into and connecting to a plurality of wireless router devices with antennas and filters via ports, interface with vehicles, mobile devices and Net Extender devices to provide the electronic services, wherein the wireless router device, the LAN manager device, and the servers connected to the K-Net network, are each coupled to a DC compartment that converts direct current to alternating current;
an interface that provides at least one button link for making an electronic payment from the K-Net device;
a phone chip in a divided Net Extender device for managing at least one phone device connected to the divided Net Extender device;
a traffic controller chip (TCC) coupled to the processor and memory through an I/O controller in the LAN manager device and the wireless router device for managing connectivity of vehicles on the K-Net network;
a K-Net recorder device for recording and transmitting events to at least one server;
at least one Geo Internet protocol for securing networks and devices, wherein the Geo Internet protocol constitutes tokens or turples that identify at least one of devices, facilities, networks, service providers, locations and sublocations;
a plurality of GIP allocation servers for allocating GIP addresses, domain name servers (DNS′) for translating and controlling devices on the network and authentication servers executing a GIP reader for identifying and verifying devices from connection requests based on the GIP addresses, and authenticating the devices on the network based on the GIP protocol, wherein the GIP is sub divided into tokens for identifying parts that the GIP is made of and, wherein the GIP is automatically assigned to devices by GIP allocation servers;
a divided Net Extender “DNE” device that resides in buildings to provide network extension to the buildings is embedded with at least one of a gChip, a plurality of algorithms, software and other technologies, wherein the divided Net Extender provides at least one of a private chamber utilized only by specific user devices in a building and a public chamber to which any mobile device connects to maintain network connectivity on the K-Net network, wherein at least one of the divided Net Extender, a television set and other K-Net devices auto detects a node connected to and determines local television channels to display in a television guide based on the area identifiers;
a plurality of servers each executing at least one gChip embedded with at least one algorithm for managing connectivity of devices and vehicles, wherein the gChip coupled to a memory, executing algorithms, software instructions, and other technologies, provide electronic services and manage connectivity of the devices over at least one of the Wi-Fi, the cellular, the millimeter wave, the microwave and other wireless networks that provide connectivity and networking;
a multiport circuit board with at least one processor and an input-output (I/O) controller coupled to a plurality of G chips and TCC chips, wherein the processor, in conjunction with the I/O controller determining which chip is available for a connection request, data transmission and storing of transaction logs in memory of a Local Area Network (LAN) manager device in which the multiport circuit board is built, wherein the LAN manager device connecting to servers by wires, is built with at least one input-output port to which a fiber optic, copper or other type of wire connects to transmit data between the LAN manager and a plurality of wireless router devices that provide the electronic services to mobile devices, vehicles and divided Net Extender devices,
the system further comprising:
a circuit board for a wireless router device, and for the DNE device with at least one input-output (I/O) port(s) to which fiber optics or other wires from LAN manager devices plugs to connect, is coupled to a satellite interface, wherein the I/O ports are connected to an I/O controller coupled to at least one G chip and the processor for executing instructions to and from the wireless routers operating on the Wi-Fi, the cellular, the millimeter wave, the Bluetooth and the microwave bands to control network and satellite traffic, wherein a repeater coupled to the I/O controller and processor, amplifies signal;
a Direct Current (DC) compartment for generating alternating current (AC) from a direct current source with at least one of a rechargeable DC battery, at least one photovoltaic cell or antennas for harnessing power signals from the atmosphere through electrical conductors and a switch, wherein the devices are coupled to an inverter for converting DC to AC current utilizing a transformer and an inductor as components of the inverter for increasing or decreasing output voltage in the wireless network router device, the LAN manager device, and servers connected to by the K-Net network devices.

2. The system of claim 1, wherein the G chip of the wireless router embedded with the iCCP, manages K-Net (mobile) devices, Net Extender devices and vehicles connecting for electronic services on the K-Net network via the broadband modem, wherein the K-Net device and vehicle (the device) running an improved packet control protocol (iPCP) embedded in a network packet controller chip of the broadband modem for networking and transmitting data, simultaneously connects to more than one wireless node(s) on the K-Net network to switch from one node to another node operating on Wi-Fi bands, microwave bands or other broadband spectrums, wherein the device working symbiotically with the LAN manager device and servers, accesses the electronic services at a designated range of frequencies and a port for each type of electronic service; and
the iCCP on the wireless router, and the system function algorithm (SFA) on the device, verifies the device and displays a com or main interface showing the types of electronic services including: a television service button link, a phone service button link, a text message button link, a video conference service button link, a movies service button link, a my networks service button link, an apps service button link, a compute button link for returning to an operating system (OS) interface with a browser, a remote camera access service button link for configuring a K-Net recorder device and retrieving recordings, a navigation service button link, a radio service button link and a payment service button link, wherein the button links on the com interface submits instructions to the processor, and causes the processor to invoke a main interface for the type of electronic service choice requested by the button link opened.

3. The system of claim 2, wherein the SFA executed on boot, transmits instructions to the K-Net device processor invoking the packet control protocol and modules to check for a client device status while connecting by a default GIP or a default IP, or an assigned GIP or an assigned IP, wherein the SFA checks for an existing client device payment status from the payment server, and provide warnings to the device when an electronic payment is almost due showing a number of days left and providing a payment service button link for making a payment;
a button link for canceling to return to the main or com interface is provided, wherein the button link for making a payment, submits instructions to the device processor invoking a payment module that extracts and take as parameters a service provider payment code and a client account number saved in a file or mini database in memory of the K-Net device and transmits the parameters to the payment server, wherein the payment module, displays an interface of the payment system that links to user accounts for making payments via a payment method of choice; and
the interface of the payment system, is a tabbed interface that provide at least one of a tab for a credit card payment, a tab for a bank electronic check payment, a tab for a prepaid card payment and a tab for a digital or crypto currency payment method for making payments, and, wherein the interface of the payment system alternatively provide payment methods by dropdown menus, check boxes, radio buttons and links saving the payment directly to the server, updating the client device account status, and returning to the main or com interface.

4. The system of claim 2, wherein the K-Net device running the SFA, displays a com or main interface on boot or at login showing button links for the electronic services provided, wherein the electronic service button link that initiates the television service, further invokes the system function algorithm specific to television submitting instructions to the device processor, and causing the processor to display a tabbed interface, wherein the tabbed interface displays a subscribed television tab, an over the air television tab, a pay per view channels tab, a favorites tab for saving and retrieving favorite television shows, a main interface tab or button link for returning to the main interface, and a filter by region button link for filtering channels by region;
tabs and button links on the tabbed interface, submits instructions to the processor causing the processor to filter and load specific channels corresponding to television type or category selected by extracting the service channels from memory of at least one server, filtering by frequency range and channel type and assigning an application port for providing the selected service type and television channel; and
a channel log is generated providing a channel number, a channel name, a channel type, a frequency range under which the channel is provided, region which includes a country, a city where the service is broadcasted from, and date and time when the channel is added, wherein pressing the filter by region button link on the interface causes the processor to transmit instructions to filter and display the channels by region and city besides channel type, and, wherein the system provides for setting of a default television tab and default region on the tabbed interface via a settings interface providing a TV channel guide for each tab.

5. The system of claim 2, wherein the K-Net device is registered with an internet service provider (ISP) and identified by authentication servers from the static GIP when requesting for network connectivity and electronic resources, wherein the K-Net device is assigned a transient or dynamic GIP during authentication and the ISP records a successful connection to a connection log on a server logging the static GIP or static IP, the transient GIP or the transient IP, a fully qualified domain name, an ISP ID, a connection date-time, and a disconnection date-time in the connection log; and
the transient or dynamic GIP, is also saved to memory of external domain name servers, preventing access to the internal static GIP and protecting the device, in addition to a connection code and a user authentication utilized, wherein the GIP reader on an authentication server or other server, prioritizes a connection request based on a type of device seeking for the connection, and, wherein the K-Net device is configured to auto save contacts to a server, and synch the contacts on multiple devices.

6. The system of claim 5, wherein the server running the GIP reader is configured to identify a connecting device that accesses electronic resources based on a static GIP and a user authentication, wherein a K-Net device connected to a network and seeking access to resources, submits a transient GIP or transient IP assigned to the device, a connection time (CT) at which the device connected to the ISP network, and an ISP token as parameters to a resource provider server to access the resources;
the ISP GIP reader on the authentication server or other server, receives a device verification request from the resource provider server based on the ISP token in the transient GIP, wherein the request include a transient GIP or transient IP address, a connection time of the device to the network and the ISP token;
the ISP GIP reader reading identifiers of the device from the connection log on an authentication server or other server comparing the transient GIP or transient IP and CT provided by the resource provider in the verification request to the transient GIP or transient IP in the connection log and time at which the device connected (CT) to the ISP network; and
when the parameters match, the ISP returns a verification confirmation to the resource provider transmitting a static GIP or static IP from the connection log along with the transient GIP and CT to the resource provider server, wherein the resource provider identifies the connecting device as a dedicated device allowing the device to access electronic resources specifically configured to be accessed by the device's static GIP in addition to user authentication.

7. The system of claim 2, wherein the LAN manager device on the K-Net network stores account payment status info and initial connections of divided net extender devices that connects through said LAN manager in memory, keeping at least one connection log and the LAN manager device updates the account payment status info once every X hours where X is 24, 48, or 72 hours; and
the LAN manager transmitting data about a divided net extender to a server for the first time, memorizes a shortest path for sending data to the server and a second shortest path and a third shortest path and a fourth shortest path for every net extender connecting to the LAN manager, wherein the LAN manager keeping the paths as a log table, and setting the paths saved in memory as primary, secondary1, secondary2 and secondary3 for quick connectivity, delivers connections in a shortest possible delivery time without verifying with a server each time.

8. The system of claim 2, further comprising a safety chip embedded with a personal safety algorithm, provides a safety button coupled to the K-Net device processor, a transmitter, and at least one default recorder camera; and when the safety button is pressed and held by a user to record an event at a site, the safety button transmits instructions to the processor, wherein the processor triggers a device vibration to indicate to the user that recording is initiated;
the recording includes a video, sounds, a GPS location of the event site and a trace route path indicating nearest places and landmarks to the event site, wherein the processor, safety chip and transmitter, automatically transmits the recordings to a service provider's server for real time retrieval; and
the device is configured to transmit recordings to other destination devices by providing device identifiers such as a phone number(s) or an internal GIP and the service provider's server submit links to the designated devices and calls the devices to inform of the recordings, turning on vibration mode of a recipient's device. Transceiver

9. A K-Net recorder device for improving a K-Net communication network on which the devices run to securely provide electronic services, the K-Net recorder comprising at least one of:
a circuit board with at least one antenna coupled to at least one filter and converter for filtering narrowband and broadband signal in and out of the K-Net recorder device, wherein the K-Net recorder device is equipped with at least one of a transmitter for transmitting data packets, a receiver for receiving data packets, a modem card for networking with at least one wireless node and transmitting data packets to and from the at least one wireless node over at least one of the Wi-Fi, the cellular, the millimeter wave, the microwave, Bluetooth and other narrowband and broadband spectrums that provide connectivity and data packet continuity when in motion;
at least one motion sensor and an infrared sensor built into the K-Net recorder, wherein the K-Net recorder, is configured to detect varied temperatures and sense motion to activate and connect to the K-Net network to record and transmit video and audio events to at least one designated server utilizing a specific frequency range whether in motion or stationed, wherein the K-Net recorder learns paths or trace route and location of an event site and a trace route;
at least one camera for recording and a transmitter for transmitting recordings, wherein the recordings include at least one of video, sound, the location of the event site and a trace route path indicating nearest places and landmarks to the event site, and recordings are transmitted to a server for real time retrieval, wherein the recordings are retrieved from the server via at least one of a television, a computer and a mobile device;
at least one camera coupled to a plurality of algorithms detecting an animal or a human based on thermal and structural properties, wherein the thermal properties constitute body temperature and the structural properties constitute shape of the human and animal;
at least one input-output (I/O) port for audio coupled to a microphone for converting sound into electrical signals, a G chip and memory for executing instructions to and from the K-Net recorder and establishing connectivity;
a geographical internet protocol “GIP or Geo IP” utilized as an internet address “IP”, wherein the GIP provides a transient or dynamic GIP address and a static GIP address for securing devices on the K-Net communication network, wherein configuring the recorder with the static GIP or a static IP address to connect to the K-Net network to record and transmit video and audio events, transmits recordings to at least one of a designated server and internal memory of the device whether in motion or stationed;
at least one service provider's server for receiving recordings transmitted by the K-Net recorder and executing real time retrieval of the recordings, wherein a K-Net device provides device identifiers including at least one of a phone number and an internal GIP or an internal IP designating a device to receive recordings, wherein the service provider's server submits links to the designated device and alerts the designated device by at least one of sound and device vibration to inform of the recordings;
at least one of speakers for audio out and navigation software for pinpointing a device location, submitting recordings to a server, wherein the recorder is turned on and off remotely via a com interface or other internet connected device;
a record button, and a stop recording button for manually activating and deactivating the K-Net recorder device;
a smoke detector for detecting smoke around the K-Net recorder;
at least one of a sticky backside and clippers that holds onto a surface for steady recordings when in motion or stationary, wherein the recordings are accessed remotely via a K-Net device with a graphical com interface or any other device with access to the server recording service via a web browser or application.

10. The system of claim 7, wherein the K-Net network implements a multiport circuit board for the Local Area Network (LAN) manager device and implements a four port circuit board for a wireless router device with at least one physical data port on one or more sides of the wireless router;
the wireless router is added to the K-Net network by plugging one end of a fiber optics line, a copper wire or other wire into a connected LAN manager's I/O port and plugging the other end of the fiber or wire to the I/O port of the wireless router;
powering on the wireless router, causes the wireless router's physical I/O port to get lit invoking a initial communication module and submitting the wireless router's identifiers to the connected LAN manager, wherein the LAN manager transmits the identifiers of said wireless router to a server for verification and assignment of a 128 bit geographical internet address (GIP) or an internet protocol (IP) address for the wireless router to communicate with at least one LAN manager on the network, wherein the wireless router device, storing each of the LAN managers that the wireless router connects to via different I/O ports in memory along with respective paths of the LAN managers, provide the electronic services to mobile devices, vehicles and Net Extender devices.

11. The system of claim 10, wherein the wireless router device built on the four port circuit board with an improved Card Control Protocol (iCCP) in the memory, connects to at least one LAN manager device running the improved Network Control Protocol (iNCP);
the iNCP determines a next wireless node for a mobile device in motion to connect to on the K-Net network over Wi-Fi, microwave, or other broadband spectrum bands;
an I/O port of the wireless router device coupled to at least one I/O controller, the processor, a memory controller and at least one of a G chip 1309 and a traffic controller chip 902b processes service requests from a K-Net device, a Net Extender device and a vehicle equipped with the broadband modem to access electronic services; and
the iCCP retrieving a connection request and code from the LAN manager stored in memory and comparing the connection request and code to a connection request and code received wirelessly from the wireless broadband modem, wherein the iCCP authenticates the wireless modem in motion to switch from one node to the next node when the connection requests and connection code match, wherein the device maintains packet continuity when switching nodes, and, wherein the DC compartment converting direct current to alternating current powers the wireless router.

12. The system of claim 10, wherein the multiport circuit board for the LAN manager device, is implemented with a plurality of input/output (I/O) ports to which fiber optics or other wires from wireless routers plugs and connects, wherein the I/O ports are connected to at least one I/O controller coupled to at least one processor for executing instructions to and from the wireless routers and servers connected to via fiber optics, copper or other type of wires;
the I/O controller connected to a plurality of G chips or traffic controller chips for processing data from the wireless routers and servers, wherein the processor and the I/O controller determines which chip is available for a connection request and data transmission to provide the electronic services, wherein the LAN manager stores transaction logs including logs of wireless nodes on local area networks, geo-locations and radii under which the nodes perform well for networking in secondary memory from where the logs are cached for easy access; and
a repeater coupled to the processor retransmits signal to distant LAN managers and servers, and, wherein the DC compartment converting direct current to alternating current electrically powers the LAN manager device.

13. The system of claim 12, wherein the LAN manager device running the iNCP, calculates position of a K-Net device in motion recording coordinates and buffering service data to access when switching from one wireless broadband node to another; and
the LAN manager directs a moving K-Net device to a wireless router to connect to next when switching from one node to another on the broadband K-Net wireless network, wherein the K-Net device, with a broadband modem running a packet control protocol embedded in a network controller chip of the modem card, submits a connection request to a wireless router and the wireless router forwards the request to the LAN manager, wherein the LAN manager redirects new connection requests to other LAN manager devices when at maximum capacity and transmits a message to inform the plurality of wireless router devices connected to, not to send in new connection requests until notified.

14. The system of claim 7, wherein the divided Net Extender (DNE) device that wirelessly connects to the K-Net broadband network via at least one of cellular, millimeter wave, Wi-Fi and microwave bands to establish a network extension, provide electronic services including at least one of television service, phone service, video conferencing service, computing service, and payment service;
the com interface and related functions are installed on a storage media in at least one of the divided Net Extender device and the K-Net device to provide the services via the com interface on at least one of a K-Net device, a television display, a computer monitor, a wall projection and other screen at specific frequencies and packet identifiers;
the DNE device powered by DC current in addition to AC current, connects to wireless router devices with an improved card control protocol and connects to a LAN manager device with an improved Network Control Protocol (iNCP), wherein the DNE is embedded with the improved card control protocol on a G chip and works in conjunction with the at least one LAN manager device and at least one server to provide the electronic services, and, wherein the Net Extender device storing data on a storage media, provides the com interface, tabbed interfaces and other interfaces for launching the electronic services.

15. The system of claim 14, wherein the divided Net Extender device connects mobile devices to a public chamber at specific networking frequency ranges different from the home-office private chamber networking frequencies to prevent signal interference.

16. The system of claim 4, wherein the television channels are selected and filtered based on region, and or country where service is provided, and streamed at specific frequency ranges that are assigned application ports, channel numbers, channel names and displayed in a channel guide from a tabbed interface for the selected region or country, wherein a settings tab or button link provides for setting of a default language on a K-Net device and Net Extender device.

17. The system of claim 1, wherein the wireless router device, the LAN manager device, and the server devices connected to on the K-Net network, are powered by alternating current (AC) electrical energy generated in the DC compartment inside each of the devices or attached to the devices;
at least one rechargeable DC battery in a charging case coupled to a sensor built into the charging case for determining charge level on the battery while providing a DC current; or
the at least one photovoltaic cell absorbing electromagnetic waves (EM) from the sun and providing a DC current;
at least one antenna coupled to a frequency perturbation component harnessing a direct current (DC) from a perturbed atmosphere, generating the DC; and an inverter in the DC compartment, converting the direct current into an alternating current for utilization in the device with the DC compartment, wherein transistors amplifying the electrical signals to a high output voltage while resistors limits the voltage and control a max voltaic output for each device.

18. The system of claim 2, wherein the GIP allocation servers allocates two static GIP addresses to a resource providing server instead of a static and a dynamic GIP or IP as allocated to a user device;
one of the static GIP addresses or IP address is internal, residing on the resource providing server to which the GIP is allocated, and a second GIP is external residing on an external domain name server (EDNS) logged or tabulated against the resource server's fully qualified domain name (FQDN);
a record of the internal GIP or IP, external GIP or IP, and FQDN is kept in a connection log, on an internal domain name server (IDNS) for resolution and the internal GIP is neither reachable from outside a network nor can an external device perform a ping or run a trace route on the server; an external device seeking a connection to a resource providing server, utilizes the server's fully qualified domain name (FQDN) on the external domain name server, wherein the FQDN translates to the service server's external GIP at the EDNS and the GIP reader on an authentication server or other server reading a connection log of an IDNS populated with internal GIPs, external GIPs, and FQDNs for each resource server, maps the resource server's FQDN provided by the device seeking a connection to the resource server's internal GIP on the (IDNS) utilizing the external GIP; and
the GIP reader redirects the connection request to the service server without providing the internal GIP of the service server, wherein the GIP reader logging identifiers of the external device seeking a connection to the resource server in the connection log, and, wherein the identifiers include a transient or dynamic GIP, an external internet service provider (ISP) token, a connection date-time token, a disconnection date-time token, and GIP of a server connected to.

19. A traffic controller chip (TCC) coupled to a memory, a plurality of filters and antennas for filtering at least one of narrowband and broadband signal, and improving the K-Net communication network on which the devices run to securely provide electronic services on at least one of the LAN manager and the wireless router device, wherein the TCC embedded with algorithms of the improved Network Control Protocol software and other technologies, resides in at least one of the, the Local Area Network (LAN) manager device and server and the TCC embedded with algorithms of the improved Card Control Protocol and software resides in the wireless router device to process signal over at least one of the Wi-Fi bands, the microwave bands, the millimeter wave bands, the cellular, the Bluetooth and other narrowband and broadband spectrums, that provide connectivity and networking to manage connectivity of vehicles with a modem in motion switching from one wireless node to another, wherein the wireless router device interfaces with the vehicles connecting through the modem, and wherein the chip with embedded a plurality of algorithms and technologies, memorizes devices that connects to the network and control data to and from the vehicle; based in the at least one of the LAN manager device, the server and the wireless router.

20. The system of claim 1, wherein the local area network (LAN) manager device interacting with at least one server, manages connectivity of mobile devices, Net Extender devices and autonomous vehicles through the plurality of wireless router devices to which the LAN manager is connected by fiber optics, copper, Ethernet or other type of wires; and
the LAN manager device runs an improved network control protocol embedded in the traffic controller chip (TCC) and the G chip to control traffic and manage wireless router devices providing electronic services including radio, autonomous vehicle connectivity, television, phone and video conference, wherein the TCC or G chip in the LAN manager device or in the wireless router device coupled to radio frequency and microwave filters and antennas, manages switching of autonomous vehicles and mobile devices with a broadband modem, from at least one wireless router device to another over Wi-Fi bands, microwave bands or other broad bands,

21. The system of claim 20, wherein the plurality of wireless router devices with antennas coupled to filters and at least one of the traffic controller chip or the G chip running an improved card control protocol to provide the electronic services to connecting mobile devices, Net Extender devices and autonomous vehicle (AV) s at specific frequency ranges for each type of electronic service, provides a reset button link that resets a service provider's GIP or IP to a factory default static GIP/IP,
and a list of internet service providers (ISPs) displays for a user to select from when switching from one ISP to another, wherein the connecting device connecting for a first time or restoring a disconnected service account, utilize the default GIP or the default IP to connect submitting a device MAC address or other device ID and a model number extracted from the device memory, wherein the connecting device is assigned a payment application port and a payment interface to subscribe to an ISP or restore a disconnected service account without the ISP's involvement;
and, wherein the reset button link erases a service provider from an operational memory of a device to switch to another ISP and the new ISP's system receives a default GIP or IP, a device ID, a model number, a customer account number, an ISP payment code and a payment confirmation code as parameters to subscribe a device to a service.

22. The system of claim 21, wherein the filters coupled to the antennas of the wireless router device, are coupled to at least one G chip or traffic controller chip on the four port circuit board and the filters coupled to the antennas of the LAN manager device, are coupled to at least one G chip or traffic controller chip on the multiport circuit board, wherein the at least one chip, processes wireless signal from mobile devices, Net Extender devices, autonomous vehicles, satellite, over the air television signal, radio signal, and signal from fiber optics or wire plugged into I/O ports of the wireless router device to deliver the electronic services over Wi-Fi or microwave bands, wherein the electronic services are delivered wirelessly to mobile devices, Net Extender devices and autonomous vehicles through the wireless router device by authentication.

23. The system of claim 1, wherein the divided Net Extender device with at least one converter converting digital signal from the processor coupled to the phone chip in the Net Extender device into analog signal and converting analog signal from a phone device or from antennas into digital for processing, wherein the divided Net Extender providing phone service on a phone device plugged into the divided Net Extender device port or plugged in a splitter; and
the phone chip with embedded code stores a plurality of phone numbers and related information in memory for facilitating phone service to multiple office or home phone devices in a building each through a dedicated channel, a dedicated frequency range and a dedicated port, wherein adding at least one phone number to forward to, forwards a call to the phone number and when not picked up at the forwarded number, a message is saved to the Net Extender memory, wherein pressing an asterisk key or other key on a phone device keypad and selecting a voice box number or name assigned to a Net Extender channel, retrieves messages from the voicemail of the phone number associated with the channel and, wherein an admin user adds phone numbers to channels.

24. The system of claim 2, wherein the at least one of my networks service button link and the apps service button link provide a plurality of electronic services from a tabbed interface or button links, wherein the services are provided in a browser or from an application installed on the K-Net device and the divided Net Extender device (the device), wherein the device connecting to a network, filters each type of the electronic services into an individual tab at specific frequency ranges and assigns at least one application port for each of the tabs for launching the electronic service, wherein the types of electronic services include sharing textual content, images and links service, videos service, video conferencing service, phone service and photo album service each executing individually on a server; and
a save to favorites button link, invokes a save module generating a saved content Id for identifying a selected electronic service content to be saved, wherein the save module concatenating a current date and the saved content Id into a save parameter and submitting the save parameter along with a user account Id to a database or file linking the saved content Id to the user account Id, and saving the selected electronic service content to favorites on a server under the saved content Id and the user account Id, and, wherein the favorites are accessed by authenticating of the user account Id from a connected device.

25. The system of claim 14, wherein, the divided Net Extender connects to wireless routers and LAN managers at a frequency range different from a frequency range user devices utilize to connect to the Net-Extender.

26. The system of claim 2, wherein the network packet controller chip of the broadband modem coupled to a cache memory, compares a last packet from a wireless node to a first packet from a next wireless node to connect to, to determine packet order and maintain data packet continuity when switching from one wireless node to another, wherein the LAN manager device transfers service data from a previous wireless node buffered on the LAN manager device to the next wireless node switched to for the broadband modem to access over Wi-Fi, microwave and other bands.

27. A Geo Internet Protocol “Geo IP or GIP” mechanism for producing K-Net devices and improving a K-Net communication network on which the devices run to securely provide electronic services, the Geo IP protocol mechanism comprising at least one of:
at least one processor and a memory coupled to said processor for executing instructions in at least one of the K-Net device, the wireless router device, the LAN manager device, servers and the divided Net Extender device;
at least one gChip embedded with algorithms for managing security of devices and networks, wherein the gChip is coupled to a memory for storing instructions and information relating to the network, servers and devices;
a K-Net device running a geo internet protocol (GIP) address for protecting the K-Net device from network related attacks and for communicating with servers, wherein the GIP, is characterized by a plurality of hexadecimal tokens for identifying specific functions of the GIP, wherein the GIP is made up of two types of geo internet protocol addresses one static and referred to as internal, and resident in the K-Net device for identifying the device on a service provider's network and a counterpart dynamic GIP referred to as external for identifying the device on external networks and saved to a server connection log instead of saving on the device, wherein the hexadecimal tokens with a total of at least 64 bits, are adjustable in length referred to as number of bits per token and the tokens include at least one of:
a GIP type token, a region token, a sub-region token, an ISP token, a firm token, a facility token, a subnet token, a device type, and a device id token, wherein the Geo IP protocol mechanism further comprising:
a plurality of algorithms and software for controlling connectivity and security for wireless routers, LAN manager devices, servers, user devices, and data;
a plurality of GIP/IP allocation servers for allocating GIP or IP addresses, internal and external domain name servers (IDNS/EDNS) for translating GIPs and controlling devices on the network and authentication servers executing the GIP reader for verifying and authenticating the devices, wherein powering on a K-Net device with the system function algorithm (SFA) in memory, transmits instructions to the processor of the device to test for a new client device status;
a new client device, invoking a module and retrieving the default GIP or default IP from memory of the device along with a MAC address or other device ID and a model number, and submitting the trio to the authentication server to register the device, establishing an account, wherein the Geo IP protocol mechanism connecting the new client device utilizing the default GIP or default IP and assigning the device a payment application port at a specific frequency range; and
providing an interface for subscribing to the electronic services displaying a list of internet service providers (ISP) or telecom providers to choose from, wherein choosing an ISP displays a payment button link showing available services and prices, wherein opening the payment button link and selecting a payment method, and making an electronic payment via one of the payment methods including a debit or credit card, a prepaid card, a bank electronic check and a digital or crypto currency, subscribes the device to a service, wherein the electronic payment over the SFA, invokes a module for receiving a service provider payment code, a client device account number, and a static GIP or IP replacing the default GIP in memory, wherein the SFA saving the service provider payment code, client device account number and the static GIP to a file or mini database in memory for future payments and connection requests, wherein the main or com interface is displayed on a screen without a service provider's action.

28. The Geo IP protocol mechanism of claim 27, wherein the K-Net device assigned a static GIP or a static IP address after an account is established, executes the SFA to connect, extracting the service provider code, a client device account number and a static GIP or static IP from memory of the device, and testing for connectivity to establish a connection, wherein the SFA transmits instructions to the device processor to submit an encrypted or unencrypted connection request submitting the static GIP or static IP, the client device account number and the service provider payment code to the authentication server as parameters to establish a connection, wherein the internal domain name server (IDNS) interacting with a payment server and identifying the static GIP or IP of the device, the client device account number and the service provider payment code, redirects the connection to the GIP allocation server that assigns a transient or dynamic GIP or IP to the device, wherein the authentication server authenticates the device displaying the com or main interface showing service button links including the television service, the phone service, the video conference service, the my networks service, the apps service and the payment service upon connecting, wherein the authentication server logs the connection to a connection log; and
opening any of the service button links, selects a service type submitting instructions to the device processor and invoking the algorithm to display a corresponding interface for the selected service type.

29. The Geo IP protocol mechanism of claim 28, wherein the button link for the television service submits instructions to the device processor causing the SFA to display the television tabbed interface and tabs as button links, wherein, the tabbed interface showing:
at least one of a button link or a tab for subscribed television channels, a button link or a tab for over the air channels, a button link or a tab for pay per view channels, a button link or a tab for saving and retrieving favorite television shows and favorite apps, and a tab or a button link for returning to the main interface, wherein the SFA highlighting and displaying a configured default tab, transmits service signals at specific frequency ranges, assigning frequency, application ports and external channel identifiers to specific channels, wherein the channels and channel identifiers are displayed in the television channel guide with corresponding scheduled playback time slots under the respective tabs.

30. The Geo IP protocol mechanism of claim 28, wherein the at least one of my networks service button link and the apps service button link provide a plurality of electronic services from a tabbed interface or button links, wherein the services are provided in a browser or from an application installed on the K-Net device and the divided Net Extender device (the device), wherein the device connecting to a network, filters each type of the electronic services into an individual tab at specific frequency ranges and assigns at least one application port for each of the tabs for launching the electronic service, wherein the types of electronic services include sharing textual content, images and links service, a videos service, a video conferencing service, a phone service and a photo album service each executing individually on a server; and
a save to favorites button link, invokes a save module generating a saved content Id for identifying a selected electronic service content to be saved, wherein the save module concatenating a current date and the saved content Id into a save parameter and submitting the save parameter along with a user account Id to a database or file linking the saved content Id to the user account Id, and saving the selected electronic service content to favorites on a server under the saved content Id and the user account Id, and, wherein the favorites are accessed by authenticating of the user account Id from a connected device.

31. The system of claim 4, wherein the K-Net device wirelessly connects to the K-Net network interfacing with the wireless router device “wireless node” to provide electronic services while in at least one of stationary and in motion, wherein a K-Net device in motion receiving and transmitting signal via at least one antenna coupled to at least one filter, utilizes the broadband modem based on the at least one chip and the memory to switch from one wireless router device to another, and network the device and the wireless router while maintaining data packet order and continuity over the Wi-Fi, the microwave, cellular bands, millimeter waves or a combination thereof, wherein the system function algorithm “SFA” on the K-Net device facilitates provision of the electronic services providing a plurality of interfaces and button links corresponding to different services.

32. The system of claim 31, wherein the K-Net device connects to the wireless router device and accesses the electronic services, wherein the SFA displays at least one interface with one or more service button links, wherein the interface provides one or more button links for accessing at least one of television service and radio service through one or more antennas without internet connection.

33. The system of claim 31, wherein the K-Net device and the K-Net communication network implements a security mechanism that involves an internet service provider (ISP) creating a user account and registering a user with at least one electronic communication method that includes email, and registering devices of the user that connects to the wireless router device to executes the security mechanism over at least one of Wi-Fi, cellular, microwave millimeter wave spectrums, and other wireless spectrums that provide connectivity and networking, wherein a Geo IP or an IP address is established for each of the user devices, wherein the security mechanism provides at least one button link for viewing devices on the account and inventory of installed software; and
at least one of the email verifies the user account and a three way authentication verifies a user's credentials, the device and the ISP.

34. The system of claim 31, wherein the K-Net device connects to the wireless router device to access electronic services, wherein the SFA provides at least one button link for subscribed television service, over the air television service, pay per view channels, favorites, and a button link for filtering television channels, wherein the channels are filtered based on region, and or country where service is provided, wherein a television or other K-Net device is configured to default to channels in a specific region or a specific country or region and country.

35. The system of claim 31, wherein the K-Net device displays a multipurpose interface that receives data packets and displays at least one of climate conditions and ads, wherein the interface displays ads in form of videos, or images or text or audio or a combination thereof, and wherein an interface displays showing the ads when booting, and when booted.

36. The system of claim 4, wherein a television set or a display running the broadband modem on at least one of narrowband and broadband spectrums, is mounted to an automobile or truck to wirelessly connect to the K-Net network providing at least one of a television service and ads while in motion or stationed, wherein the ads are in form of video or images or audio or text, or a combination thereof and the ads are transmitted at specific frequency ranges, over at least one of a Wi-Fi network, a cellular network, a microwave network, a millimeter wave network, and other networks that provides wireless connectivity and networking.

37. A divided Net-Extender (DNE) device for improving the K-Net communication network on which the devices run to securely provide electronic services, the DNE device comprising at least one of:
a circuit board with at least one antenna and filter coupled to a memory and an interface, wherein the interface is at least one of a satellite, a Wi-Fi, a cellular, a millimeter wave, a Bluetooth, a microwave, and other wireless spectrums that provides connectivity and networking;
at least one of a radio frequency (RF) antenna coupled to at least one of an I/O controller, a chip, a filter, a memory and a processor for executing instructions to and from a wireless router and establishing connectivity and networking to provide internet service to user devices over the at least one of the Wi-Fi, the cellular, the millimeter wave, the Bluetooth, the microwave, and the other spectrums that provides connectivity and networking in at least one of a building and in motion.
a storage media storing at least one of an operating system for managing protocols, applications and software in the DNE device, and a com interface and related functions for providing electronic services on at least one of a television, a computer monitor, a mobile device and a wall projector, wherein the com interface invokes a plurality of tabbed interfaces and other interfaces for launching the electronic services;
a direct current (DC) power compartment that provides DC/AC power input generated from within the DNE device for powering the DNE device, wherein the DC power compartment generates alternating current (AC) from a direct current source utilizing at least one of a rechargeable DC battery, at least one photovoltaic cell and antennas for harnessing power signals from the atmosphere through electrical conductors and a switch, wherein the inverter converts DC to AC current utilizing a transformer and an inductor as components of the inverter for increasing or decreasing output voltage in the DNE device;
at least one uplink and downlink antenna for exchanging signal and data with at least one of other antennas, sensors, wireless nodes and satellite, and distributing the data to the user devices;
at least one of a multiplexer for consolidating the various types of signals flowing between the DNE and the wireless node, and a converter and filter for filtering narrowband and broadband signal, and converting the incoming and outgoing signal in the DNE device, wherein the DNE device connects wirelessly to at least one of a wireless router device, and the LAN manager device wherein the DNE provide internet access to the user devices and manages connectivity of the user devices whether stationary or in motion;
a modem based on the network packet controller chip embedded with at least one of the improved card control protocol (jCCP) and the improved packet control protocol (iPCP) for networking and transmitting data packets to and from at least one wireless node over at least one of the Wi-Fi, the cellular, the millimeter wave, the Bluetooth, the microwave and other narrowband and broadband spectrums that provide connectivity and networking, wherein the chip in the modem is coupled to at least one of a memory, a filter, an antenna, and a processor to provide internet service to the user devices stationary in a home or office building and when in motion;
at least one external port that connects to wires on the DNE to provide internet service to the user devices, wherein the internet service is provided by the DNE to the user devices via the external ports by plugging;
a G chip embedded with an improved Card Control Protocol is coupled to at least one of a memory, at least one filter and antenna for managing wireless connections and providing internet access to user devices over Wi-Fi and other wireless spectrums that provide connectivity and networking;
a geographical internet protocol “GIP or Geo IP” utilized as an internet address “IP”, wherein the GIP provides a transient or dynamic GIP address and a static GIP address for securing devices on the K-Net communication network;
a system function algorithm (SFA) installed in the storage media for managing and controlling how the K-Net device operates to provide electronic services, wherein the SFA runs with a plurality of modules and algorithms on the DNE to network devices and provide internet service, wherein the SFA provide the electronic services to the user devices;
a phone chip for managing at least one phone device connected to the DNE device;
a traffic controller chip (TCC) coupled to at least one of the processor, an antenna and filter, and a memory through an I/O controller for managing connectivity of vehicles on the K-Net network;
a plurality of algorithms and technologies coupled to at least one of the memory, the gChip and a processor for controlling connectivity and data transmission;
a public chamber to which any mobile device connects and maintain network connectivity; and
a private chamber utilized by specific user devices in a building, wherein the private chamber provides data ports for plugging fiber optics, Ethernet, USB, HDMI and other wire ports for connecting user devices, wherein the DNE wirelessly connects over at least one of the Wi-Fi, the millimeter wave, the microwave bands, the cellular the satellite interface and other wireless network that provide connectivity and networking to provide internet service to the user devices.

38. The DNE device of claim 37, wherein the DNE device connects wirelessly to at least one of the wireless router device and the LAN manager device to provide the internet service to user devices, wherein one or more antenna is coupled to the at least one wireless router device, or LAN manager device to harvest free television channels from the air into the K-Net network, wherein the network provides for at least one of automatic configuration of default local television channels based on at least one of a location of a wireless node connected to, and configuration of default channels by selecting or entering one or more area identifiers, and the area identifiers include at least one of an area code, a zip code, a postal code, a country code and other area identifiers.

39. The DNE device of claim 38, wherein the device wirelessly connects to the network over at least one of the cellular, the microwaves, the millimeter waves, the Wi-Fi bands, the satellite and other wireless bands that provide connectivity and networking to provide internet access and the electronic services to the user devices, wherein the DNE provides the internet access to the user devices utilizing at least one of wirelessly over the Wi-Fi and the Bluetooth, and through data ports by plugging, wherein the DNE device provides the internet access when stationary and when in motion.

40. The DNE device of claim 39, wherein the DNE device, executes instructions to select a radius for covering the local television channels harvested by the wireless router or LAN manager device into the network, wherein configuring the radius provides for entry of multiple area identifiers, wherein the multiple identifiers provides more local channels from a larger area, and the channels are sorted by the area identifiers, and wherein at least one port on the DNE device provides for plugging a phone.

41. The system of claim 6, wherein at least one of the static GIP, the dynamic GIP, an IP address, a tiny code, a connection code, account number, device id, and time at which said user device initially connects to an internet service provider (ISP)'s network identifies a device on the network, wherein a resource provider GIP reader on a server, or LAN manager, verifies a user seeking access to the system by authentication, wherein the ISP's network verifies at least one of the device seeking access to the electronic resources, the time at which the device connects to the system, and verifies the internet service provider to which the device is connected, wherein the verification by the ISP network is returned to a resource provider for authentication.

42. The system of claim 41 implements at least one of the transient Geo IP address and the transient IP address, wherein the K-Net device receives at least one tiny code from an ISP when the transient Geo IP or the transient IP address is changed, wherein the at least one of the account number, device id, connection code, tiny code, time the tiny code is saved, the transient Geo IP, and the IP address, is a device signature that is passed to an ISP as a parameter for verification and authentication.

43. The system of claim 42, wherein the at least one of the Geo IP, the IP address, the connection code, and the tiny code is saved to at least one of a connection application, a memory and a chip in the K-Net device for security.

44. The system of claim 1, wherein the LAN manager device working in conjunction with at least one wireless router further comprising at least one of:
a multi-port circuit board with at least one of the G chip and the traffic controller chip (TCC) for executing instructions to and from the at least one wireless router and servers, and for managing connectivity of vehicles on the K-Net network, wherein the at least one of the G chip and the TCC chip, is coupled to at least one of a processor and a memory for executing instructions to and from the at least one wireless router and servers, and establishing connectivity;
a multiplexer and a demultiplexer for facilitating communication and distributing data to at least one wireless router, servers, and other local area network manager devices, are coupled to at least one chip and a memory, wherein the LAN manager device symbiotically working with the at least one wireless router, receives, processes and transmits data to the wireless routers and the servers, and wherein the chip is embedded with an improved network control protocol;
at least one uplink and downlink antenna for exchanging data with other antennas and satellite, and distributing the data to and from user devices;
a direct current (DC) power compartment that provides DC/AC power input generated from within the DNE device for powering the DNE device, wherein the DC power compartment generates alternating current (AC) from a direct current source utilizing at least one of a rechargeable DC battery, at least one photovoltaic cell and antennas for harnessing power signals from the atmosphere through electrical conductors and a switch, wherein the devices are coupled to an inverter for converting DC to AC current utilizing a transformer and an inductor as components of the inverter for increasing or decreasing output voltage in the local area network manager device;
an improved K-Net network connecting the servers to a plurality of wireless routers and DNE devices via the local area network manager, wherein the local area network manager utilizes a geographical internet protocol “GIP or Geo IP” as an internet address “IP”, wherein the GIP provides a transient or dynamic GIP address and a static GIP address for securing devices on the K-Net communication network;
a storage medium or a memory running an embedded operating system for managing protocols and connectivity of the wireless routers, mobile devices, vehicles and Net Extender devices on the K-Net network stores updated connection data of all nodes in a sub wide area network (SWAN) and connected user devices on the local area network, wherein the LAN manager device coupled to at least one server and wireless router stores identities of local devices for quick retrieval and verifies a user device connecting from a different SWAN;
at least one input-output (I/O) port on the local area network manager device is coupled to the at least one wireless router, wherein the at least one wireless router filtering by frequency ranges of narrowband and broadband signal to transmit data to and from user devices and servers, runs an improved card control protocol (iCCP), wherein the at least one wireless router provides, at least one of internet service and electronic services to the user devices over at least one of the cellular network, the wi-fi network, the millimeter wave network, the microwave network, the Bluetooth, or a combination thereof.

45. The system of claim 44, wherein the LAN manager device works in conjunction with the wireless router device to manage connectivity of at least one of the mobile devices, the vehicles and the Net Extender devices “user devices”, that utilize the modem card, wherein the wireless router device stores in memory, each of the LAN manager devices that the wireless router device connects to for quick access, wherein the LAN manager device networks the mobile devices and vehicles switching from one wireless router to another when in motion.

46. The system of claim 45, wherein the wireless router device is coupled to a fiber optic cable or a copper cable, or an Ethernet cable, or other type of broadband cable to transmits data between the wireless router device and the LAN manager device, and between the wireless router device and the servers, wherein the local area network manager device works in conjunction with the wireless router device to manage wireless connectivity; and when the wireless router device transmits data to the server without the LAN manager device, the wireless router device works with the server to manage wireless connectivity and provide electronic services on mobile devices, Net extender devices and autonomous vehicles over at least one of the Wi-Fi, the microwave, the Bluetooth, the cellular and the millimeter wave spectrums.

47. The system of claim 44, wherein the DNE device wirelessly connects to at least one of the wireless router and the LAN manager device over at least one of the Wi-Fi, the cellular, the millimeter waves, the microwave bands, and the other wireless networks that provide connectivity and networking to provide electronic services to the user devices, wherein the DNE device built with at least one external port and the G chip coupled to at least one of a memory, a filter and an antenna, wherein the G chip embedded with at least one of the improved card control protocol and the improved packet control protocol, manages connectivity of the user devices and provide electronic services to the user devices over at least one of the Wi-Fi, the Bluetooth and by plugging.

48. The system of claim 44, wherein the at least one server is configured to connect to a plurality of LAN manager devices, wherein the LAN manager devices implements antennas and filters for controlling connectivity of K-Net devices on the narrowband and the broadband signal, wherein the plurality of LAN manager devices works symbiotically with the at least one server to provide electronic services to the K-Net devices over a range of frequencies, and a port designated for each type of electronic service, wherein the plurality of LAN manager devices running the improved network control protocol (INCP) and the wireless router devices running the improved card control protocol (iCCP) are each coupled to a satellite interface for input into the network and output to the satellite and K-Net devices.

49. The system of claim 26, wherein the K-Net device wirelessly connects to the wireless router device or the LAN manager device (node) to provide electronic services, wherein the K-Net device utilizes at least one chip to network with the node when in motion switching from one node to another on at least one of the Wi-Fi, the millimeter wave, the cellular and the microwave network, wherein the K-Net device embedded with a near-field communication chip coupled to interfaces, the memory and the processor, establishes a short range connection and read or transmit near field communication data.

50. The system of claim 4, wherein the K-Net device is a television set running the modem card, wherein the television set connects to a wireless node over at least one of the Wi-Fi, the cellular, the microwave the millimeter waves, and the other wireless networks that provide connectivity and networking, wherein the television set provide electronic services, and wherein the television set is authenticated over at least one of a Geo IP, an IP address, a phone number or other identifier to a user account, wherein at least one of the television set, the DNE and other K-Net devices execute instructions to select a radius for covering the local television channels harvested by the wireless router or LAN manager device into the network, wherein configuring the radius provides for entry of multiple area identifiers for providing more local channels from a larger area, and the channels are sorted by area identifiers, wherein at least one of the television set and the other K-Net devices auto detects a node connected to and determines local television channels to display in a television guide based on the area identifiers.

51. The system of claim 8, wherein the system provides for selection of a camera to record an event on the K-Net device, and when configured to transmit recordings to law enforcement stations, the servers provide the law enforcement stations in the vicinity of the event site and any designations as configured in the system with recordings, wherein the K-Net device connecting wirelessly over at least one of the Wi-Fi, the millimeter waves, the microwave bands, a Cellular network, the Satellite and other wireless networks that provide wireless connectivity and electronic services, provide internet access, to other user devices wirelessly over at least one of the Wi-Fi and Bluetooth when stationary and when in motion.

52. The K-Net recorder device of claim 9, wherein the K-Net recorder device comprising at least one of a modem card, a receiver and a transmitter, is turned on and off remotely via a com interface from a dedicated K-Net device connected to the internet, or other internet connected device with at least one of an application software and a browser installed for configuration, wherein the K-Net recorder device is configured to record when in motion; and recording via a wireless router “node” or Net Extender when mounted indoors or outdoors, and recordings are accessed in real time from the server by authentication on designated devices to maximize security, wherein the K-Net recorder device triggers an alarm and sends warning messages to the server when excessive heat and smoke or smoke is detected, and the warning messages are configured to be transferred to fire departments and law enforcement over at least one of the Wi-Fi, the cellular, the millimeter wave, the microwave, the satellite or a combination there of.

53. The K-Net recorder device of claim 52, wherein the K-Net recorder device is mounted to a vehicle, wherein the K-Net recorder detects humans and animals such as a deer on a road utilizing the infrared and motion sensors, wherein the K-Net record beeps to alert a driver, wherein at least one of the sticky side and clippers, provides for a steady recording when in a moving vehicle.

54. The K-Net recorder device of claim 53, wherein the device equipped with at least one of the motion sensor and the infrared sensor, is configured to record when at least one of motion is detected and temperature variation, wherein recordings are configured to be saved to at least one of the device and the server while stationery and while in motion, wherein the K-Net recorder is configured to record by default from a top camera, a rear camera or a front camera to at least one of a server of choice, and to an internal storage on the K-Net recorder device.

55. The system of claim 2, wherein the processor invokes an interface for the payment service button link that is activated on boot, to connect and check for a client device status and a payment status from a payment server, wherein the SFA connects a new client device prior to purchasing services and without a service provider's action, wherein a payment module provides for resetting a service provider's static GIP or static IP to a default GIP or IP when switching to a new service provider.

56. The system of claim 55, wherein the processor invokes a button link on at least one interface to execute a payment, wherein the payment method is at least one of the credit card payment method, the electronic check payment method, the prepaid card payment method, and the digital or crypto currency payment method.

57. The system of claim 1, wherein at least one of the K-Net device, the television and the DNE executes an interface that provides at least one button link for making an electronic payment, wherein the button link is configured to transmit instructions to the processor causing the processor to invoke a payment interface utilized to make the payments electronically.

58. The system of claim 57, wherein the K-Net device, the television and the DNE with the at least one button link for making the electronic payment, causes the processor to invoke a payment interface for making the electronic payment from at least one of the K-Net device, the television and the DNE, wherein the electronic payment is made from a payment application without involvement of an internet service provider.

59. The system of claim 38, wherein the television set, K-Net devices and the DNE, executes instructions to select a radius for covering the local television channels harvested by the wireless router or LAN manager device into the network, wherein configuring the radius provides for entry of multiple area identifiers, wherein the multiple identifiers provide more local channels from a larger area, and the channels are sorted by area identifiers.

60. The system of claim 2 comprising a G chip and the SFA, displays an interface for selecting a type of electronic services, wherein the interface provides at least one button link for selecting a television service.

61. The system of claim 38, wherein at least one of the DNE, the television set and the K-Net device, auto detects a node connected to and determines local television channels to display in a television guide.

62. The system of claim 22, implements the satellite interface with signal uplink and downlink antennas to exchange data with and distribute data to at least one of the user devices, the DNE and sensors, wherein the data includes at least one of the electronic services and data from the sensors.

63. The system of claim 41, wherein at least one of the LAN manager and the plurality of servers running at least one of the Geo IP and the IP address, generates at least one of the tiny code that identifies a K-Net device on a network, and the connection code utilized to identify a K-net device switching from one wireless node to another, wherein the at least one of the LAN manager and the plurality of servers, provides the connection code to a wireless router that saves the connection code to memory, and provide the connection code to the K-Net device, wherein the K-Net device broadcasts the connection code and the connection code is picked by the wireless node that received the connection code from the at least one of the LAN manager and the plurality of servers, and compares to authenticate on the network when identical.

64. The system of claim 63, wherein the network implements at least one of the connection code and the tiny code for security over at least one of the Wi-Fi network, the cellular network, the millimeter wave network, the microwave network, and other networks that delivers wireless networking.

65. The system of claim 64, wherein the network saves the tiny code on the at least one server and on the K-Net device, wherein a K-Net device receives a tiny code through a wireless router to connect to and the K-Net device saves the tiny code to at least one of a memory, an application, and a chip, wherein the K-Net device, receives a new tiny code from a wireless node to connect to and compares the new tiny code to the tiny code saved previously on the K-Net device to verify the network.

66. The DNE device of claim 38 equipped with a broadband modem, provides internet access to devices over broadband and narrowband spectrums, wherein the modem equipped with at least one antenna coupled to a filter, memory and a satellite interface, provides an uplink and a downlink connection to exchange data with satellites and user devices.

67. The K-Net recorder device of claim 9, wherein the device connects to at least one of the wireless router and the DNE device via at least one of the Wi-Fi, the cellular, the millimeter wave, the microwave and the Bluetooth to transmit data and receive data.

68. The K-Net recorder device of claim 66, wherein the device is configured to transmit data to at least one of law enforcement stations in vicinity of an event, and at least one designated server, wherein the K-Net recorder device is further configured to save data to at least one of internal memory of the device, internal memory of the device then transfer to a server, and save to a server.

69. The system of claim 37, wherein the DNE device that connects to the Wi-Fi, the cellular, the millimeter wave, the Bluetooth, the microwave, and other spectrums that provides connectivity and networking in at least one of a building and in motion, is embedded with a rechargeable battery, and powered by at least one of DC current from the battery and AC current from a grid, wherein the DNE provides at least one of internet service and electronic services to user devices over at least one of plugging of wires, Wi-fi, Bluetooth and other wireless spectrums that provides connectivity to user devices.

70. The system of claim 31, wherein the K-Net device comprising at least one of a mobile phone, a tablet, a laptop, a computer, a television and a wearable, utilizes a modem to connect to the network over at least one of the Wi-Fi, the cellular, the millimeter wave, the Bluetooth, the microwave, and the other spectrums that provides connectivity and networking, wherein the K-Net device utilizes a satellite interface to access the electronic services, wherein the electronic services includes at least one of phone service, text messaging, video conferencing, television service, and other electronic services.

71. The system of claim 4, wherein the interface that provide at least one button link for making an electronic payment from the K-Net device, invokes at least one of the processor and the gChip to select a service provider and process a payment to the service provider from the K-Net device, wherein the K-Net device is at least one of the mobile phone, the tablet, the laptop, and the wearable.

72. The system of claim 8, wherein the safety button is accessed via at least one of an external button that is pressed, and a graphical button on an interface, wherein the safety button is configured to invoke at least one of the processor and the safety chip to transmit the instructions to designated devices and phone numbers in emergency situations.

73. The system of claim 4, wherein an interface in the K-Net device displays a button link for making an electronic payment for electronic services, wherein the button link is configured to invoke at least one of the processor and the gChip to process the electronic payment to the electronic service provider utilizing a payment method that includes at least one of a debit or credit card, a prepaid card, a bank electronic check and a digital or crypto currency.

74. The Geo IP mechanism of claim 27, wherein the at least 64 bits in the Geo IP protocol provides at least one bit as a reserve bit for other purposes, wherein the at least one bit is arranged in different binary or hexadecimal tokens and the tokens are adjusted as needed.

75. The system of claim 1, wherein the plurality of servers wirelessly provide the electronic services to at least one of the user devices, the DNE and the vehicles over at least one of Wi-Fi, Bluetooth, millimeter wave, cellular, and satellite, wherein the user devices, the DNE, and the vehicles wirelessly connects to the wireless router to communicate with the plurality of servers.
